(19) United States
(12) Patent Application Publication
(10) Pub. No.: US 2024/0218282 A1
(43) Pub. Date: Jul. 4, 2024

(54) ETHYLENE-PROPYLENE BRANCHED COPOLYMERS USED AS VISCOSITY MODIFIERS

(71) Applicants: ExxonMobil Chemical Patents Inc., Houston, TX (US); Chevron Oronite Company LLC, San Ramon, CA (US)

(72) Inventors: Jingwen ZHANG, Houston, TX (US); Peijun JIANG, Katy, TX (US); Jo Ann M. CANICH, Houston, TX (US); John R. HAGADORN, Houston, TX (US); Yen-Hao LIN, Houston, TX (US); Sarah MATTLER, League City, TX (US); Chase A. ECKERT, Houston, TX (US); Aaron REED, League City, TX (US); Adrian G. BARRY, Omaha, NE (US); Sara Yue ZHANG, Danville, CA (US); Maryam SEPEHR, San Ramon, CA (US); David L. MORGAN, Pleasanton, CA (US)

(21) Appl. No.: 18/557,826

(22) PCT Filed: May 11, 2022
(86) PCT No.: PCT/US2022/028709

§ 371 Date: Oct. 27, 2023

Related U.S. Application Data
(60) Provisional application No. 63/188,667, filed on May 14, 2021.

(51) Int. Cl. C10M 143/04; C08F 210/16; C10M 169/04; C10N 20/00; C10N 20/04; C10N 30/00; C10N 30/02

(52) U.S. Cl. CPC C10M 143/04; C08F 210/16; C10M 169/041; C08F 2420/10; C08F 2800/20; C10M 2203/003; C10M 2205/024; C10N 2020/019; C10N 2020/04; C10N 2020/071; C10N 2030/02; C10N 2030/40; C10N 2030/68

(57) ABSTRACT

The present disclosure also relates to lubrication compositions comprising a long branched ethylene copolymer and methods for making compositions. Compositions of the present disclosure can be a composition including an oil and a ethylene copolymer, the copolymer having one or more of an MWD from about 2.0 to about 6.5; an Mw(LS) from about 30,000 to about 300,000 g/mol; a g′ᵥᵢₛ of from about 0.5 to about 0.97; an ethylene content of about 40 wt % to less than 80 wt %. The compostion has a shear stability index (30 cycles) of from about 1% to about 60%; and a kinematic viscosity at 100° C. of from about 3 cSt to about 25 cSt. A method of making a composition includes blending an oil with a copolymer is also disclosed. Additionally, provided are novel long chain branched ethylene propylene copolymers and methods to produce such copolymers.

### FIELD

The present disclosure relates to lubrication oil compositions including a branched copolymer and methods for making oil compositions.

### BACKGROUND

Lubrication fluids are applied between moving surfaces to reduce friction, thereby improving efficiency and reducing wear. Lubrication fluids also often function to dissipate the heat generated by friction between moving surfaces in contact with each other.

One type of lubrication fluid is a petroleum-based lubrication oil used for internal combustion engines. Lubrication oils contain additives that improve performance of the oil by controlling oxidation, friction, wear and viscosity under engine operating conditions. In general, the viscosity of lubrication oils and fluids is inversely dependent upon temperature. When the temperature of a lubrication fluid is increased, the viscosity generally decreases, and when the temperature decreases, the viscosity generally increases.

Viscosity index modifiers have been widely used to improve the temperature dependence of viscosity of lubrication oils. The addition of viscosity index modifiers to lubricating oils slows down the rate at which the viscosity decreases with temperature. In addition to improve the temperature dependence of viscosity of lubrication oils: polymeric viscosity index modifiers have two other critical attributes, which are modifiy a lubrication oil's viscosity and maintain appropriate shear stability.

The effectiveness in viscosity modification is measured using thickening efficiency (TE). Thickening efficiency (TE) as described in U.S. Pat. No. 8,105,992 is a relative measure of how much viscosity gain can be achieved by dissolution a polymer in a given reference oil. A polymer having a high value of TE indicates that it is a potent thickener. TE is primarily a function of molecular architectures and molecular weight of the polymers.

Shear stability of the polymer is one of the important criteria that determines its suitibility as a viscosity modifier. A polymer's shear stability index (SSI) is used to measure its resistance to mechanical degradation under shearing stress. Mechanical forces that break polymer chains into lower molecular weight fragments are elongational in nature, causing the molecule to stretch until it can no longer bear the load. This loss in polymer chain length leads to a permanent degradation of lubricant viscosity at all temperatures. A polymer's shear stability index (SSI) measures the percent viscosity loss at 100° C. of polymer-containing fluids when evaluated using a diesel injector apparatus procedure that uses European diesel injector test equipment. The higher the SSI, the less stable the polymer, i.e., the more susceptible it is to mechanical degradation.

Reducing green house gas emissions is a global trend; as a result, the industry continues to be challenged by increased fuel economy requirements. Recent government and consumer requests for sustainability growth has fueled the technology advancement for lubricating oils to provide improved fuel economy while maintaining long-term viscosity stability.

Fuel economy appears to be related to the engine oil viscosity. It is now well known that engine oil formulated with a low High Temperature High Shear (HTHS) viscosity promotes good fuel economy because of the resultant thinner oil film. However, engines lubricated by thin oil films are prone to excessive wear due to decreased hydrodynamic boundary layer formation, which can lead to increased wear that shortens engine life. Therefore, selecting a viscosity index modifier with chemistry and architecture that can deliver high thickening efficiency, good shear stability while contributing to the kinematic viscosity will be essential given the increasing demands for lubricants to provide not only excellent wear protection but also fuel efficiency.

Analysis of engine test performance have shown that the ability of polymeric viscosity index modifiers to minimize overall engine friction is the key to maximize fuel economy improvement from the lubricating oils. The ability of a polymeric molecule to respond quickly when engine temperature and/or speed increases determine the ability to reduce viscous drag of the oil and therefore minimize engine friction. The tendency of a polymeric molecule to undergo chain scission when subjected to repeately mechanical forces is dictated by its molecular weight, molecular weight distribution, chemical composition, and architecture of the polymer chains. The chemistry, architecture and molecular weight of viscosity index modifier polymers can vary significantly. Some of the most commonly used polymers in lubricating oils include linear olefin copolymers (OCP), polyalkylmethacrylates (PMA) and hydrogenated poly(styrene-co-conjugated dienes). It is ideal for a polymeric viscosity index modifier to have the combination of fast and strong shear thinning response in engine condition and resistance to mechanical degradation from mechanical shear.

U.S. Pat. No. 9,657,122 is directed to a branched ethylene-propylene copolymer with a percentage of sequences of length of 6 of greater which is more than 32% and a r₁r₂ of greater than 2 indicating a “blocky copolymer” and a polymer of greater crystallinity for a given ethyelene content.

U.S. Pat. No. 5,458,791 discloses improved multi-arm star polymers having triblock copolymer arms of hydrogenated polyisoprene-polystyrene-polyisoprene. U.S. Pat. No. 10,479,956 discloses use of star shaped and block hydrogenated polyisoprene-polystyrene-polyisoprene in formulating high fuel economy engine oils.

Despite the advances in viscosity index improver for lubricating oil formulation, there remains a need for a polymeric viscosity index improver that effectively improves fuel economy while also provide good shear stability for long term engine antiwear performance. The present disclosure relates to oil compositions comprising a novel branched ethylene-propylene copolymer with good shear thinning behavior, whereby the finished oil composition has improved fuel economy and maintains shear stability for long-term wear protection.

### SUMMARY

The present disclosure relates to lubricant compositions comprising a long chain branched ethylene copolymer and a lubrication oil. The long chained branched ethylene copolymer is soluble in the lubrication oil at a temperature of from −40 to 150° C. at application concentration. The concentration of the long chain branched ethylene copolymer in the lubrication oil is about 12 wt % or less. The shear stability index (at 30 cycles) of the branched ethylene copolymer in the lubricating oil is from about 1% to about 60%, and the kinematic viscosity at 100° C. is from about 3 cSt to about 30 cSt.

The disclosed lubricant compositions have low high temperature high shear viscosity (HTHS) as compared with a lubricant composition of linear olefin copolymers at the same kinematic viscosity at a temperature of 100° C. HTHS viscosity is measured at 150° C. and 10⁶ s⁻¹ according to ASTM D4683 in a Tapered Bearing Simulator and has a unit of centipoise (cP).

Long chain branched ethylene propylene copolymers that may be employed in the compositions of the present disclosure have from about 40% to less than 80% ethylene content by weight, preferably from about 40% to 75% ethylene content by weight, more preferably from about 43% to about 73% ethylene content by weight, or more preferably from about 45% to about 70% ethylene content by weight, as determined by FTIR (ASTM D3900), wherein the polymer has a g′ᵥᵢₛ of from about 0.5 to about 0.97; a Mw(LS)/Mn(DRI) from about 2.0 to about 6.5; a Mw(LS) from about 30,000 to about 300,000 g/mol; and optionally one or more and preferably two or more additional properties selected from:
(a) a branching index (g′ᵥᵢₛ) less than −0.0003x+0.88, and greater than −0.0054x+1.08, where x is the percent total monomer conversion.
(b) a r₁r₂ less than 2.0 and greater than 0.45;
(c) an “average sequence length for methylene sequences six and longer” less than 0.1869z-0.30, and greater than 0.1869z-1.9, where z is the mol % of ethylene as measured by ¹³C NMR;
(d) a “percentage of methylene sequence length of 6 or greater” less than 1.3z-35.5, and greater than 1.3z-50, where z is the mol % of ethylene as measured by ¹³C NMR;
(e) exhibiting no polymer crystallinity, or a polymer crystallinity wherein the heat of fusion (J/g) as measured by DSC is less than 2.8y-134, where y is the wt % of ethylene as measured by FTIR;
(f) exhibiting no polymer crystallinity, or a polymer crystallinity wherein the heat of fusion (J/g) as measured by DSC is less than 1.47y-64, where y is the wt % of ethylene as measured by FTIR;
(g) exhibiting a Tm of less than 50° C. as measured by DSC;
(h) a SSI (%) 30 cycle per ASTM D6278 less than 0.0003x-2.125 where x is Mw(LS) from light scattering GPC-3D; and
(i) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

This disclosure also relates to novel long chain branched ethylene propylene copolymers that may be employed in the compositions of the present disclosure have from about 40% to less than 80% ethylene content by weight, alternatively from about 40% to 75% ethylene content by weight, alternatively from about 43% to about 73% ethylene content by weight, or alternatively from about 45% to about 70% ethylene content by weight, as determined by FTIR (ASTM D3900), wherein the polymer has a g′ᵥᵢₛ of from about 0.5 to about 0.97; a Mw(LS)/Mn(DRI) from about 2.0 to about 6.5; a Mw(LS) from about 30,000 to about 300,000 g/mol; and two or more additional properties selected from:
(a) a branching index (g′ᵥᵢₛ) less than −0.0003x+0.88, and greater than −0.0054x+1.08, where x is the percent total monomer conversion.
(b) a r₁r₂ less than 2.0 and greater than 0.45;
(c) an “average sequence length for methylene sequences six and longer” less than 0.1869z-0.30, and greater than 0.1869z-1.9, where z is the mol % of ethylene as measured by ¹³C NMR;
(d) a “percentage of methylene sequence length of 6 or greater” less than 1.3z-35.5, and greater than 1.3z-50, where z is the mol % of ethylene as measured by ¹³C NMR;
(e) exhibiting no polymer crystallinity, or a polymer crystallinity wherein the heat of fusion (J/g) as measured by DSC is less than 2.8y-134, where y is the wt % of ethylene as measured by FTIR;
(f) exhibiting no polymer crystallinity, or a polymer crystallinity wherein the heat of fusion (J/g) as measured by DSC is less than 1.47y-64, where y is the wt % of ethylene as measured by FTIR;
(g) exhibiting a Tm of less than 50° C. as measured by DSC;
(h) a SSI (%) 30 cycle per ASTM D6278 less than 0.0003x-2.125 where x is Mw(LS) from light scattering GPC-3D; and
(i) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

This disclosure also relates to a process for polymerization comprising: (i) contacting at a temperature greater than 50° C., ethylene and propylene with a catalyst system capable of producing long chain branched ethylene propylene copolymers having vinyl chain ends, the catalyst system comprising a metallocene catalyst compound and an activator; (ii) converting at least 50% of the monomer to a polyolefin; and (iii) obtaining a long chain branched ethylene propylene copolymer having from about 40% to less than 80% ethylene content, preferably about 45% to less than 70% ethylene content by weight, as determined by FTIR (ASTM D3900), wherein the polymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol. Additional polymer properties are as describe above.

In another embodiment, the polymers of the present disclosure can be prepared by a process for polymerization comprising: (i) contacting at a temperature greater than 50° C., ethylene and propylene with a catalyst system capable of producing long chain branched ethylene propylene copolymers having vinyl chain ends, the catalyst system comprising a metallocene catalyst compound and an activator; (ii) converting at least 50% of the monomer to a polyolefin; and (iii) obtaining a long chain branched ethylene propylene copolymer having from about 40% to less than 80% ethylene content by weight, preferably about 45% to less than 70% ethylene content by weight, as determined by FTIR (ASTM D3900), wherein the polymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol, and wherein the metallocene compound is represented by the formula:

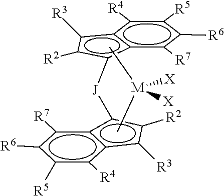

where: (1) J is a divalent bridging group comprising C, Si, or both; (2) M is a group 4 transition metal (preferably Hf); (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl (such as C₁-C₅₀ substituted or unsubstituted halocarbyl), provided that any one or more of the pairs R⁴ and R⁵, R⁵ and R⁶, and R⁶ and R⁷ may optionally be bonded together to form a saturated or partially saturated cyclic or fused ring structure,

In another class of embodiments, the present disclosure provides a lubricant composition comprising first and second copolymers wherein the first copolymer has an ethylene content higher than that of the second copolymer, and wherein at least one of the two copolymers is a long chain branched ethylene copolymer.

### BRIEF DESCRIPTION OF THE DRAWING

FIG. 1 is a plot of high temperature, high shear (HTHS) viscosity vs. Shear Stability Index (SSI) for lubrication oil formulations comprising branched ethylene copolymers as viscosity index modifiers

FIG. 2 is a dynamic frequency sweep of complex viscosity at 190° C. on neat polymers produced in Examples 56, 40 and 46 from Cat #1, #2 and #3 respectively vs. linear OCP Comparative Example 3 in accordance with some embodiments of the present disclosure.

FIG. 3 is a HPLC projection of ethylene propylene copolymers produced in Examples 14, 18, 21, and 30.

FIG. 4 is a plot of total monomer conversion in the reactor vs. g′ᵥᵢₛ of the polymer produced.

FIG. 5 is a plot of ethylene (mol %) vs. the average methylene sequence lengths for sequences of six and greater as measured by ¹³C NMR

FIG. 6 is a plot of ethylene (mol %) vs. m6 which is the percentage of methylene sequences of sequence length of six and greater as measured by ¹³C NMR.

FIG. 7 is a plot of ethylene (mol %) vs. r₁r₂ as measured by ¹³C NMR

FIG. 8 is a plot of ethylene (wt %) from FTIR vs. the Heat of Fusion (J/g) of the melting peak as measured by DSC.

FIG. 9 is a plot of Shear Stability Index (SSI) for lubrication oil formulations comprising branched ethylene copolymers as viscosity index modifiers vs. polymer Mw (LS).

FIG. 10 is a lot of the shear thinning ratio vs. polymer Mw (LS) where the shear thinning ratio is defined as the complex viscosity at a frequency of 0.1 rad/s divided by the complex viscosity at a frequency of 100 rad/s.

### DETAILED DESCRIPTION

The present disclosure relates to lubricant compositions comprising a long chain branched ethylene copolymer and a lubrication oil. The long chain branched ethylene copolymer is soluble to the lubrication oil at a temperature of from −40 to 150° C. at application concentration. The concentration of the long chain branched ethylene copolymer in the lubrication oil is about 12 wt % or less, preferably about 5 wt % or less, more preferably 4 wt % or less and even more preferably 3 wt % or less. The long chain branched ethylene copolymer has one or more of (a) an MWD (Mw/Mn) from about 2.0 to about 6; (b) an Mw(LS) from about 30,000 to about 300,000 g/mol; (c) a branching index, g′ᵥᵢₛ, of from about 0.5 to about 0.97; (d) an ethylene content of about 40 wt % to less than 80 wt %.; (e) a shear thinning ratio of greater than 0.8572*EXP(2E-05*w) where w is the Mw(LS) from light scattering GPC-3D.

The present disclosure also relates to lubrication compositions comprising a long chain branched ethylene copolymer; wherein the branched ethylene copolymers has branching index, g′ᵥᵢₛ as determined using GPC-3D, of less than 0.95, and an ethylene content in a range of from about 40 wt % to less than 80 wt %.

The lubricant compositions of the present disclosure have one or more of (a) a shear stability index (at 30 cycles) of from about 1% to about 60%, preferably about 10% to about 50% and more preferably from about 15% to about 40%; (b) a kinematic viscosity at 100° C. of from about 3 cSt to about 30 cSt and preferably from about 5 cSt to about 20 cSt and more preferably about 10 cSt to about 15 cSt; (c) thickening efficiency of about 1 to about 4 and preferably from about 1.5 to about 3.5; (d) HTHS viscosity of 4 cap or less.

In one aspect, a method of making a lubricant composition includes blending an oil with a long chain branched ethylene copolymer. The long chain branched ethylene copolymers show lower high temperature high shear (HTHS) viscosity as compared to existing linear olefin copolymer (OCP) grades,

The long chain branched ethylene copolymers are preferrably long chain branched ethylene/propylene copolymers.

The present disclosure also relates to lubrication compositions comprising a long chain branched ethylene copolymer; wherein the branched ethylene copolymers has branching index, g′ᵥᵢₛ of 0.97 or less, preferably about 0.55 to about 0.97 and more preferably about 0.55 to about 0.85, and an ethylene content in a range of from about 40 wt % tless than 80 wt %, preferably from about 40 to about 75 wt %, more preferably about 43 to about 73 wt % and even more preferably from about 45 to 70 wt %.

Suitable lubrication oil composition may include about 0.01 wt %, 0.1 wt % to about 5 wt %, or about 0.25 wt % to about 1.5 wt %, or about 0.5 wt % or about 1.0 wt % of the long chain branched ethylene copolymer. In at least one embodiment, the amount of the polymer produced herein in the lubrication oil composition can range from a low of about about 0.01 wt %, about 0.5 wt %, about 1 wt %, or about 2 wt % to a high of about 2.5 wt %, about 3 wt %, about 5 wt %, about 10 wt % or about 12 wt %. An embodiment of a particular range of the copolymer in a lubrication oil composition according to the present disclosure is 0.01 wt % to about 12 wt % and from 0.01 wt % to about 3 wt %.

The present disclosure also provides a lubricant composition comprising a blend of long chain branched ethylene copolymers. The blend includes at least one long chain branched ethylene copolymer. In the blends, a second copolymer having an ethylene content less than the ethylene content of the first copolymer is present. The second copolymer can be a branched ethylene-propylene copolymer as described above or a linear ethylene-propylene copolymer.

Lubricant compositions of the present disclosure that include at least one long chain branched ethylene copolymers can provide a shear stability index (30 cycles) of about 60% or less, such as from about 1% to about 60%, a kinematic viscosity at 100° C. of from about 3 cSt to about 30 cSt, a thickening efficiency of about 1-4, a shear thinning onset of about 0.01 rad/s or less, and a high temperature high shear (HTHS) viscosity of about 4.0 cP or less, such as from about 1.5 cP to 3.5 cP.

While large polymer molecules are good oil thickeners, they are also more easily broken down into smaller polymer molecules, which influences the shear stability of the oil. Balance between the thickening efficiency and shear stability is one of the key factors to selection of polymers used as oil viscosity modifiers. SSI performance is related to the TE of the lubricant composition, in addition to the molecular weight, molecular weight distribution and ethylene content of the ethylene copolymer.

Furthermore, the lubricant composition of the present disclosure may have a high temperature and high shear viscosity (cP) of about 3.5 cP or less, such as from about 1.5 cP to about 3.5 cP, or such as from about 1.5 cP to about 3.3 cP. HTHS viscosity is measured at 150° C. and 10⁶ 1/s according to ASTM D4683 in a Tapered Bearing Simulator.

In at least one embodiment, the lubricant composition described herein also has a kinematic viscosity at 100° C. (KV100), as measured by ASTM D445, of about 3 cSt to about 30 cSt, such as of about 7 cSt to about 17 cSt, or such as about 9 cSt to about 15 cSt or such as about 10 cSt to about 15 cSt.

The lubricant compositions described herein may also have a kinematic viscosity at 40° C. (KV40), as measured by ASTM D445, of about 50 cSt to about 150 cSt, such as of about 55 cSt to about 125 cSt, or such as about 60 cSt to about 110 cSt.

Further, lubricant compositions described herein may have a thickening efficiency (TE) of about 1.0 or greater, such as from about about 1.5 to 3.5, or such as from about 1.55 to 2.8, or such as from about 1.6 to 2.7.

The lubrication oil composition can have a SSI of about 70% to 5%, such as of about 68% to 10%, such as of about 66% to 15%, such as of about 10% to 50%, or such as of about 15% to about 47%. SSI is determined according to ASTM D6278, 30 cycles.

In at least one embodiment, the present disclosure provides a lubricant composition including an oil and a long chain branched ethylene copolymer having: 1) an MWD (defined as Mw/Mn) from about 2.0 to about 6.5, 2) an Mw(LS) is from about 100,000 to about 240,000 g/mol, 3) a g′ᵥᵢₛ of from about 0.55 to about 0.97, 4) an ethylene content of about 40 wt % to about 75 wt %.

The present disclosure provides a lubricant composition where the long chain branched ethylene copolymer has an ethylene content of about 40 wt % to about 75 wt %, and a MWD from about 2.0 to about 6.5.

In at least one embodiment, the present disclosure provides a lubricant composition, including an oil and a copolymer, having 1) a shear stability index (30 cycles) of from about 10 to about 50; and 2) a kinematic viscosity at 100° C. of from about 9 cSt to about 15 cSt.

The present disclosure provides a lubricant composition having a kinematic viscosity at 100° C. of from about 9 cSt to about 15 cSt, a shear stability index (30 cycles) about 10 or greater, and a thickening efficiency of about 1.5 or greater.

The present disclosure also provides a lubricant composition where the oil includes a hydrocarbon, polyalphaolefin, alkyl esters of dicarboxylic acids, polyglycols, alcohols, polybutenes, alkylbenzenes, organic esters of phosphoric acids, polysilicone oils, or combinations thereof.

In at least one embodiment, the present disclosure provides a method of making a lubricating oil composition comprising (1) a long chain branched ethylene copolymer (first copolymer) having: a) an MWD from about 2.0 to about 6.5; b) an Mw(LS) from about 30,000 to about 300,000 g/mol; c) a g′ᵥᵢₛ of from 0.5 to 0.97; d) an ethylene content of about 40 wt % to about 75 wt %; (2) a second copolymer having an ethylene content less than the ethylene content of the first copolymer, and (3) an oil, to produce an lubricating oil composition having a) a shear stability index (30 cycles) of from about 10% to 50%; and b) a kinematic viscosity at 100° C. of from about 3 cSt to about 30 cSt.

In yet further embodiments, the lubricant compositions may instead or also be characterized by their composition. In one embodiment, the aluminum content of the lubricant composition is 1 ppm or less. The element content is determined using ICP procedure according to ASTM D5185.

This disclosure also relates to long chain branched ethylene propylene copolymers having from about 40% to less than 80% ethylene content by weight, preferably about 45% to less than 70% ethylene content as determined by FTIR (ASTM D3900), wherein the polymer has a g′ᵥᵢₛ of from about 0.5 to about 0.97; a Mw(LS)/Mn(DRI) from about 2.0 to about 6.5; a Mw(LS) from about 30,000 to about 300,000 g/mol; and two or more additional properties selected from:
(a) a branching index (g′ᵥᵢₛ) less than −0.0003x+0.88, and greater than −0.0054x+1.08, where x is the percent total monomer conversion.
(b) a r₁r₂ less than 2.0 and greater than 0.45;
(c) an “average sequence length for methylene sequences six and longer” less than 0.1869z-0.30, and greater than 0.1869z-1.9, where z is the mol % of ethylene as measured by ¹³C NMR;
(d) a “percentage of methylene sequence length of 6 or greater” less than 1.3z-35.5, and greater than 1.3z-50, where z is the mol % of ethylene as measured by ¹³C NMR;
(e) exhibiting no polymer crystallinity, or a polymer crystallinity wherein the heat of fusion (J/g) as measured by DSC is less than 2.8y-134, where y is the wt % of ethylene as measured by FTIR;
(f) exhibiting no polymer crystallinity, or a polymer crystallinity wherein the heat of fusion (J/g) as measured by DSC is less than 1.47y-64, where y is the wt % of ethylene as measured by FTIR.
(g) exhibiting a Tm of less than 50° C. as measured by DSC;
(h) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

In some embodiments, the long chain branched ethylene propylene copolymers that may be employed in the compositions of the present disclosure have from about 40% to less than 80% ethylene content by weight, alternatively from about 40% to 75% ethylene content by weight, alternatively from about 43% to about 73% ethylene content by weight, alternatively from about 45% to about 70% ethylene content by weight, alternatively from about 45% to about 65% ethylene content by weight, alternatively from about 45% to about 60% ethylene content by weight or alternatively from about 45% to about 50% ethylene content by weight as determined by FTIR (ASTM D3900).

In another class of embodiments, the present disclosure provides a lubricant composition comprising first and second copolymers wherein the first copolymer has an ethylene content higher than that of the second copolymer, and wherein at least one of the two copolymers is a long chain branched ethylene copolymer.

This disclosure also relates to a process for polymerization comprising: (i) contacting at a temperature greater than 50° C., ethylene and propylene with a catalyst system capable of producing long chain branched ethylene propylene copolymers having vinyl chain ends, the catalyst system comprising a metallocene catalyst compound and an activator; (ii) converting at least 50% of the monomer to polyolefin; and (iii) obtaining a long chain branched ethylene propylene copolymer having from about 40% to less than about 80% ethylene content, preferably about 45% to less than 70% ethylene content by weight as determined by FTIR (ASTM D3900), wherein the polymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol, and optionally, wherein the polymer has one or more of the following properties:
(a) a branching index (g′ᵥᵢₛ) less than −0.0003x+0.88, and greater than −0.0054x+1.08, where x is the percent total monomer conversion.
(b) a r₁r₂ less than 2.0 and greater than 0.45;
(c) an “average sequence length for methylene sequences six and longer” less than 0.1869z-0.30, and greater than 0.1869z-1.9, where z is the mol % of ethylene as measured by ¹³C NMR;
(d) a “percentage of methylene sequence length of 6 or greater” less than 1.3z-35.5, and greater than 1.3z-50, where z is the mol % of ethylene as measured by ¹³C NMR;
(e) exhibiting no polymer crystallinity, or a polymer crystallinity wherein the heat of fusion (J/g) as measured by DSC is less than 2.8y-134, where y is the wt % of ethylene as measured by FTIR;
(f) exhibiting no polymer crystallinity, or a polymer crystallinity wherein the heat of fusion (J/g) as measured by DSC is less than 1.47y-64, where y is the wt % of ethylene as measured by FTIR;
(g) exhibiting a Tm of less than 50° C. as measured by DSC;
(j) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

This disclosure also relates to a process for polymerization comprising: (i) contacting at a temperature greater than 50° C., ethylene and propylene with a catalyst system capable of producing long chain branched ethylene propylene copolymers having vinyl chain ends, the catalyst system comprising a metallocene catalyst compound and an activator; (ii) converting at least 50% of the monomer to polyolefin; and (iii) obtaining a long chain branched ethylene propylene copolymer having from about 40% to less than about 80% ethylene content by weight preferably about 45% to less than 70% ethylene content as determined by FTIR (ASTM D3900), wherein the polymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol, and wherein the metallocene compound is represented by the formula:

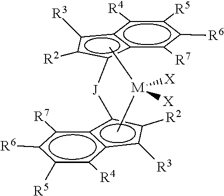

where: (1) J is a divalent bridging group comprising C, Si, or both; (2) M is a group 4 transition metal (preferably Hf); (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl (such as C₁-C₅₀ substituted or unsubstituted halocarbyl), provided that any one or more of the pairs R⁴ and R⁵, R⁵ and R⁶, and R⁶ and R⁷ may optionally be bonded together to form a saturated or partially saturated cyclic or fused ring structure,

### Definitions

For purposes herein, the numbering scheme for the Periodic Table Groups is used as described in CHEMICAL AND ENGINEERING NEWS, 63(5), pg. 27 (1985). For example, a “Group 4 metal” is an element from Group 4 of the Periodic Table, e.g., Hf, Ti, or Zr.

As used herein, an “olefin,” alternatively referred to as “alkene,” is a linear, branched, or cyclic compound of carbon and hydrogen having at least one double bond. A “polymer” has two or more of the same or different monomer (“mer”) units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of ethylene copolymer, as used herein, includes copolymer or terpolymers of ethylene and one or more olefins.

“Linear polymer” means that the polymer has few, if any, long chain branches and has a g′ᵥᵢₛ value of about 0.97 or above, such as about 0.98 or above.

The term “cyclopentadienyl” (Cp) refers to a 5-member ring having delocalized bonding within the ring and being bound to M through η⁵-bonds, carbon making up the majority of the 5-member positions.

For nomenclature purposes, the following numbering schemes are used for indenyl and 1,5,6,7-tetrahydro-s-indacenyl. It should be noted that indenyl can be considered a cyclopentadienyl fused with a benzene ring. The structures below are drawn and named as an anion.

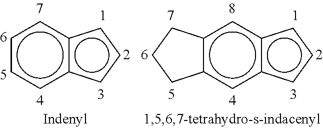

As used herein, a “catalyst” includes a single catalyst, or multiple catalysts with each catalyst being conformational isomers or configurational isomers. Conformational isomers include, for example, conformers and rotamers. Configurational isomers include, for example, stereoisomers.

The term “complex,” may also be referred to as catalyst precursor, precatalyst, catalyst, catalyst compound, transition metal compound, or transition metal complex. These words are used interchangeably. Activator and cocatalyst are also used interchangeably.

Unless otherwise indicated, the term “substituted” generally means that a hydrogen of the substituted species has been replaced with a different atom or group of atoms. For example, methyl-cyclopentadiene is cyclopentadiene that has been substituted with a methyl group. Likewise, picric acid can be described as phenol that has been substituted with three nitro groups, or, alternatively, as benzene that has been substituted with one hydroxy and three nitro groups.

An “anionic ligand” is a negatively charged ligand that donates one or more pairs of electrons to a metal ion. A “neutral donor ligand” is a neutrally charged ligand that donates one or more pairs of electrons to a metal ion.

The terms “hydrocarbyl radical,” “hydrocarbyl,” “hydrocarbyl group,” “alkyl radical,” and “alkyl” are used interchangeably throughout this document. Likewise, the terms “group,” “radical,” and “substituent” are also used interchangeably in this document. For purposes of this disclosure, “hydrocarbyl radical” refers to C₁-C₁₀₀ radicals, that may be linear, branched, or cyclic, and when cyclic, aromatic or non-aromatic. Examples of such radicals include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and their substituted analogues. Substituted hydrocarbyl radicals are radicals in which at least one hydrogen atom of the hydrocarbyl radical has been substituted with at least one halogen (such as Br, Cl, F or I) or at least one functional group such as C(O)R*, C(O)NR*₂, C(O)OR*, NR*₂, OR*, SeR*, TeR*, PR*₂, AsR*₂, SbR*₂, SR*, BR*₂, SiR*₃, GeR*₃, SnR*3, and PbR*₃ (where R* is independently a hydrogen or hydrocarbyl radical, and two or more R* may join together to form a substituted or unsubstituted saturated, partially unsaturated or aromatic cyclic or polycyclic ring structure), or where at least one heteroatom has been inserted within a hydrocarbyl ring.

The term “alkenyl” means a straight chain, branched-chain, or cyclic hydrocarbon radical having one or more double bonds. These alkenyl radicals may optionally be substituted. Examples of suitable alkenyl radicals include ethenyl, propenyl, allyl, 1,4-butadienyl cyclopropenyl, cyclobutenyl, cyclopentenyl, cyclohexenyl, cycloctenyl, including their substituted analogues.

The term “alkoxy” or “alkoxide” means an alkyl ether or aryl ether radical wherein the term alkyl is as defined above. Examples of suitable alkyl ether radicals include methoxy, ethoxy, n-propoxy, iso-propoxy, n-butoxy, iso-butoxy, sec-butoxy, tert-butoxy, and phenoxyl.

The term “aryl” or “aryl group” includes a C₄-C₂₀ aromatic ring, such as a six carbon aromatic ring, and the substituted variants thereof, including phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

Where isomers of a named alkyl, alkenyl, alkoxide, or aryl group exist (e.g., n-butyl, iso-butyl, iso-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

For any particular compound disclosed herein, any general or specific structure presented also encompasses all conformational isomers, regioisomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom-substituted ring where a hydrogen on a ring atom is replaced with a heteroatom. For example, tetrahydrofuran is a heterocyclic ring and 4-N,N-dimethylamino-phenyl is a heteroatom-substituted ring.

As used herein the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

Conversion in a polymerization process is the amount of all monomers that is converted to polymer product, and is reported as percent and is calculated based on the polymer yield and the amount of monomer fed into the reactor. Catalyst efficiency is defined as the amount of products produced by per unit of catalyst used in the reaction and is reported as the mass of product polymer (P) produced per mass of catalyst (cat) used (gP/gcat or kgP/kgcat). The mass of the catalyst is the weight of the pre-catalyst without including the weight of the activator.

Herein, “catalyst” and “catalyst complex” are used interchangeably.

The following abbreviations may be used herein: dme is 1,2-dimethoxyethane, Me is methyl, Ph is phenyl, Et is ethyl, Pr is propyl, iPr is isopropyl, n-Pr is normal propyl, Bu is butyl, cPR is cyclopropyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, p-Me is para-methyl, Ph is phenyl, Bn is benzyl (i.e., CH₂Ph), THE (also referred to as thf) is tetrahydrofuran, RT is room temperature (and is 23° C. unless otherwise indicated), tol is toluene, TLTM is too low to measure, THTM is too high to measure, EtOAc is ethyl acetate, Cy is cyclohexyl, Cp is cyclopentadienyl, cP is centipoise, VI is viscosity index, VM is viscosity modifier, TE is Thickening efficiency, SSI is shear stability index, OCP-based is olefin copolymer-based, TP is thickening power, CCS is cold cranking simulator, PP is pour point, PSSI is permanent shear stability index, KV is kinematic viscosity, FE is fuel efficiency.

The terms oil composition, lubricating oil composition, lubrication oil composition, and lubricant composition are used interchangeably, and refer to a composition comprising an ethylene-based copolymer including ethylene propylene copolymers, and an oil.

### Lubrication Oil Composition

Lubricating oil compositions containing a long chain branched ethylene copolymer and one or more base oils (or base stocks) are provided according to the present disclosure. The base stock can be or include natural or synthetic oils of lubricating viscosity, whether derived from hydrocracking, hydrogenation, other refining processes, unrefined processes, or re-refined processes. The base stock can be or include used oil. Natural oils include animal oils, vegetable oils, mineral oils and mixtures thereof. Synthetic oils include hydrocarbon oils, silicon-based oils, and liquid esters of phosphorus-containing acids. Synthetic oils may be produced by Fischer-Tropsch gas-to-liquid synthetic procedure as well as other gas-to-liquid oils.

In one embodiment, the base stock is or includes a polyalphaolefin (PAO) including a PAO-2, PAO-4, PAO-5, PAO-6, PAO-7 or PAO-8 (the numerical value relating to Kinematic Viscosity at 100° C.). Preferably, the polyalphaolefin is prepared from dodecene and/or decene. Generally, the polyalphaolefin suitable as an oil of lubricating viscosity has a viscosity less than that of a PAO-20 or PAO-30 oil. In one or more embodiments, the base stock can be defined as specified in the American Petroleum Institute (API) Base Oil Interchangeability Guidelines. For example, the base stock can be or include an API Group I, II, III, IV, and V oil or mixtures thereof.

In one or more embodiments, the base stock can include oil or compositions thereof conventionally employed as crankcase lubricating oils. For example, suitable base stocks can include crankcase-lubricating oils for spark-ignited and compression-ignited internal combustion engines, such as automobile and truck engines, marine and railroad diesel engines, and the like. Suitable base stocks can also include those oils conventionally employed in and/or adapted for use as power transmitting fluids such as automatic transmission fluids, tractor fluids, universal tractor fluids and hydraulic fluids, heavy duty hydraulic fluids, power steering fluids and the like. Suitable base stocks can also be or include gear lubricants, industrial oils, pump oils and other lubricating oils.

In one or more embodiments, the base stock can include not only hydrocarbon oils derived from petroleum, but also include synthetic lubricating oils such as esters of dibasic acids; complex esters made by esterification of monobasic acids, polyglycols, dibasic acids and alcohols; polyolefin oils, etc. Thus, the lubricating oil compositions described can be suitably incorporated into synthetic base oil base stocks such as alkyl esters of dicarboxylic acids, polyglycols and alcohols; polyalpha-olefins; polybutenes; alkyl benzenes; organic esters of phosphoric acids; polysilicone oils; etc.

The lubricating oil compositions of the present disclosure can optionally contain one or more conventional additives, such as, for example, pour point depressants, anti-wear agents, antioxidants, other viscosity-index improvers, dispersants, corrosion inhibitors, anti-foaming agents, detergents, rust inhibitors, friction modifiers, and the like.

Corrosion inhibitors, also known as anti-corrosive agents, reduce the degradation of the metallic parts contacted by the lubricating oil composition. Illustrative corrosion inhibitors include phosphosulfurized hydrocarbons and the products obtained by reaction of a phosphosulfurized hydrocarbon with an alkaline earth metal oxide or hydroxide, preferably in the presence of an alkylated phenol or of an alkylphenol thioester, and also preferably in the presence of carbon dioxide. Phosphosulfurized hydrocarbons are prepared by reacting a suitable hydrocarbon such as a terpene, a heavy petroleum fraction of a C₂ to C₆ olefin polymer such as polyisobutylene, with from 5 to 30 wt % of a sulfide of phosphorus for 0.5 to 15 hours, at a temperature in the range of 66° C. to 316° C. Neutralization of the phosphosulfurized hydrocarbon may carried out in the manner known by those of ordinary skill in the art.

Oxidation inhibitors, or antioxidants, reduce the tendency of mineral oils to deteriorate in service, as evidenced by the products of oxidation such as sludge and varnish-like deposits on the metal surfaces, and by viscosity growth. Such oxidation inhibitors include alkaline earth metal salts of alkylphenolthioesters having C₅ to C₁₂ alkyl side chains, e.g., calcium nonylphenate sulfide, barium octylphenate sulfide, dioctylphenylamine, phenylalphanaphthylamine, phosphosulfurized or sulfurized hydrocarbons, etc. Other oxidation inhibitors or antioxidants useful in this disclosure include oil-soluble copper compounds, such as described in U.S. Pat. No. 5,068,047.

Friction modifiers serve to impart the proper friction characteristics to lubricating oil compositions such as automatic transmission fluids. Representative examples of suitable friction modifiers are found in U.S. Pat. No. 3,933,659, which discloses fatty acid esters and amides; U.S. Pat. No. 4,176,074, which describes molybdenum complexes of polyisobutenyl succinic anhydride-amino alkanols; U.S. Pat. No. 4,105,571, which discloses glycerol esters of dimerized fatty acids; U.S. Pat. No. 3,779,928, which discloses alkane phosphonic acid salts; U.S. Pat. No. 3,778,375, which discloses reaction products of a phosphonate with an oleamide; U.S. Pat. No. 3,852,205, which discloses S-carboxyalkylene hydrocarbyl succinimide, S-carboxyalkylene hydrocarbyl succinamic acid and mixtures thereof; U.S. Pat. No. 3,879,306, which discloses N(hydroxyalkyl)alkenyl-succinamic acids or succinimides; U.S. Pat. No. 3,932,290 which discloses reaction products of di-(lower alkyl)phosphites and epoxides; and U.S. Pat. No. 4,028,258, which discloses the alkylene oxide adduct of phosphosulfurized N-(hydroxyalkyl)alkenyl succinimides. Preferred friction modifiers are succinate esters, or metal salts thereof, of hydrocarbyl substituted succinic acids or anhydrides and thiobis-alkanols such as described in U.S. Pat. No. 4,344,853.

Dispersants maintain oil insolubles, resulting from oxidation during use, in suspension in the fluid, thus preventing sludge flocculation and precipitation or deposition on metal parts. Suitable dispersants include high molecular weight N-substituted alkenyl succinimides, the reaction product of oil-soluble polyisobutylene succinic anhydride with ethylene amines such as tetraethylene pentamine and borated salts thereof. High molecular weight esters (resulting from the esterification of olefin substituted succinic acids with mono or polyhydric aliphatic alcohols) or Mannich bases from high molecular weight alkylated phenols (resulting from the condensation of a high molecular weight alkylsubstituted phenol, an alkylene polyamine and an aldehyde such as formaldehyde) are also useful as dispersants.

Pour point depressants (“PPD”), otherwise known as lube oil flow improvers, lower the temperature at which the fluid will flow or can be poured. Any suitable pour point depressant known in the art can be used. For example, suitable pour point depressants include, but are not limited to, one or more C₈ to C₁₈ dialkylfumarate vinyl acetate copolymers, polymethyl methacrylates, alkylmethacrylates and wax naphthalene.

Foam control can be provided by any one or more anti-foamants. Suitable anti-foamants include polysiloxanes, such as silicone oils and polydimethyl siloxane.

Anti-wear agents reduce wear of metal parts. Representatives of conventional antiwear agents are zinc dialkyldithiophosphate and zinc diaryldithiosphate, which also serve as an antioxidant.

Detergents and metal rust inhibitors include the metal salts of sulphonic acids, alkyl phenols, sulfurized alkyl phenols, alkyl salicylates, naphthenates and other oil soluble mono- and dicarboxylic acids. Highly basic (viz, overbased) metal sales, such as highly basic alkaline earth metal sulfonates (especially Ca and Mg salts) are frequently used as detergents.

When lubricating oil compositions contain one or more of the components discussed above, the additive(s) are blended into the composition in an amount sufficient for it to perform its intended function. Typical amounts of such additives useful in the present invention are shown in Table A below.

TABLE A
Typical Amounts of Various Lubricating Oil Components

| | Approximate wt % | Approximate wt % |
|---|---|---|
| Compound | (useful) | (preferred) |
| Detergents | 0.01-8 | 0.01-4 |
| Dispersants | 0.1-20 | 0.1-8 |
| Antiwear agents | 0.01-6 | 0.01-4 |
| Friction Modifiers | 0.01-15 | 0.01-5 |
| Antioxidants | 0.01-5 | 0.1-2 |
| Pour Point Depressants | 0.01-5 | 0.1-1.5 |
| Anti-foam Agents | 0.001-1 | 0-0.2 |
| Corrosion Inhibitors | 0-5 | 0-1.5 |
| Other Viscosity Improvers | 0.25-10 | 0.25-5 |
| (solid polymer basis) | | |

When other additives are used, it may be desirable, although not necessary, to prepare additive concentrates that include concentrated solutions or dispersions of the VI improver (in concentrated amounts), together with one or more of the other additives, such a concentrate denoted an “additive package,” whereby several additives can be added simultaneously to the base stock to form a lubrication oil composition. Dissolution of the additive concentrate into the lubrication oil can be facilitated by solvents and by mixing accompanied with mild heating, but this is not essential. The additive-package can be formulated to contain the VI improver and optional additional additives in proper amounts to provide the desired concentration in the final formulation when the additive-package is combined with a predetermined amount of base oil.

### Blending/Formulation

This disclosure is related to a lubricant composition comprising a long chain branched ethylene copolymer and a lubrication oil. The solid long chain branched ethylene copolymer can be dissolved in the base stock without a need for additional shearing and degradation processes.

Conventional compounding methods are described in U.S. Pat. No. 4,464,493, which is incorporated by reference herein. This conventional process passes the polymer through an extruder at an elevated temperature for degradation of the polymer and circulates hot oil across the die face of the extruder while reducing the degraded polymer to particle size upon issuance from the extruder and into the hot oil. The long chain branched ethylene copolymer used according to the present disclosure, as described above, can be added by compounding directly with the base oil so as to give directly the viscosity for the VI improver, so that the complex multi-step process of the prior art is not needed.

The long chain branched ethylene copolymer employed in the compositions of the present disclosure can be soluble at room temperature in lube oils at, for example, up to about 20% concentration, and at least about 0.5% (e.g., up to 18%, up to 15%, up to 12%, up to 10%, and the like) and more typically at least about 10% in order to prepare a viscosity modifier concentrate. Such concentrates, including an additional additive package including the suitable additives used in lube oil applications as described above, can be further diluted to the final concentration (usually approximately 1%) by multi-grade lube oil producers. In this case, the concentrate will be a pourable homogeneous solid-free solution.

For example, a solution blending with Spectrasyn™ PAO4 Group IV base oil is obtained by heating the base oil at high temperature, such as 130° C., followed by the addition of the long chain branched ethylene copolymer used in the present disclosure and an optional antioxidant. The mixture can be stirred until complete dissolution of the copolymer and is then cooled to room temperature. The solubility behavior is recorded at room temperature.

Furthermore, the present disclosure provides a method including blending an oil and one or more long chain branched ethylene copolymer of the present invention to form a composition, and heating the composition at a temperature of about 150° C. or less, such as about 130° C. or less, such as about 100° C. or less, such as from about 50° C. to about 150° C., such as from about 50° C. to about 130° C. or such as from about 50° C. to about 100° C.

The composition of this disclosure may be suitable for any lubricant applications. When the long chain branched ethylene copolymer of the present invention is used in an engine oil lubricant composition, it typically further provides better fuel economy performance. Examples of a lubricant include an engine oil for a 2-stroke or a 4-stroke internal combustion engine, a gear oil, an automatic transmission oil, a hydraulic fluid, a turbine oil, a metal working fluid or a circulating oil.

In one embodiment the internal combustion engine may be a diesel-fueled engine, a gasoline fueled engine, a natural gas fueled engine or a mixed gasoline/alcohol fueled engine. In one embodiment the internal combustion engine is a diesel fueled engine and in another embodiment a gasoline fueled engine. Suitable internal combustion engines include marine diesel engines, aviation piston engines, low-load diesel engines, and automobile and truck engines.

### Long Chain Branched Ethylene Copolymer

The present disclosure relates to lubricant compositions comprising a long branched ethylene copolymer and lubrication oils. The present disclosure also relates to novel long chain branched ethylene copolymers. As used herein the term “long chain branched ethylene copolymer” is defined as the polymer molecular architecture obtained when a polymer chain (also referred to as macromonomer) with reactive polymerizable chain ends is incorporated into another polymer chain during the polymerization of the latter to form a structure comprising a backbone defined by one of the polymer chains with branches of the other macromonomer chains extending from the backbone. The side arms are of 50 carbons or longer, preferably 100 carbons or longer, more preferably longer than the entanglement length. The side arm can have the same composition as that in the backbone (referred as to homogeneous long chain branching). Alternatively, the composition in the side arms are different from that of the backbone. In some embodiments of the disclosure, additional branches may be on the side arms to form an architecture with branch-on-branch. A linear polymer differs structurally from the branched polymer because of lack of the extended side arms. In one embodiment, homogeneous long chain branching structures are preferred.

The term copolymer as used herein, unless otherwise indicated, includes terpolymers, tetrapolymers, interpolymers, etc., of ethylene and C₃₋₄₀ alpha-olefin and/or a non-conjugated diolefin or mixtures of such diolefins. Preferably the alpha-olefins have 3 to 12 carbon atoms such as propylene, 1-butene, 1-pentene, 3-rnethyl-1-butene, 1-hexene, 3-rnethyl-1-pentene, 4-rnethyl-1-pentene, 3-ethyl-1 pentene, 1-octene, 1-decene, 1-undecene (two or more of which may be employed in combination). Among those listed above, propylene is preferred. In one embodiment, the long chain branched ethylene copolymer is an ethylene/propylene copolymer. The ethylene copolymers (preferrably ethylene propylene copolymers) have long chain branched index (g′ᵥᵢₛ) of 0.97 or less, preferably 0.95 or less, preferably 0.92 or less, preferably 0.90 or less, preferably 0.87 or less, preferably 0.85 or less, preferably 0.83 or less, alternatively 0.80 or less, alternatively 0.75 or less, alternatively 0.70 or less. In an embodiment, the ethylene copolymers (preferrably ethylene propylene copolymers) have long chain branched index (g′ᵥᵢₛ) of from about 0.55 to about 0.85.

The ethylene-propylene polymers described herein are long chain branched, having a branching index (g′ᵥᵢₛ) less than −0.0003x+0.88 and greater than −0.0054x+1.08 where x is the percent total monomer conversion, and total monomer conversion is greater than 50%, preferably greater than 55%, preferrably greater than 60%, alternatively greater than 65%, alternatively greater than 70%, alternatively greater than 75%, alternatively greater than 80%, alternatively greater than 85%.

Alternatively, g′ᵥᵢₛ is less than −0.0003x+0.87, alternatively less than −0.0003x+0.86, alternatively less than −0.0003x+0.85 where x is the percent total monomer conversion

Alternatively, g′ᵥᵢₛ is greater than −0.0054x+1.09, alternatively greater than −0.0054x+1.10 where x is the percent total monomer conversion.

The branching index is determined using GPC-3D as described in the experimental section. Percent total monomer conversion is the percentage of monomers (such as ethylene and propylene) in the reactor that have been converted to polymer, and is related to the process and process conditions.

In at least one embodiment, the ethyelene copolymer is free of diene and/or polyene.

In at least one embodiment, the copolymer has an ethylene content, as determined by FTIR, of less than about 80 wt %, such as less than about 78 wt %, such as less than about 77 wt %, such as less than about 76 wt %, such as less than about 75 wt %, such as from about 40 wt % to less about 80 wt %, such as from about 43 wt % to about 78 wt %, such as from about 45 wt % to about 70 wt %. Alternatively, the weight percent of ethylene in the ethylene copolymer is at least 40 wt %. In alternative embodiments, the ethylene copolymer is about 40 wt % ethylene to about 75 wt % ethylene or about 40 wt % ethylene to about 50 wt % ethylene.

In one or more embodiments, the ethylene-based copolymer is substantially, or completely amorphous. Substantially amorphous as used herein means less than about 2.0 wt. % crystallinity. Preferably, amorphous ethylene-based copolymers have less than about 1.5 wt. % crystallinity, or less than about 1.0 wt. % crystallinity, or less than about 0.5 wt. % crystallinity, or less than 0.1 wt. % crystallinity.

In an alternative embodiment, the inventive polymers have low crystallinity with at heat of fusion of the ethylene-propylene copolymer of less than 10 J/g, alternatively less than 8 J/g, alternatively less than 5 J/g, alternatively less than 4 J/g, alternatively less than 2 J/g, alternatively less than 1 J/g, alternatively 0 J/g as measured by DSC.

In a preferred embodiment, the amorphous ethylene-based copolymer does not exhibit a melt peak as measured by DSC.

For branched ethylene-propylene copolymers that exhibit a polymer melting temperature (Tm), the heat of fusion (J/g) of the ethylene-propylene copolymer correlates to the amount of ethylene in the polymer. The branched ethylene-propylene copolymers exhibiting crystallinity herein have a heat of fusion less than 2.8y-134, alternatively less than 1.47y-64 where y is the wt % of ethylene as measured by FTIR ASTM D3900.

In a preferred embodiment, the ethylene-propylene copolymer has a melting point (Tm) of less than 50° C., alternatively less than 45° C., or alternatively less than 40° C. as measured by DSC.

The ethylene content of the long chain branched (LCB) ethylene copolymers and ethylene content in chain segments of a polymer molecule play important roles in low temperature properties of lubrication. In one embodiment, the ethylene content of the LCB ethylene copolymer needs to be lower than 50%, having more randomness, and not having high ethylene content segments or another monomer's content segments in a polymer chain (e.g., propylene) to promote crystallization.

The copolymerization of monomer M1 and monomer M2 leads to two types of polymer chains-one with monomer M1 at the propagating chain end (M1*) and other with monomer M2 at the propagating chain end (M2*). Four propagation reactions are then possible. Monomer M1 and monomer M2 can each add either to a propagating chain ending in monomer M1 or to one ending in monomer M2, i.e.,

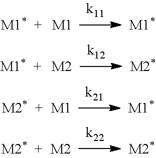

where k₁₁ is the rate constant for inserting M1 to a propagating chain ending in M1 (i.e. M1*), k₁₂ is the rate constant for inserting M2 to a propagating chain ending in M1 (i.e., M1*), and so on. The monomer reactivity ratio r₁ and r₂ are defined as

$$\\ {r}_{1} = \frac{{k}_{11}}{{k}_{12}} ; {r}_{2} = \frac{{k}_{22}}{{k}_{21}}$$

r₁ and r₂ as defined above is the ratio of the rate constant for a reactive propagating species adding its own type of monomer to the rate constant for its addition of the other monomer. The tendency of two monomers to copolymerize is noted by values of r₁ and r₂. An r₁ value greater than unity means that M1* preferentially inserts M1 instead of M2, while an r₁ value less than unity means that M1* preferentially inserts M2. An r₁ value of zero would mean that M1 is incapable of undergoing homopolymerization.

The preferential insertions of two monomers in the copolymerization lead to three distinguish polymer chain structures. When the two monomers are arranged in an alternating fashion, the polymer is called an alternating copolymer:
M1-M2-M1-M2-M1-M2-M1-M2-M1-M2-M1-M2-M1-M2-

In a random copolymer, the two monomers are inserted in a random order:
M1-M1-M2-M1-M2-M2-M1-M2-M1-M1-M2-M2-M2-M1-

In a block copolymer, one type of monomer is grouped together in a chain segment, and another one is grouped together in another chain segments. A block copolymer can be thought of as a polymer with multiple chain segments with each segment consisting of the same type of monomer:
M2-M2-M2-M2-M1-M1-M1-M2-M2-M2-M1-M1-M1-M1-.

The classification of the three types of copolymers can be also reflected in the reactivity ratio product, r₁r₂. As is known to those skilled in the art, when r₁r₂=1, the polymerization is called ideal copolymerization. Ideal copolymerization occurs when the two types of propagating chains M1* and M2* show the same preference for inserting M1 or M2 monomer. The copolymer is “statistically random”. For the case, where the two monomer reactivity ratios are different, for example, r₁>1 and r₂<1 or r₁<1 and r₂>1, one of the monomers is more reactive than the other toward both propagating chains. The copolymer will contain a larger proportion of the more reactive monomer in random placement.

When both r₁ and r₂ are greater than unity (and therefore, also r₁r₂>1), there is a tendency to form a block copolymer in which there are blocks of both monomers in the chain. For the special case of r₁>>r₂ (i.e. r₁>>1 and r₂<<1), both types of propagating chains preferentially add to monomer M1. There is a tendency toward “consecutive homopolymerization” of the two monomers to form block copolymer. A copolymer having reactivity product, r₁r₂, greater than 1.5 contains relatively long homopolymer sequences and is said to be “blocky”.

The two monomers enter into the copolymer in equi-molar amounts in a nonrandom, alternating arrangement along the copolymer chain when r₁r₂=0. This type of copolymerization is referred to as alternating copolymerization. Each of the two types of propagating chains preferentially adds to the other monomer, that is, M1 adds only to M2* and M2 adds only to M1*. The copolymer has the alternating structure irrespective of the co-monomer feed composition.

The behavior of most copolymer systems lies between the two extremes of ideal and alternating copolymerization. As the r₁r₂ product decreases from unity toward zero, there is an increasing tendency toward alternation. Perfect alternation will occur when r₁ and r₂ become progressively less than unity. In other words, a copolymer having a reactivity ratio product r₁r₂ of between 0.75 and 1.5 is generally said to be random. When r₁r₂>1.5 the copolymer is said to be “blocky”.

The reactivity ratio product is described more fully in Textbook of Polymer Chemistry, F. W. Billmeyer, Jr., Interscience Publishers, New York, p. 221 et seq. (1957). For a copolymer of ethylene and propylene, the reactivity ratio product r₁r₂, where r₁ is the reactivity ratio of ethylene and r₂ is the reactivity ratio of propylene, can be calculated from the measured diad distribution (PP, EE, EP and PE in this nomenclature) using ¹³C NMR by the application of the following formulae: r₁r₂=4 (EE)(PP)/(EP)².

In one embodiment, the long chain branched ethylene copolymer has a r₁r₂ less than 2.0 and greater than 0.45.

In yet another embodiment, the branched ethylene-propylene copolymers have an r₁r₂ of from less than 1.5 to greater than 0.45. Alternatively, the branched ethylene-propylene copolymers have an r₁r₂ from less than 1.3 (preferably less than 1.25, more preferably less than 1.2), and from greater than 0.5 (preferably greater than 0.6, more preferably greater than 0.7, alternatively greater than 0.8).

In some embodiments of the present disclosure, the r₁r₂ is less than 1.5 and greater than 0.8 indicating a truly random copolymer.

The inventive branched ethylene-propylene copolymers herein have a unique “average sequence length for methylene sequences six and longer” and a unique “percentage of methylene sequence length of 6 or greater” as measured by ¹³C NMR as described in “Methylene sequence distributions and average sequence lengths in ethylene-propylene copolymers,” Macromolecules, 1978, 11, 33-36 by James C. Randall.

In still yet another embodiment, the branched ethylene-propylene copolymers herein have an “average sequence length for methylene sequences six and longer” less than 0.1869z-0.30 and greater than 0.1869z-1.9 where z is the mol % of ethylene as measured by ¹³C NMR.

Alternatively, the “average sequence length for methylene sequences six and longer” is less than 0.1869z-0.35, alternatively less than 0.1869z-0.40, alternatively less than 0.1869z-0.45, alternatively less than 0.1869z-0.50, alternatively less than 0.1869z-0.55, alternatively less than 0.1869z-0.60, alternatively less than 0.1869z-0.65, or alternatively less than 0.1869z-0.70.

Alternatively, the “average sequence length for methylene sequences six and longer” is greater than 0.1869z-1.8, alternatively greater than 0.1869z-1.7, alternatively greater than 0.1869z-1.6, or alternatively greater than 0.1869z-1.5.

The branched ethylene-propylene copolymers used herein also have a “percentage of methylene sequence length of 6 or greater” less than 1.3z-35.5 and is greater than 1.3z-50 where z is the mol % of ethylene as measured by ¹³C NMR.

Alternatively, the “percentage of methylene sequence length of 6 or greater” is less than 1.3x-36.0, alternatively less than 1.3x-36.5, alternatively less than 1.3x-37.0, alternatively less than 1.3x-37.5, alternatively less than 1.3x-38.0, alternatively less than 1.3x-38.5, or alternatively less than 1.3x-39.0.

Alternatively, the “percentage of methylene sequence length of 6 or greater” is greater than 1.3z-49, alternatively greater than 1.3z-48, alternatively greater than 1.3z-47, alternatively greater than 1.3z-46, alternatively greater than 1.3z-45.5.

In some embodiments of the present disclosure, the long chain branched ethylene copolymer has a shear thinning ratio of greater than 0.5027*EXP(2E-05*w) where w is the Mw(LS) from light scattering GPC-3D.

In at least one embodiment, the branched ethylene copolymer has an Mw(LS) of from about 30,000 to about 300,000 g/mol; an Mz(LS) of from about 100,000 g/mol to 900,000 g/mol, such as from about 160,000 g/mol to about 900,000 g/mol, such as from about 180,000 g/mol to about 800,000 g/mol, or such as from about 190,000 g/mol to about 750,000 g/mol; and a polydispersity (PDI defined as Mw(LS)/Mn(DRI), as determined by GPC of about 1.5 to about 7.5, such as from about 1.7 to 7, such as from about 2.0 to about 6.5, such as from about 2.2 to about 6.0.

In at least one embodiment, the ethylene copolymer has a unimodal or multimodal molecular weight distribution as determined by Gel Permeation Chromotography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In one embodiment, the olefin monomers (typically ethylene and propylene) can be copolymerized with at least one diene monomer to create cross-linkable copolymers. Suitable diene monomers include any hydrocarbon structure, preferably C₄ to C₃₀, having at least two unsaturated bonds. Preferably, the diene is a nonconjugated diene with at least two unsaturated bonds, wherein one of the unsaturated bonds is readily incorporated into a polymer. The second bond may partially take part in polymerization to form cross-linked polymers but normally provides at least some unsaturated bonds in the polymer product suitable for subsequent functionalization (such as with maleic acid or maleic anhydride), curing or vulcanization in post polymerization processes. Examples of dienes include, but are not limited to butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and polybutadienes having a molecular weight (Mw) of less than 1000 g/mol. Examples of straight chain acyclic dienes include, but are not limited to 1,4-hexadiene and 1,6-octadiene. Examples of branched chain acyclic dienes include, but are not limited to 5-methyl-1,4-hexadiene, 3,7-dimethyl-1,6-octadiene, and 3,7-dimethyl-1,7-octadiene. Examples of single ring alicyclic dienes include, but are not limited to 1,4-cyclohexadiene, 1,5-cyclooctadiene, and 1,7-cyclododecadiene. Examples of multi-ring alicyclic fused and bridged ring dienes include, but are not limited to tetrahydroindene; methyl-tetrahydroindene; dicyclopentadiene; bicyclo-(2.2.1)-hepta-2,5-diene; 2,5-norbornadiene; and alkenyl-, alkylidene-, cycloalkenyl-, and cylcoalkyliene norbornenes [including, e.g., 5-methylene-2-norbornene, 5-ethylidene-2-norbornene (ENB), 5-propenyl-2-norbornene, 5-isopropylidene-2-norbornene, 5-(4-cyclopentenyl)-2-norbornene, 5-cyclohexylidene-2-norbornene, and 5-vinyl-2-norbornene]. Examples of cycloalkenyl-substituted alkenes include, but are not limited to vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. 5-Ethylidene-2-norbornene (ENB) is a preferred diene in particular embodiments. In one embodiment, the long chain branchs are formed in a post reactor process.

Diene monomers as utilized in some embodiments have at least two polymerizable unsaturated bonds that can readily be incorporated into polymers to form cross-linked polymers in a polymerization reactor. A polymerizable bond of a diene is referred as to a bond that can be incorporated or inserted into a polymer chain during the polymerization process of a growing chain. Diene incorporation is often catalyst specific. For polymerizations using metallocene catalysts, examples of such dienes include α-ω-dienes (such as butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, and 1,13-tetradecadiene) and certain multi-ring alicyclic fused and bridged ring dienes (such as tetrahydroindene; 7-oxanorbornadiene, dicyclopentadiene; bicyclo-(2.2.1)-hepta-2,5-diene; 5-vinyl-2-norbornene; 3,7-dimethyl-1,7-octadiene; 1,4-cyclohexadiene; 1,5-cyclooctadiene; 1,7-cyclododecadiene and vinyl cyclohexene). In one embodiment of polymer compositions, the content of diene with at least two polymerizable bonds in the inventive polymer composition is less than 0.5 wt %, and preferably less than 0.1 wt % of the copolymer. In another embodiment, the long chain branched ethylene copolymer is free of diene.

Long chain branched structures can also be observed by Small Amplitude Oscillatory Shear (SAOS) measurement of the molten polymer performed on a dynamic (oscillatory) rotational rheometer. From the data generated by such a test it is possible to determine the phase or loss angle, which is the inverse tangent of the ratio of G″ (the loss modulus) to G′ (the storage modulus). For a typical linear polymer, the loss angle at low frequencies approaches 90 degrees, because the chains can relax in the melt, adsorbing energy, and making the loss modulus much larger than the storage modulus. As frequencies increase, more of the chains relax too slowly to absorb energy during the oscillations, and the storage modulus grows relative to the loss modulus. Eventually, the storage and loss moduli become equal and the loss angle reaches 45 degree. In contrast, a branched chain polymer relaxes very slowly, because the branches need to retract first before the chain backbone can relax along its tube in the melt. This polymer never reaches a state where all its chains can relax during an oscillation, and the loss angle never reaches 90 degrees even at the lowest frequency of the experiments. The loss angle is also relatively independent of the frequency of the oscillations in the SAOS experiment; another indication that the chains cannot relax on these timescales. In one embodiment, the phase angle of the long chain branched ethylene copolymer is 70 degree or less, preferably 60 degree or less, and more preferably 50 degree or less. Alternatively, the tan (δ) of the oil extended ethylene copolymer is 2.5 or less, 1.7 or less, or 1.2 or less.

As known by persons of ordnary skill in the art, rheological data may be presented by plotting the phase angle versus the absolute value of the complex shear modulus (G*) to produce a van Gurp-Palmen plot. Conventional ethylene copolymers without long chain branches exhibit a negative slope on the van Gurp-Palmen plot. For LCB ethylene copolymers, the phase angels shift to a lower value as compared with the phase angle of a linear ethylene copolymer without long chain branches at the same value of G*. In one embodiment, the phase angle of the ethylene copolymers described herein is less than 70 degrees in a range of the complex shear modulus from 50,000 Pa to 1,000,000 Pa. Alternatively, an an embodiment, the branched ethylene copolymers described herein have a phase angle of 70° or less at G*=8000 Pa and 40° or less at G*=100,000 Pa·190° C.

The long chain branched ethylene copolymers described herein preferably have significant shear induced viscosity thinning. Shear thinning is characterized by the decrease of the complex viscosity with increasing shear rate. One way to quantify the shear thinning is to use a ratio of complex viscosity at a frequency of 0.1 rad/s to the complex viscosity at a frequency of 100 rad/s. Preferably, the complex viscosity ratio of the ethylene copolymer is 5 or more, more preferably 10 or more, even more preferably 20 or more when the complex viscosity is measured at 190° C.

The long chain branched ethylene copolymers described herein have a melt flow rate (MFR, measured at 230° C. and 2.16 kg) of 250 g/10 min or less, 140 g/10 min or less, 120 g/10 min or less, 100 g/10 min or less, 50 g/10 min or less, 20 g/10 min or less. The long chain branched ethylene copolymers used herein have a high load melt flow rate (HLMFR, measured at 230 C and 21.6 kg) of 2500 g/min or less, 1500 g/min or less, 1000 g/min or less, 800 g/min or less. A melt flow index ratio (HLMFR/MFR) of 10 or more, 20 or more, or 50 or more.

The long chain branched ethylene copolymers described herein have Mooney viscosity ML (1+4 at 125° C.) ranging from a low of any one of about 2, 10 and 20 MU (Mooney units) to a high of any one of about 30, 40, 50, 60, 80, 100 and 120 MU. The long chain branched ethylene copolymers described herein have a MLRA ranging from a low of any one of about 20, 30 and 40 mu*sec to a high of any one of about 50, 100, 200, 300, 400, 600, 650, 700, 800, 900, 1000, 1150, 1200, 1250, 1300, 1350, 1400, 1450, 1500, 1550, 1600, 1650, 1700, 1750, 1800, 1850, 1900, 1950, and 2000 mu*sec. For instance, the MLRA may be about 300 to about 2000 mu*sec, or from about 400 to about 1500 mu*sec, or from about 500 to about 1200 mu*sec. In certain embodiments, the MLRA may be at least 500 mu*sec, or at least 600 mu*sec, or at least 700 mu*sec.

Alternatively, the long chain branched ethylene copolymers described herein have a cMLRA at Mooney Large Viscosity ML=80 mu (Mooney units) ranging from a low of any one of about 200, 250, 300, 350, and 400 mu*sec to a high of any one of about 500, 550, 600, 650, 700, 800, 900, 1000, 1150, 1200, 1250, 1300, 1350, 1400, 1450, 1500, 1550, 1600, 1650, 1700, 1750, 1800, 1850, 1900, 1950, and 2000 mu*sec. For instance, the cMLRA may be about 240 to about 2000 mu*sec, or from about 400 to about 1500 mu*sec, or from about 500 to about 1200 mu*sec. In certain embodiments, the cMLRA may be at least 500 mu*sec (without a necessary upper boundary), or at least 600 mu*sec, or at least 700 mu*sec.

In still another aspect, the branched ethylene-propylene copolymers described herein have a glass transition temperature (Tg) within the range of from −60 or −50 or −40° C. to −10 or −5 or 0° C.

In still another aspect, the branched ethylene-propylene copolymers used herein have a melting point (Tm) within the range of from −30 or −20 or −10° C. to 10 or 20 or 30 or 40° C.

In a still another aspect, the branch ethylene-propylene copolymers described herein have a melting point (Tm) of less than 50° C., alternatively less than 45° C., or alternatively less than 40° C., alternatively less than 30° C. as measured by DSC.

The ethylene copolymers in some embodiments employed in the present disclosure comprises one or more ethylene copolymers (a blend of two or more ethylene copolymers), each ethylene copolymer comprising units derived from two or more different C₂-C₁₂ alpha-olefins. Preferably, the ethylene contents of the ethylene copolymers are different. More preferably, one ethylene copolymer has ethylene content in fom 40 to 55 wt %, and another ethylene copolymer has ethylene content from 50 to 75 wt %. In one embodiment, both ethylene copolymers have a long chain branched architecture with g′ᵥᵢₛ from 0.50 to 0.97. Alternatively, only one ethylene copolymer is branched.

In embodiments where the copolymer is a reactor blended polymer, the copolymer may comprise from 40 to 55 wt % of the first polymer component, from 5 to 40 wt % of the second polymer component, based on the weight of the copolymer, where desirable ranges may include ranges from any lower limit to any upper limit. The copolymer may comprise from 55 to 97 wt % of the first polymer component, from 60 to 95 wt % of the first polymer component, from 65 to 92.5 wt % of the first polymer component, based on the weight of the copolymer, where desirable ranges may include ranges from any lower limit to any upper limit. In one embodiment, the reactor blend is produced in a system with parallel reactors. Alternatively, the reactor blend is produced in series reactors.

In another class of embodiments, the present disclosure provides a lubricant composition comprising a first and a second long chain branched copolymers wherein the first copolymer has an ethylene content higher than that of the second copolymer.

In another class of embodiments, the present disclosure provides a lubricant composition comprising first and second copolymers wherein the first copolymer is long chain branched and has an ethylene content higher than that of the second copolymer which is substantially linear.

In another class of embodiments, the present disclosure provides a lubricant composition comprising first and second copolymers wherein the first copolymer is substantially linear and has an ethylene content higher than that of the second copolymer which is long chain branched.

### Process to Produce Ethylene Copolymers

This disclosure is related to a lubricant composition comprising a long chain branched ethylene copolymer and a lubrication oil. This disclosure is also related to novel long chain branched ethylene copolymers. Long chain branched (LCB) ethylene copolymers can be produced either in polymerization reactors or through post reactor processes such as radical cross-linking using a peroxide or irradiation. For in-reactor approaches, the process comprises contacting ethylene and one or more olefins selected from C₃ to C₂₀ alpha-olefins, and one or more catalysts in one or more polymerization reactors. LCB structures are produced through various mechanisms depending on the catalyst systems. In Ziegler-Natta catalyst systems, for example, some conventional EPDM polymers have long chain branching produced via a cationic coupling of pendant double bonds. Terminal branching is one of branching mechanisms in metallocene catalyzed systems for in-situ long chain branching formation. LCB is formed through re-insertion of in-situ generated vinyl terminated macromonomers during the formation of a polymer chain. The catalyst is required to fulfill two functions in the polymerization process: (i) produce macromonomers/polymers with vinyl chain ends and (ii) incorporate the macromonomer/polymer through vinyl chain end insertion into a growing polymer chain to form the LCB. Catalyst selection is very limited for a process requiring a high level of LCB. Combining the proper catalyst with the proper process conditions, ethylene copolymers with a high level of LCB can be made. In one embodiment, the long chain branched ethylene copolymer described herein has a braching index, g′ᵥᵢₛ of 0.97 or less, preferably 0.92 or less, more preferally 0.90 or less, even more preferably 0.88 or less. The long chain branched ethylene copolymer described herein can be produced in the polymerization process using a single catalyst system.

In one embodiment, the long chain branched ethylene copolymers described herein are produced in a single reactor using one catalyst system. Both the backbone and sidearms of the long chain branched ethylene copolymer are produced in the same polymerization environment; and the composition for the backbone and sidearms are same. This type of long chain branched ethylene copolymer is called a homogeneous long chain branched polymer.

To enhance LCB level, dual catalysts have been explored. In a mixed catalyst system, at least one catalyst can produce vinyl-terminated macromonomer while another catalyst can reinsert the macromonomer. Each catalyst possesses a specific structure for the specific task. The two catalysts must be compatible in the same polymerization environment. Dual reactor is another option where more freedom is allowed in optimizing process condition for each task. In one embodiment, the long chain branched ethylene copolymer is made using multiple catalysts.

According to certain embodiments, the branched ethylene copolymer is produced by polymerizing ethylene, one or more α-olefins (preferably C₃ to C₁₂ α-olefins) in the presence of a dual metallocene catalyst system. The dual metallocene catalyst system includes: (1) a first metallocene catalyst capable of producing high molecular-weight polymer chains, and in particular capable of incorporating vinyl-terminated hydrocarbon chains into the growing high molecular-weight polymer chain; and (2) a second metallocene catalyst capable of producing lower molecular-weight polymer chains, and which further generates a relatively high percentage of vinyl-terminated polymer chains. Dual catalyst systems also provide the ways to produce the long chain branched ethylene copolymers with bomodal distribution of ethylene content. For example, the ethylene content for the copolymer derived from the first catalyst is in a range of about 40 to 55 wt %, and the the ethylene content for the copolymer derived from the second catalyst is in a range of about 50 to 70 wt %.

Macromonomer re-insertion is controlled through reaction kinetics and mass transfer. From reaction kinetic point of view, the macromonomer incorporation competes with monomer insertion (or propagation) during chain growth. Process conditions play important roles for degree of LCB. A process with low monomer concentration and high concentration of vinyl terminated macromonomers favors the macromonomer reinsertion. In one embodiment, a process with low monomer concentration and high polymer concentration is preferred. For example, the ethylene concentration is 1.0 mol/L or less, and polymer concentration is 0.01 mol/L or more. The level of branching is also influenced by the extent to which monomer is converted into polymer. At high conversions, where little monomer remains in the solvent, conditions are such that vinyl terminated chains are incorporated into the growing chains more frequently, resulting in higher levels of LCB. Catalyst levels may be adjusted to influence the level of conversion as desired.

One way to increase the reactive group on a polymer chain is to incorporate diene with two polymerizable double bonds into the polymer chain. Long chain branching can occur in polymerization through reactions of a pendent unsaturation on the chain. LCB structures are achieved through the copolymerization of dienes having two polymerizable double bonds such as norbornadiene, dicyclopentadiene, 5-vinyl-2-norbornene (VNB) or alpha-omega dienes in a metallocene catalyzed system. Each insertion of a diene into a growing polymer chain produces a dangling vinyl group. These reactive polymer chains can then be incorporated into another growing polymer chain through the second dangling double bond of a diene. This doubly inserted diene creates a linkage between two polymer chains and leads to branched structures. The branching structure formed through diene linkage between polymer chains is referred as to “H” type and has a tetra-functional branching structure due to short diene bridge. Comparing with terminal branching, the diene is distributed along a polymer chain and number of vinyl groups is proportional to the number of diene incorporated on each molecule. In addition to the overall higher amount of vinyl groups, incorporation of diene also changes the placement of vinyl groups along the polymer chain as compared with vinyl-terminated macromonomers. The number of branches and level of branches (branches on branches) depend on the amount of diene incorporated. Higher molecular weight polymer chains incorporate more diene on per molecule base (i.e., the longer molecules contain more vinyl than the shorter ones). Thus the LCB level increases with molecular weight and concentration of polymer chains (also referred as cement loading). The challenge in polymerization process is to control the level of branching and excessive branching will lead to gel formation. Precise process control is required to eliminate gel formation. In one embodiment, the diene with at least two polymerizable bonds are employed to produce long chain branched ethylene copolymers used herein.

Long chain branching architectures can also be made using a living polymerization catalyst, and an aluminum vinyl-transfer agent (AVTA) represented by the formula: Al(R′)₃₋ᵥ(R)ᵥ with R defined as a hydrocarbenyl group containing 4 to 20 carbon atoms and featuring an allyl chain end, R′ defined as a hydrocarbyl group containing 1 to 30 carbon atoms, and v defined as 0.1 to 3 (such as 1 or 2). Some olefin polymerization catalysts readily undergo reversible polymeryl group chain transfer with the added aluminum vinyl transfer agent (AVTA) and are also capable of incorporating the vinyl group of the AVTA to form a long-chain branched polymer. In one embodiment, the long chain branched ethylene copolymer is free of the aluminum-capped species Al(R′)₃₋ᵥ(polymer-CH═CH₂)ᵥ, where v is 0.1 to 3 (alternately 1 to 3, alternately 1, 2, or 3). In another embodiment, the polymerization processes employed to produce the long chain branched ethylene copolymer employed in the compositions of the present disclosure is free of AVTA.

In one embodiment, the ethylene copolymers described herein can also be produced in a system with multiple reactors. A blend of ethylene copolymers, with each component has different ethylene content and/or molecular weight, can be produced. The system can be adjusted to produce the polymer blends with desired properties for each component. Preferably, one component has an ethylene content of 50 wt % or less, and another component has an ethylene content of 60 wt % or more.

In some embodiments, multiple catalysts are employed. The multiple catalysts can be used in a single polymerization zone or multiple reaction zones in the same system. The catalysts employed in the first reaction zone include those capable of producing polymers with polymerizable unsaturated chain ends, while the catalysts used in the second reaction zone include those capable of incorporating the polymerizable polymers into a growing chain to form branched ethylene copolymers with extended side arms.

In at least one embodiment, little or no scavenger is used in the process to produce the ethylene polymer used herein. A scavenger (such as tri alkyl aluminum) in this embodiment, when used, can be present at a molar ratio of scavenger metal to transition metal of less than about 100:1, such as less than about 50:1, such as less than about 15:1, or such as less than about 10:1.

Each of the various polymerization processes can be carried out using general polymerization techniques known in the art. Any suspension, homogeneous, bulk, solution, slurry, or gas phase polymerization process known in the art can be used. Such processes can be run in a batch, semi-batch, or continuous mode. Homogeneous polymerization processes is preferred. A homogeneous polymerization process is defined to be a process where at least 90 wt % of the product is soluble in the reaction media. A bulk process is defined to be a process where the monomer itself is used as the reaction medium and monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Since either batch or continuous polymerization processes may be used, references herein to monomer ratios and ratios of monomer feed rates should be considered interchangeable. For instance, where a ratio between a first monomer and second monomer to be copolymerized is given as 10:1, that ratio may be the ratio of moles present in a batch process, or the ratio of molar feed rates in a continuous process. Similarly, where catalyst ratios are given, such ratios should be considered as ratios of moles present in a batch process, or equivalently as ratios of molar feed rates into a continuous process.

Furthermore, although known polymerization techniques may be employed, particular process conditions (e.g., temperature and pressure) can be used. Temperatures and/or pressures generally may include a temperature from about 0° C. to about 300° C. Examples of which include from a low of any one of about 20, 30, 35, 40, 45, 50, 55, 60, 65, and 70° C. to a high of any one of about 100, 110, 120, 130, 140, 150, 160, 170, 180, 190, 200, 250, and 300° C. For example, polymerization temperatures may fall within the range of from about 40° C. to about 200° C., alternatively from about 45° C. to about 150° C., alternatively from about 70° C. to about 150° C., alternatively from about 70° C. to about 145° C. or, in particular embodiments, from about 80° C. to about 130° C. Pressure may depend on the desired scale of the polymerization system. For instance, in some polymerizations, pressure may generally range from about ambient pressure to 200 MPa. In various such embodiments, pressure may range from a low of any one of about 0.1, 1, 5, and 10 to a high of any one of about 3, 5, 10, 15, 25, 50, 100, 150, and 200 MPa, provided the high end of the range is greater than the low end. According to such embodiments, pressure is preferably in a range of about 2 to about 70 MPa.

In a typical polymerization, the run time (also referred as to residence time) of the reaction is up to 300 minutes, preferably in the range of from about 5 to 250 minutes, or more preferably from about 10 to 120 minutes. Alternatively, the run time of reaction may preferably be in a range of 5 to 30 minutes when a solution process is employed. The run time of reaction is preferably in a range of 30 to 180 minutes when a slurry or gas phase process is employed. The run time of reaction and reactor residence time are used interchangeably herein.

In some embodiments, hydrogen is present in the polymerization reactor at a partial pressure of 0.001 to 345 kPa, preferably from 0.01 to 172 kPa, and more preferably 0.1 to 70 kPa. Alternatively, 500 ppm or less, or 400 ppm or less, or 300 ppm of less of hydrogen is added into the reactor. In another embodiment, at least 50 ppm of hydrogen is added, or 100 ppm, or 200 ppm. Thus, certain embodiments include hydrogen added to the reactor in amounts ranging from a low of any one of about 50, 100, 150, and 200 ppm to a high of any one of about 250, 300, 350, 400, 450, and 500 ppm.

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins that may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic; preferably, aromatics are present in the solvent at less than 1 wt %, preferably less than 0.5 wt %, and more preferably less than 0.1 wt % based upon the weight of the solvents.

In some embodiments, the activity of the catalyst system is at least 50 g/mmol/hour, preferably 500 or more g/mmol/hour, preferably 5000 or more g/mmol/hr, preferably 50,000 or more g/mmol/hr, or more preferably 100,000 or more g/mmol/hr. Alternatively, the catalyst efficiency is 10,000 kg of polymer per kg of catalyst or more, preferably, 50,000 kg of polymer per kg of catalyst or more, or more preferably 100,000 kg of polymer per kg of catalyst or more.

Other additives may also be used in the polymerization, as desired, such as one or more scavengers, promoters, modifiers, chain transfer agents (such as dialkyl zinc, typically diethyl zinc), reducing agents, oxidizing agents, hydrogen, aluminum alkyls, or silanes.

A polymer can be recovered from the effluent of any one or more polymerizations by separating the polymer from other constituents of the effluent using conventional separation means. For example, the polymer can be recovered from a polymerization effluent by coagulation with a non-solvent such as isopropyl alcohol, acetone, or n-butyl alcohol, or the polymer can be recovered by stripping the solvent or other media with heat or steam. One or more conventional additives such as antioxidants can be incorporated in the polymer during the recovery procedure. Possible antioxidants include phenyl-beta-naphthylamine; di-tert-butylhydroquinone, triphenyl phosphate, heptylated diphenylamine, 2,2′-methylene-bis (4-methyl-6-tert-butyl)phenol, and 2,2,4-trimethyl-6-phenyl-1,2-dihydroquinoline. Other methods of recovery such as by the use of lower critical solution temperature (LCST) followed by devolatilization are also envisioned. The catalyst may be deactivated as part of the separation procedure to reduce or eliminate further uncontrolled polymerization downstream the polymer recovery processes. Deactivation may be effected by the mixing with suitable polar substances such as water, whose residual effect following recycle can be counteracted by suitable sieves or scavenging systems.

In an embodiment, the polymerization: 1) is conducted at temperatures of 0 to 300° C. (preferably 25 to 150° C., preferably 40 to 140° C., and more preferably 50 to 130° C.); 2) is conducted at a pressure of atmospheric pressure up to 20 MPa (preferably 0.35 to 16 MPa, preferably from 0.45 to 12 MPa, and more preferably from 0.5 to 10 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents) or aromatic solvents such as toluene, benzene or xylenes; 4) wherein the catalyst system used in the polymerization comprises less than 0.5 mol %, preferably 0 mol % alumoxane, alternately the alumoxane is present at a molar ratio of aluminum to transition metal 500:1 or less, preferably 300:1 or less, and more preferably 100:1 or less,) the polymerization preferably occurs in one or two reaction zones; 6) the productivity of the catalyst compound is at least 50,000 g polymer/g catalyst (preferably at least 80,000 g polymer/g catalyst, preferably at least 100,000 g polymer/g catalyst, preferably at least 150,000 g polymer/g catalyst, preferably at least 200,000 g polymer/g catalyst, and more preferably at least 300,000 g polymer/g catalyst); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 20:1, and more preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), and more preferably 0.1 to 10 psig (0.7 to 70 kPa)). In an embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In an embodiment, the polymerization occurs in one or alternatively two reaction zones.

### Catalysts

Suitable catalysts for producing long chain branched ethylene copolymers are those capable of polymerizing a C₂ to C₂₀ olefin and incorporating polymerizable macromonomer to form branching architectures. These include metallocene, post metallocene or other single site catalyst, and Ziegler-Natta catalysts. The term “post-metallocene catalyst”, also known as “non-metallocene catalyst” describe transition metal complexes that do not feature any pi-coordinated cyclopentadienyl anion donors (or the like) and are useful the polymerization of olefins when combined with common activators. See Baier, M. C.; Zuideveld, M. A.; Mecking, S. Angew. Chem. Int. Ed. 2014, 53, 2-25; Gibson, V. C., Spitzmesser, S. K. Chem. Rev. 2003, 103, 283-315; Britovsek, G. J. P., Gibson, V. C., Wass, D. F. Angew. Chem. Int. Ed. 1999, 38, 428-447; Diamond, G. M. et al. ACS Catal. 2011, 1, 887-900; Sakuma, A., Weiser, M. S., Fujita, T. Polymer J. 2007, 39:3, 193-207. See also U.S. Pat. Nos. 6,841,502, 7,256,296, 7,018,949, 7,964,681.

Particularly useful catalyst compounds include metallocene catalysts, such as bridged group 4 transition metal (e.g., hafnium or zirconium, preferably hafnium) metallocene catalyst compounds having two indenyl ligands. The indenyl ligands in some embodiments have various substitutions. In particular embodiments, the metallocene catalyst compounds, and catalyst systems comprising such compounds, are represented by the formula (1):

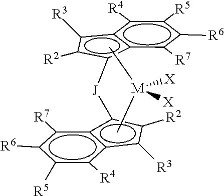

where: (1) J is a divalent bridging group comprising C, Si, or both; (2) M is a group 4 transition metal (preferably Hf); (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl (such as C₁-C₅₀ substituted or unsubstituted halocarbyl), provided that any one or more of the pairs R⁴ and R⁵, R⁵ and R⁶, and R⁶ and R⁷ may optionally be bonded together to form a saturated or partially saturated cyclic or fused ring structure. Such compounds are also referred to as bis-indenyl metallocene compounds.

In certain embodiments, each X is, independently, selected from the group consisting of hydrocarbyl radicals having from 1 to 20 carbon atoms, hydrides, amides, alkoxides, sulfides, phosphides, halides, dienes, amines, phosphines, ethers, and a combination thereof. Two Xs may form a part of a fused ring or a ring system. In particular embodiments, each X is independently selected from halides and C₁ to C₅ alkyl groups. For instance, each X may be a chloro, bromo, methyl, ethyl, propyl, butyl or pentyl group. In specific embodiments, each X is a methyl group.

In some particular embodiments, each R², R³, R⁴, R⁵, R⁶, and R⁷ is independently selected from the following: H; CH₃; CH₂CH₃; CH₂CH₂CH₃; CH₂(CH₂)₂CH₃; CH₂(CH₂)₃₋₃₀CH₃; CH₂C(CH₃)₃; CH═CH₂; CH(CH₃)₂; CH₂CH(CH₃)₂; CH₂CH₂CH(CH₃)₂; C(CH₃)₂CH(CH₃)₂; CH(C(CH₃)₃)CH(CH₃)₂; C(CH₃)₃; CH₂C(CH₃)₃CH₂Si(CH₃)₃; CH₂Ph; C₃H₅, C₄H₇; CsH₉; C₆H₁₁; C₇H₁₃; C₈H₁₅; C₉H₁₇; CH₂CH═CH₂; CH₂CH₂CH═CH₂; CH₂CH₂(CF₂)₇CF₃; CF₃; N(CH₃)₂; N(C₂H₅)₂; and OC(CH₃)₃. In some particular embodiments, each R², R³, R⁴, R⁵, R⁶, and R⁷ is independently selected from hydrogen, or C₁-C₁₀ alkyl (preferably hydrogen, methyl, ethyl, propyl, butyl, pentyl, heptyl, hexyl, octyl, nonyl, decyl or an isomer thereof).

In yet other embodiments, each R³ is H; each R⁴ is independently C₁-C₁₀ alkyl (preferably methyl, ethyl, propyl, butyl, pentyl, heptyl, hexyl, octyl, nonyl, decyl or an isomer thereof); each R², and R⁷ is independently hydrogen, or C₁-C₁₀ alkyl); each R⁵ and R⁶ is independently hydrogen, or a C₁-C₅₀ substituted or unsubstituted hydrocarbyl (preferably hydrogen or a C₁-C₁₀ alkyl); and R⁴ and R⁵, R⁵ and R⁶ and/or R⁶ and R⁷ may optionally be bonded together to form a ring structure.

In more specific embodiments, each R² and each R³ are hydrogen, and each R⁴ is independently a C₁ to C₄ alkyl group, preferably methyl, ethyl, n-propyl, cyclopropyl, or n-butyl, and each R⁵, R⁶ and R⁷ are independently hydrogen, or C₁-C₁₀ alkyl, and R⁵ and R⁶ may optionally be bonded together to form a ring structure.

In yet other specific embodiments, each R² is a C₁ to C₃ alkyl group, preferably methyl, ethyl, n-propyl, isopropyl or cyclopropyl, each R³, R⁵, and R⁶ is hydrogen, and R⁴ and R⁷ are, independently, a C₁ to C₄ alkyl group, preferably methyl, ethyl, propyl, butyl, or an isomer thereof.

In yet further specific embodiments, each R², R⁴, and R⁷ is independently methyl, ethyl, or n-propyl, each R⁵ and R⁶ is independently, a C₁ to C₁₀ alkyl group, preferably methyl, ethyl, propyl, butyl, pentyl, heptyl, hexyl, octyl, nonyl, decyl or an isomer thereof, R³ is hydrogen, and R⁵ and R⁶ are joined together to form a 5-membered partially unsaturated ring.

In yet further specific embodiments, each R⁴ and R⁷ is independently methyl, ethyl, or n-propyl, each R⁵ and R⁶ is independently, a C₁ to C₁₀ alkyl group, preferably methyl, ethyl, propyl, butyl, pentyl, heptyl, hexyl, octyl, nonyl, decyl or an isomer thereof, R² and R³ are hydrogen, and R⁵ and R⁶ are joined together to form a 5-membered partially unsaturated ring.

In yet further specific embodiments, each R⁴ and R⁷ is methyl, each R⁵ and R⁶ is independently, a C₁ to C₁₀ alkyl group, preferably methyl, ethyl, propyl, butyl, pentyl, heptyl, hexyl, octyl, nonyl, decyl or an isomer thereof, R² and R³ are hydrogen, and R⁵ and R⁶ are joined together to form a 5-membered partially unsaturated ring.

In one embodiment, R², R⁴ and R⁷ are the same, and are selected from the group consisting of C₁ to C₃ alkyl group (any isomer thereof), and R³, R⁵ and R⁶ are hydrogen. In yet other embodiments, R⁴ and R⁷ are the same, and are selected from the group consisting of C₁-C₃ alkyl (any isomer thereof), and R², R³, R⁵, and R⁶ are hydrogen or alternatively R² and R³ are hydrogen, while R⁵ and R⁶ are joined together to form a 5-membered partially unsaturated ring.

In certain embodiments of the catalyst compound, R⁴ is not an aryl group (substituted or unsubstituted). An aryl group is defined to be a single or multiple fused ring group where at least one ring is aromatic. A substituted aryl group is an aryl group where a hydrogen has been replaced by a heteroatom or heteroatom containing group. Examples of substituted and unsubstituted aryl groups include phenyl, benzyl, tolyl, carbazolyl, naphthyl, and the like. Likewise, in particular embodiments, R², R⁴ and R⁷ are not a substituted or unsubstituted aryl group. In even further embodiments, R², R⁴, R⁵, R⁶ and R⁷ are not a substituted or unsubstituted aryl group.

J may be represented by the formula (1a):

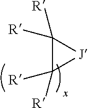

wherein J′ is C or Si (preferably Si), x is 1, 2, 3, or 4, preferably 2 or 3, and each R′ is, independently, hydrogen or C₁-C₁₀ hydrocarbyl, preferably hydrogen. Particular examples of J groups where J′ is silicon include cyclopentamethylenesilylene, cyclotetramethylenesilylene, cyclotrimethylenesilylene, and the like. Particular examples of J groups where J′ is carbon include cyclopropandiyl, cyclobutandiyl, cyclopentandiyl, cyclohexandiyl, and the like. In specific embodiments, J is preferrably cyclotetramethylenesilylene.

In a particular embodiment, J may be represented by the formula (R^{a}₂J′)ₙ where each J′ is independently C or Si (with J′ preferably Si), n is 1 or 2, and each R^{a} is, independently, C₁ to C₂₀ substituted or unsubstituted hydrocarbyl, provided that two or more R^{a} optionally may be joined together to form a saturated or partially saturated or aromatic cyclic or fused ring structure that incorporates at least one J′. Particular examples of J groups include dimethylsilylene, diethylsilylene, isopropylene, ethylene and the like.

In a particular embodiment, the bis-indenyl metallocene compound used herein is at least 95% rac isomer and the indenyl groups are substituted at the 4 position with a C₁ to C₁₀ alkyl group, the 3 position is hydrogen, the bridge is carbon or silicon which is incorporated into a 4, 5 or 6 membered ring. For instance, the catalyst compound may be the rac form of cyclotetramethylenesilylene-bis(4,8-dimethyl-1,5,6,7-tetrahydro-s-indacen-1-yl)hafnium dimethyl, shown below:

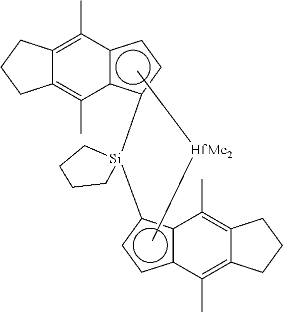

In one particular embodiment, the catalyst compound is in the rac form. For instance, at least 95 wt % of the catalyst compound may be in the rac form, based upon the weight of the rac and meso forms present. More particularly, at least any one of about 96, 97, 98, and 99 wt % of the catalyst compound may be in rac form. In one embodiment, the entire catalyst compound is in rac form. In some embodiments, mixtures of rac and meso isomers are considered to be a single catalyst compound, particularly when the meso content is less than 10% of the total isomers present.

Catalyst compounds that are of particular interest include one or more of the metallocene compounds listed and described in Paragraphs [0089]-[0090] of U.S. Ser. No. 14/325,449, filed Jul. 8, 2014, published Jan. 22, 2015 as US 2015/0025209, which is incorporated by reference herein. For instance, useful catalyst compounds may include any one or more of: cyclotetramethylenesilylene-bis(2,4,7-trimethylinden-1-yl)hafnium dimethyl; cyclopentamethylene-silylene-bis(2,4,7-trimethylinden-1-yl)hafnium dimethyl; cyclotrimethylenesilylene-bis(2,4,7-trimethylinden-1-yl)hafnium dimethyl; cyclotetramethylenesilylene-bis(2,4-dimethylinden-1-yl)hafnium dimethyl; cyclopentamethylenesilylene-bis(2,4-dimethylinden-1-yl)hafnium dimethyl, cyclotrimethylenesilylene-bis(2,4-dimethylinden-1-yl)hafnium dimethyl; cyclotetramethylenesilylene-bis(4,7-dimethylinden-1-yl)hafnium dimethyl; cyclopentamethylenesilylene-bis(4,7-dimethylinden-1-yl)hafnium dimethyl; cyclotrimethylenesilylene-bis(4,7-dimethylinden-1-yl)hafnium dimethyl; cyclotetramethylenesilylene-bis(2-methyl-4-cyclopropylinden-1-yl)hafnium dimethyl; cyclopentamethylenesilylene-bis(2-methyl-4-cyclopropylinden-1-yl)hafnium dimethyl, cyclotrimethylenesilylene-bis(2-methyl-4-cyclopropylinden-1-yl)hafnium dimethyl; cyclotetramethylenesilylene-bis(2-ethyl-4-cyclopropylinden-1-yl)hafnium dimethyl; cyclopentamethylene-silylene-bis(2-ethyl-4-cyclopropylinden-1-yl)hafnium dimethyl; cyclotrimethylenesilylene-bis(2-ethyl-4-cyclopropylinden-1-yl)hafnium dimethyl; cyclotetramethylenesilylene-bis(2-methyl-4-t-butylinden-1-yl)hafnium dimethyl; cyclopentamethylenesilylene-bis(2-methyl-4-t-butylinden-1-yl)hafnium dimethyl; cyclotrimethylenesilylene-bis(2-methyl-4-t-butylinden-1-yl)hafnium dimethyl, cyclotetramethylenesilylene-bis(4,7-diethylinden-1-yl)hafnium dimethyl; cyclopentamethylenesilylene-bis(4,7-diethylinden-1-yl)hafnium dimethyl; cyclotrimethylenesilylene-bis(4,7-diethylinden-1-yl)hafnium dimethyl; cyclotetramethylenesilylene-bis(2,4-diethylinden-1-yl)hafnium dimethyl; cyclopentamethylenesilylene-bis(2,4-diethylinden-1-yl)hafnium dimethyl; cyclotrimethylenesilylene-bis(2,4-diethylinden-1-yl)hafnium dimethyl; cyclotetramethylenesilylene-bis(2-methyl-4,7-diethylinden-1-yl)hafnium dimethyl; cyclopentamethylenesilylene-bis(2-methyl-4,7-diethylinden-1-yl)hafnium dimethyl; cyclotrimethylenesilylene-bis(2-methyl-4,7-diethylinden-1-yl)hafnium dimethyl; cyclotetramethylenesilylene-bis(2-ethyl-4-methylinden-1-yl)hafnium dimethyl; cyclopentamethylenesilylene-bis(2-ethyl-4-methylinden-1-yl)hafnium dimethyl; cyclotrimethylenesilylene-bis(2-ethyl-4-methylinden-1-yl)hafnium dimethyl; cyclotetramethylenesilylene-bis(2-methyl-4-isopropylinden-1-yl)hafnium dimethyl; cyclopentamethylenesilylene-bis(2-methyl-4-isopropylinden-1-yl)hafnium dimethyl; cyclotrimethylenesilylene-bis(2-methyl-4-isopropylinden-1-yl)hafnium dimethyl; cyclotetramethylenesilylene-bis(2,4,8-trimethyl-1,5,6,7-tetrahydro-s-indacen-1-yl)hafnium dimethyl; cyclopentamethylenesilylene-bis(2,4,8-trimethyl-1,5,6,7-tetrahydro-s-indacen-1-yl)hafnium dimethyl; cyclotrimethylenesilylene-bis(2,4,8-trimethyl-1,5,6,7-tetrahydro-s-indacen-1-yl)hafnium dimethyl; cyclotetramethylenesilylene-bis(4,8-dimethyl-1,5,6,7-tetrahydro-s-indacen-1-yl)hafnium dimethyl; cyclopentamethylenesilylene-bis(4,8-dimethyl-1,5,6,7-tetrahydro-s-indacen-1-yl)hafnium dimethyl; and cyclotrimethylenesilylene-bis(4,8-dimethyl-1,5,6,7-tetrahydro-s-indacen-1-yl)hafnium dimethyl.

Likewise, the catalyst compounds described herein may be synthesized in any suitable manner, including in accordance with procedures described in Paragraphs [0096] and [00247]-[00298] of U.S. Ser. No. 14/325,449, filed Jul. 8, 2014, and published Jan. 22, 2015 as US 2015/0025209, and which are incorporated by reference herein.

In at least one embodiment, a metallocene compound is selected from:

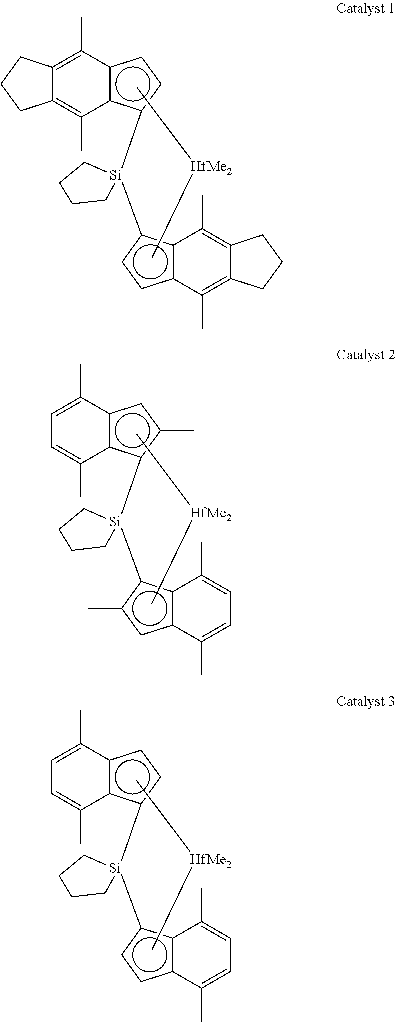

In some embodiments, catalyst 1 and catalyst 3 are preferred. In other embodiments, catalyst 1 is most preferred.

In some embodiments, a single catalyst is used which includes rac/meso isomers. Preferably, the single catalyst mixture is 95% or greater rac, and 5% or less meso. More preferably, the single catalyst mixture is 98% or greater rac, and 2% or less meso. Most preferrably, the single catalyst is greater that 99% rac.

### Activators

The terms “cocatalyst” and “activator” are used herein interchangeably and are defined to be any compound that can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Particular activators include alumoxane compounds, modified alumoxane compounds, and ionizing anion precursor compounds that abstract a reactive, σ-bound, metal ligand making the metal complex cationic and providing a charge-balancing noncoordinating or weakly coordinating anion. Any activator as described in Paragraphs [0110]-[0133] of U.S. Patent Pub. No. 2015/0025209, which description is incorporated herein by reference, may be used as the activator for the catalyst system.

Bulky activators as described therein are particularly useful NCAs. “Bulky activator” refers to anionic activators represented by the formula:

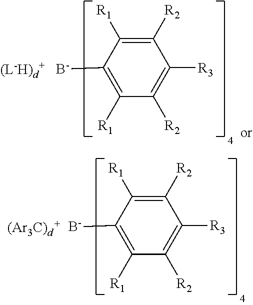

where: each R₁ is, independently, a halide, preferably a fluoride; Ar is substituted or unsubstituted aryl group (preferably a substituted or unsubstituted phenyl), preferably substituted with C₁ to C₄₀ hydrocarbyls, preferably C₁ to C₂₀ alkyls or aromatics; each R₂ is, independently, a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₂ is a fluoride or a perfluorinated phenyl group); each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₃ is a fluoride or a C₆ perfluorinated aromatic hydrocarbyl group); wherein R₂ and R₃ can form one or more saturated or unsaturated, substituted or unsubstituted rings (preferably R₂ and R₃ form a perfluorinated phenyl ring); and L is an neutral Lewis base; (L-H)⁺ is a Bronsted acid; d is 1, 2, or 3; wherein the anion has a molecular weight of greater than 1020 g/mol; and wherein at least three of the substituents on the B atom each have molecular volume >250 Å³, alternately >300 Å³, or >500 Å³. Molecular volume is determined as described in Paragraphs [0122]-[0123] of US 2015/0025209 (previously incorporated by reference herein).

Useful bulky activators include those in Paragraph [0124] of US 2015/0025209, and also those in Columns 7 and 20-21 in U.S. Pat. No. 8,658,556, which description is incorporated by reference. Particular examples of suitable NCA activators include: N,N-dimethylanilinium tetrakis(perfluorophenyl)borate; N,N-dimethylanilinium tetrakis(pentafluorophenyl)borate; N,N-dimethylanilinium tetrakis(perfluoronaphthyl)borate, N,N-dimethylanilinium tetrakis (perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis (perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄]; 1-(4-(tris(pentafluorophenyl)borate)-2,3,5,6-tetrafluorophenyl)pyrrolidinium; tetrakis(pentafluorophenyl)borate, 4-(tris(pentafluorophenyl)borate)-2,3,5,6-tetrafluoropyridine, bis(C₄-C₂₀alkyl)methylammonium tetrakis(pentafluorophenyl)borate, bis(hydrogenated tallowalkyl)methylammonium tetrakis(pentafluorophenyl)borate, bis(C₄-C₂₀alkyl)methylammonium tetrakis(perfluoronaphthyl)borate, bis(hydrogenated tallowalkyl)methylammonium tetrakis(perfluoronaphthyl)borate, N,N-dimethyl-4-octadecylbenzenaminium tetrakis(perfluoronaphthyl)borate, N-methyl-N-octadecylanilinium tetrakis(perfluoronaphthyl)borate, N-methyl-N-decylanilinium tetrakis(perfluoronaphthyl)borate, N,N-didecyl-4-methylanilinium tetrakis(perfluoronaphthyl)borate, N,N-didecyl-4-butylanilinium tetrakis(perfluoronaphthyl)borate, N-methyl-4-nonadecyl-N-octadecylanilinium tetrakis(perfluoronaphthyl)borate, N-ethyl-4-nonadecyl-N-octadecylanilinium tetrakis(perfluoronaphthyl)borate, N,N-dioctadecyl-N-methylammonium tetrakis(perfluoronaphthyl)borate.

In some embodiments, activators containing the tetrakis(perfluoronaphthyl)borate anion are preferred such as N,N-dimethylanilinium tetrakis(perfluoronaphthyl)borate, bis(hydrogenated tallowalkyl)methylammonium tetrakis(perfluoronaphthyl)borate, N,N-dimethyl-4-octadecylbenzenaminium tetrakis(perfluoronaphthyl)borate, N-methyl-N-octadecylanilinium tetrakis(perfluoronaphthyl)borate, and N-methyl-4-nonadecyl-N-octadecylanilinium tetrakis(perfluoronaphthyl)borate.

One or more of the NCAs may also or instead be chosen from the activators described in U.S. Pat. No. 6,211,105. Further, catalyst compounds can be combined with combinations of alumoxanes and NCAs. Any of the activators (alumoxanes and/or NCAs) may optionally be mixed together before or after combination with the catalyst compound, preferably before being mixed with the catalyst compound. In some embodiments, the same activator or mix of activators may be used.

Further, the typical activator-to-catalyst molar ratio for catalysts is 1:1, although preferred ranges may include from 0.1:1 to 1000:1 (e.g., from 0.5:1 to 100:1, such as 2:1 to 50:1).

In some embodiments, the activator(s) is/are contacted with a catalyst compound to form the catalyst system comprising activated catalyst and activator or other charge-balancing moiety, before the catalyst system is contacted with one or more monomers. In other embodiments, the activator(s) may be co-fed to catalyst compound(s) together with one or more monomers.

### Optional Scavengers or Co-Activators.

In addition to the activator compounds, scavengers or co-activators may be used. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum and the like. Other oxophilic species such as diethyl zinc may be used.

In an embodiment, the co-activators are present at less than about 14 wt %, or from about 0.1 to about 10 wt %, or from about 0.5 to about 7 wt %, by weight of the catalyst system. Alternately, the complex-to-co-activator molar ratio is from about 1:100 to about 100:1; about 1:75 to about 75:1; about 1:50 to about 50:1; about 1:25 to about 25:1; about 1:15 to about 15:1; about 1:10 to about 10:1; about 1:5 to about 5:1; about 1:2 to about 2:1; about 1:100 to about 1:1; about 1:75 to about 1:1; about 1:50 to about 1:1; about 1:25 to about 1:1; about 1:15 to about 1:1; about 1:10 to about 1:1; about 1:5 to about 1:1; about 1:2 to about 1:1; about 1:10 to about 2:1.

### Optional Support Materials

In certain embodiments, the catalyst system may comprise an inert support material. Preferably the supported material is a porous support material, for example, talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use with metallocene catalyst systems herein include groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Some embodiments may employ any support, and/or methods for preparing such support, as described at Paragraphs [00108]-[00114] in US Patent Application 2015/0025210, which was previously incorporated herein by reference.

In one embodiment, one or more scavengers are employed in the polymerization processes. A scavenger is a compound that can be added to a reactor to facilitate polymerization by scavenging impurities. Some scavengers may also act as chain transfer agents. Some scavengers may also act as activators and may be referred to as co-activators. A co-activator, that is not a scavenger, may also be used in conjunction with an activator in order to form an active catalyst. In at least one embodiment, a co-activator is pre-mixed with the transition metal compound to form an alkylated transition metal compound. Examples of scavengers include trialkylaluminums, methylalumoxanes, modified methylalumoxanes, MMAO-3A (Akzo Nobel), bis(diisobutylaluminum)oxide (Akzo Nobel), tri(n-octyl)aluminum, triisobutylaluminum, and diisobutylaluminum hydride.

### Process

This disclosure also relates to a process for polymerization process comprising:
(i) contacting at a temperature greater than 50° C. (preferably in the range of from about 50° C. to 160° C., alternatively from 40° C. to 140° C., alternatively from 60° C. to 140° C., or alternatively from 80° C. to 130° C.), ethylene and propylene with a catalyst system capable of producing long chain branched ethylene propylene copolymers having vinyl chain ends, wherein the catalyst system comprises a metallocene catalyst compound and an activator;
(ii) converting at least 50% of the monomer to polyolefin (preferably at least 55%, alternatively at least 60%, alternatively at least 64%, alternatively at least 70%, alternatively at least 75%, alternatively at least 80%, and alternatively at least 85%);
(iii) obtaining a long chain branched ethylene propylene copolymer having from about 45% to about 70% ethylene content by weight as determined by FTIR according to ASTM D3900, wherein the polymer obtained has one or more of the following attributes:
   (a) an “average sequence length for methylene sequences six and longer” less than 0.1869z-0.30 and greater than 0.1869z-1.9 where z is the mol % of ethylene as measured by ¹³C NMR (alternatively, the “average sequence length for methylene sequences six and longer” is less than 0.1869z-0.35, alternatively less than 0.1869z-0.40, alternatively less than 0.1869z-0.45, alternatively less than 0.1869z-0.50, alternatively less than 0.1869z-0.55, alternatively less than 0.1869z-0.60, alternatively less than 0.1869z-0.65, or alternatively less than 0.1869z-0.70, and alternatively, the “average sequence length for methylene sequences six and longer” is greater than 0.1869z-1.8, alternatively greater than 0.1869z-1.7, alternatively greater than 0.1869z-1.6, or alternatively greater than 0.1869z-1.5);
(b) a “percentage of methylene sequence length of 6 or greater” less than 1.3z-35.5 and greater than 1.3z-50 where z is the mol % of ethylene as measured by ¹³C NMR (alternatively, the “percentage of methylene sequence length of 6 or greater” is less than 1.3x-36.0, alternatively less than 1.3x-36.5, alternatively less than 1.3x-37.0, alternatively less than 1.3x-37.5, alternatively less than 1.3x-38.0, or alternatively less than 1.3x-38.5, alternatively less than 1.3x-39.0, and alternatively, the “percentage of methylene sequence length of 6 or greater” is greater than 1.3z-49, alternatively greater than 1.3z-48, alternatively greater than 1.3z-47, alternatively greater than 1.3z-46, or alternatively greater than 1.3z-45.5).
(c) an r₁r₂ is less than 2.0 and greater than 0.45, alternatively from less than 1.5 to greater than 0.45, alternatively from less than 1.3 (preferably less than 1.25, and more preferably less than 1.2), and from greater than 0.5 (preferably greater than 0.6, more preferably greater than 0.7, and even more preferably greater than 0.8);
(d) exhibiting no polymer crystallinity or having polymer crystallinity wherein the heat of fusion (J/g) as measured by DSC (ASTM D3418-03) is less than 2.8y-134, or alternatively less than 1.47y-64, where y is the wt % of ethylene as measured by FTIR; (e) exhibiting a melting point (Tm) of less than 50° C., alternatively less than 45° C., alternatively less than 40° C., alternatively less than 30° C. as measured by DSC;
(f) a branching index (g′ᵥᵢₛ) less than −0.0003x+0.88 and greater than −0.0054x+1.08 where x is the percent total monomer conversion (alternatively, g′ᵥᵢₛ is less than −0.0003x+0.87, alternatively less than −0.0003x+0.86, alternatively less than −0.0003x+0.85, and alternatively, g′ᵥᵢₛ is greater than −0.0054x+1.09, or alternatively greater than −0.0054x+1.10)
(g) a g′ᵥᵢₛ of from about 0.5 to about 0.97 (alternatively a g′ᵥᵢₛ of less than 0.90, preferably 0.85 or less, preferably 0.80 or less, preferably, 0.75 or less, and even more preferably 0.70 or less).
(h) a Mw(LS)/Mn(DRI) from about 2.0 to about 6.5, preferably from about 2.2 to about 6.0;
(i) a Mw(LS) from about 30,000 to about 300,000 g/mol; and
(j) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

Copolymers described herein, that may be employed in the compositions of the present disclosure can be prepared by a polymerization process comprising a catalyst system comprising a metallocene compound represented by the formula:

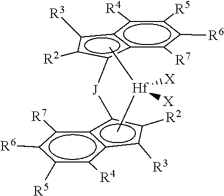

where: (1) J is a divalent bridging group comprising C, Si, or both; (2) M is a group 4 transition metal (preferably Hf); (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl (such as C₁-C₅₀ substituted or unsubstituted halocarbyl), provided that any one or more of the pairs R⁴ and R⁵, R⁵ and R⁶, and R⁶ and R⁷ may optionally be bonded together to form a saturated or partially saturated cyclic or fused ring structure, and obtaining a branched ethylene propylene copolymer having from about 45% to about 70% ethylene content by weight as determined by FTIR; wherein the polymer obtained has one or more of the following attributes:
(a) an “average sequence length for methylene sequences six and longer” less than 0.1869z-0.30 and greater than 0.1869z-1.9 where z is the mol % of ethylene as measured by ¹³C NMR (alternatively, the “average sequence length for methylene sequences six and longer” is less than 0.1869z-0.35, alternatively less than 0.1869z-0.40, alternatively less than 0.1869z-0.45, alternatively less than 0.1869z-0.50, alternatively less than 0.1869z-0.55, alternatively less than 0.1869z-0.60, alternatively less than 0.1869z-0.65, or alternatively less than 0.1869z-0.70, and alternatively, the “average sequence length for methylene sequences six and longer” is greater than 0.1869z-1.8, alternatively greater than 0.1869z-1.7, alternatively greater than 0.1869z-1.6, or alternatively greater than 0.1869z-1.5);
(b) a “percentage of methylene sequence length of 6 or greater” less than 1.3z-35.5 and greater than 1.3z-50 where z is the mol % of ethylene as measured by ¹³C NMR (alternatively, the “percentage of methylene sequence length of 6 or greater” is less than 1.3x-36.0, alternatively less than 1.3x-36.5, alternatively less than 1.3x-37.0, alternatively less than 1.3x-37.5, alternatively less than 1.3x-38.0, alternatively less than 1.3x-38.5, or alternatively less than 1.3x-39.0, and alternatively, the “percentage of methylene sequence length of 6 or greater” is greater than 1.3z-49, alternatively greater than 1.3z-48, alternatively greater than 1.3z-47, alternatively greater than 1.3z-46, or alternatively greater than 1.3z-45.5).
(c) an r₁r₂ is less than 2.0 and greater than 0.45, alternatively from less than 1.5 to greater than 0.45, alternatively from less than 1.3 (preferably less than 1.25, more preferably less than 1.2), and from greater than 0.5 (preferably greater than 0.6, more preferably greater than 0.7, or alternatively greater than 0.8);
(d) exhibiting no polymer crystallinity or having polymer crystallinity wherein the heat of fusion (J/g) as measured by DSC (ASTM D3418-03) is less than 2.8y-134, or alternatively less than 1.47y-64, where y is the wt % of ethylene as measured by FTIR;
(e) exhibiting a melting point (Tm) of less than 50° C., alternatively less than 45° C., alternatively less than 40° C., alternatively less than 30° C. ° Aug. 7, 2021 as measured by DSC;
(f) a branching index (g′ᵥᵢₛ) less than −0.0003x+0.88 and greater than −0.0054x+1.08 where x is the percent total monomer conversion (alternatively, g′ᵥᵢₛ is less than −0.0003x+0.87, alternatively less than −0.0003x+0.86, or alternatively less than −0.0003x+0.85, and alternatively, g′ᵥᵢₛ is greater than −0.0054x+1.09, or alternatively greater than −0.0054x+1.10)
(g) a g′ᵥᵢₛ of from about 0.5 to about 0.97 (alternatively a g′ᵥᵢₛ of less than 0.90, preferably 0.85 or less, preferably 0.80 or less, preferably, 0.75 or less, and even more preferably 0.70 or less).
(h) a Mw(LS)/Mn(DRI) from about 2.0 to about 6.5;
(i) a Mw(LS) from about 30,000 to about 300,000 g/mol.

In at least one embodiment the copolymers employed in the compositions of the present disclosure are obtained from a polymerization process that excludes dienes and/or polyenes.

The following further embodiments are contemplated as being within the scope of the present disclosure.

Embodiment A—A lubricant composition comprising an oil and at least one long chain branched ethylene copolymer having; an Mw(LS)/Mn(DRI) from about 2.0 to about 6.5; an Mw(LS) from about 30,000 to about 300,000 g/mol; a branching index (g′ᵥᵢₛ) of from about 0.5 to about 0.97; and an ethylene content of about 40 wt % to about 75 wt %.

Embodiment B—The composition of Embodiment A, wherein the long chain branched ethylene copolymer has one or more of: (a) an Mw(LS)/Mn(DRI) from about 2.0 to about 6.5; (b) an Mw(LS) from about 30,000 to about 300,000 g/mol; (c) a g′ᵥᵢₛ of from about 0.5 to about 0.97; (d) an ethylene content of about 40 wt % to about 75 wt %; and (e) a shear stability index (30 cycles) of from about 1% to about 60%.

Embodiment C—The composition of Embodiment A or B, where the ethylene copolymer comprises a blend of a first copolymer and a second copolymer, wherein at least one of the first copolymer and second copolymer is a long chain branched ethylene copolymer and the second copolymer has an ethylene content less than the ethylene content of the first copolymer.

Embodiment D—The composition of any one of Embodiments A to C, where the long chain branched ethylene copolymer is an ethylene/propylene copolymer

Embodiment E—The composition of any one of Embodiments A to D, wherein the lubricant composition has an aluminum content of 1 ppm or less.

Embodiment F—The composition of any one of Embodiments A to E, wherein the copolymer has an ethylene content of about 43 wt % to about 73 wt %.

Embodiment G—The composition of any one of Embodiments A to F, wherein the long chain branched ethylene copolymer has a shear thinning ratio greater than 0.8572*EXP(2E-05*w) where w is the Mw(LS) from light scattering GPC-3D.

Embodiment H—The composition of any one of Embodiments A to G, which has a kinematic viscosity at 100° C. of from about 3 cSt to about 30 cSt.

Embodiment I—The composition of any one of Embodiments A to G, which has a kinematic viscosity at 100° C. of from about 10 cSt to about 15 cSt.

Embodiment J—The composition of any one of Embodiments A to I, which has a shear stability index (30 cycles) of from about 10% to about 50%.

Embodiment K—The composition of any one of Embodiments A to I, which has a shear stability index (30 cycles) of from about 15% to about 40%.

Embodiment L—The composition of any one of Embodiments A to K, which has a thickening efficiency of from about 1 to about 4.

Embodiment M—The composition of any of any one of Embodiments A to K has a thickening efficiency of from about 1.5 to about 3.5.

Embodiment N—The composition of any one of Embodiments A to M, wherein the long chain branched ethylene copolymer has a g′ᵥᵢₛ of from about 0.55 to about 0.85.

Embodiment O—The composition of any one of Embodiments A to M, which comprises about 0.01 wt % to about 12 wt % of the long chain branched ethylene copolymer.

Embodiment P—The composition of any one of Embodiments A to M, which comprises about 0.01 wt % to about 3 wt % of the copolymer.

Embodiment Q—The composition of any one of Embodiments A to P, wherein the oil comprises a hydrocarbon, polyalphaolefin, alkyl esters of dicarboxylic acids, polyglycols, alcohols, polybutenes, alkylbenzenes, organic esters of phosphoric acids, polysilicone oils, or combinations thereof.

Embodiment R—The lubricant composition according to any one of the Embodiments A to Q further comprising at least one of a dispersant, a detergent, an antioxidant, an oiliness improver, a pour point depressant, a friction modifier, a wear modifier, an extreme pressure additive, a defoamer, a deemulsifier, or a corrosion inhibitor.

Embodiment S—The composition of any one of Embodiments A to R, which has a high temperature, high shear (HTHS) viscosity of about 4.0 cP or less.

Embodiment T—The composition of any one of Embodiments A to S, which has a shear stability index of about 60 or less.

Embodiment U—The composition of any one of Embodiments A to T, wherein the ethylene copolymer is made in a polymerization process using metallocene catalysts.

Embodiment V—The composition of any one of Embodiments A to T, wherein the copolymer has a SSI (%) 30 cycle per ASTM D6278 less than 0.0003x-2.125 where x is Mw(LS) from GPC-3D;

Embodiment W—A method of making a lubricant composition comprising blending an oil with long chain branched ethylene copolymer, wherein the copolymer has one or more of:
(a) an Mw(LS)/Mn(DRI) from about 2.0 to about 6.5;
(b) an Mw(LS) from about 30,000 to about 300,000 g/mol;
(c) a g′ᵥᵢₛ of from about 0.5 to about 0.97;
(d) an ethylene content of about 40 wt % to about 75 wt %;
(e) a shear stability index (30 cycles) of from about 1% to about 60%

Embodiment X—A method of lubricating an engine comprising supplying to the engine a lubricating oil composition comprising an oil and at least one long chain branched ethylene copolymer having; a) a Mw(LS)/Mn(DRI) from about 2.0 to about 6.5; b) a Mw(LS) from about 30,000 to about 300,000 g/mol; c) a branching index (g′ᵥᵢₛ) of from about 0.5 to about 0.97; d) an ethylene content of about 40 wt % to about 75 wt %, and (e) a shear stability index (30 cycles) of from about 1% to about 60%.

Embodiment Y—A method of lubricating an engine comprising supplying to the engine a lubricating oil composition according to any one of Embodiments A to V.

Embodiment Z—A polymerization process for producing a long chain branched ethylene propylene copolymer, wherein the process comprises: (i) contacting at a temperature greater than 50° C., ethylene and propylene with a catalyst system capable of producing long chain branched ethylene propylene copolymers having vinyl chain ends, and wherein the catalyst system comprises a metallocene catalyst compound and an activator; (ii) converting at least 50% of the ethylene and propylene to a polyolefin; and (iii) obtaining a long chain branched ethylene propylene copolymer having from about 40% to less than 80% ethylene content by weight as determined by FTIR (ASTM D3900), wherein the copolymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol.

Embodiment AA—The process of Embodiment Z, wherein the copolymer produced has a branching index (g′ᵥᵢₛ) less than −0.0003x+0.88, and greater than −0.0054x+1.08 where x is the percent total monomer conversion.

Embodiment AB—The process of any one of Embodiments Z or AA, wherein the copolymer produced has an average sequence length for methylene sequences six and longer is less than 0.1869z-0.30, and greater than 0.1869z-1.9 where z is the mol % of ethylene as measured by ¹³C NMR.

Embodiment AC—The process of any one of Embodiments Z or AA, wherein the copolymer produced has a percentage of methylene sequence length of 6 or greater” less than 1.3z-35.5 and greater than 1.3z-50 where z is the mol % of ethylene as measured by ¹³C NMR.

Embodiment AD—The process of any one of Embodiments Z to AC, wherein the copolymer produced has an r₁r₂ less than 2.0 and greater than 0.45.

Embodiment AE—The process of any one of Embodiments Z to AD wherein the copolymer produced exhibits no polymer crystallinity.

Embodiment AF—The process of any one of Embodiments Z to AD, wherein the copolymer produced has a polymer crystallinity, wherein the heat of fusion (J/g) as measured by DSC is less than 2.8y-134 where y is the wt % of ethylene as measured by FTIR.

Embodiment AG—The process of any one of Embodiments Z to AD, wherein the copolymer produced has a polymer crystallinity wherein the heat of fusion (J/g) as measured by DSC is less than 1.47y-64 where y is the wt % of ethylene as measured by FTIR.

Embodiment AH—The process of any one of Embodiments Z to AG, wherein the copolymer has an ethylene content of about 40 wt % to about 75 wt %.

Embodiment AI—The process of any one of Embodiments Z to AG, wherein the copolymer has an ethylene content of about 45 wt % to 70 wt %.

Embodiment AJ—The process of any one of Embodiments Z to AI, wherein the process is a solution process.

Embodiment AK—The process of any one of Embodiments Z to AJ, wherein the process is a continuous process.

Embodiment AL—The process of any one of Embodiments Z to AK, wherein the monomer feed excludes dienes.

Embodiment AM—The process of any one of Embodiments Z to AK, wherein the monomer feed excludes polyenes.

Embodiment AN—The process of any one of Embodiments Z to AM wherein the feed excludes aluminum vinyl transfer agents.

Embodiment AO—The process of any one of Embodiments Z to AN, wherein the metallocene catalyst compound is represented by the formula:

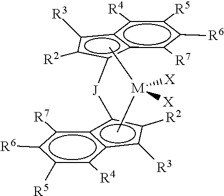

where: (1) J is a divalent bridging group comprising C, Si, or both; (2) M is a group 4 transition metal; (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl, provided that any one or more of the pairs R⁴ and R⁵, R⁵ and R⁶, and R⁶ and R⁷ may optionally be bonded together to form a saturated or partially saturated cyclic or fused ring structure.

Embodiment AP—The process of Embodiment AO, wherein each R⁴ and R⁷ is selected from the group of C₁-C₃ alkyl, each R² is hydrogen or C₁-C₃ alkyl, each R³ is hydrogen, and each R⁵ and R⁶ is hydrogen or C₁-C₃ alkyl, and optionally each R⁵ and R⁶ are joined together to form a 5-membered partially unsaturated ring.

Embodiment AQ—The process of Embodiment AO wherein each R⁴ and R⁷ is selected from the group of C₁-C₃ alkyl, each R² and R³ is hydrogen, and each R⁵ and R⁶ are joined together to form a 5-membered partially unsaturated ring.

Embodiment AR—The process of Embodiment AM to AQ, where each R⁴ and R⁷ is methyl.

Embodiment AR—The process of any one of Embodiments AN to AQ, wherein J is selected from cyclopentamethylenesilylene, cyclotetramethylenesilylene, cyclotrimethylenesilylene, cyclopropandiyl, cyclobutandiyl, cyclopentandiyl, cyclohexandiyl, dimethylsilylene, diethylsilylene, isopropylene, and ethylene.

Embodiment AS—The process of any one of Embodiments AM to AQ, wherein the metallocene comprises cyclotetramethylenesilylene-bis(4,8-dimethyl-1,5,6,7-tetrahydro-s-indacen-1-yl)hafnium dimethyl.

Embodiment AT—A long chain branched ethylene propylene copolymer having from about 40% to less than 80% ethylene content by weight as determined by FTIR (ASTM D3900), wherein the polymer has a g′ᵥᵢₛ of from about 0.5 to about 0.97; a Mw(LS)/Mn(DRI) from about 2.5 to about 6.5; a Mw(LS) from about 30,000 to about 300,000 g/mol; and two or more additional properties selected from:
(h) a branching index (g′ᵥᵢₛ) less than −0.0003x+0.88, and greater than −0.0054x+1.08, where x is the percent total monomer conversion.
(i) a r₁r₂ less than 2.0 and greater than 0.45;
(j) an “average sequence length for methylene sequences six and longer” less than 0.1869z-0.30, and greater than 0.1869z-1.9, where z is the mol % of ethylene as measured by ¹³C NMR;
(k) a percentage of methylene sequence length of 6 or greater less than 1.3z-35.5, and greater than 1.3z-50, where z is the mol % of ethylene as measured by ¹³C NMR;
(l) exhibiting no polymer crystallinity, or a polymer crystallinity wherein the heat of fusion (J/g) as measured by DSC is less than 2.8y-134, where y is the wt % of ethylene as measured by FTIR;
(m) exhibiting no polymer crystallinity, or a polymer crystallinity wherein the heat of fusion (J/g) as measured by DSC is less than 1.47y-64, where y is the wt % of ethylene as measured by FTIR;
(n) exhibiting a melting point (Tm) of less than 50° C. as measured byb DSC;
(h) a SSI (%) 30 cycle per ASTM D6278 less than 0.0003x-2.125 where x is Mw(LS) from GPC-3D; and
(i) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

Embodiment AU—The copolymer of Embodiment AT, which has an ethylene content of about 40 wt % to about 75 wt %.

Embodiment AV—The copolymer of Embodiment AT, wherein copolymer has an ethylene content of about 45 wt % to about 70 wt %.

Embodiment AW—The copolymer of any one of Embodiments AT to AV, wherein the copolymer excludes dienes.

Embodiment AX—The copolymer of any one of Embodiments AT to AW, wherein the copolymer excludes polyenes.

Embodiment AY—The copolymer of any one of Embodiments AT to AX, wherein the copolymer excludes aluminum vinyl transfer agents or remnants from aluminum vinyl transfer agents.

### EXPERIMENTS

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol. Unless otherwise noted, MWD is defined as Mw(DRI)/Mn(DRI).

Gel Permeation Chromotography with Three Detectors (GPC-3D): M_{w}, Mₙ, M_{z} and branching index are determined by using a High Temperature Gel Permeation Chromatography (Agilent PL-220), equipped with three in-line detectors, a differential refractive index detector (DRI), a light scattering (LS) detector, and a viscometer. Experimental details, including detector calibration, are described in: T. Sun, P. Brant, R. R. Chance, and W. W. Graessley, Macromolecules, Volume 34, Number 19, pp. 6812-6820, (2001) and references therein. Three Agilent PLgel 10 micron Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at room temperature and 1.284 g/ml at 145° C. The injection concentration is from 0.5 mg/ml to 2.0 mg/ml, with lower concentrations being used for higher molecular weight samples. Prior to running each sample the DRI detector and the viscometer are purged. Flow rate in the apparatus is then increased to 0.5 ml/minute, and the DRI is allowed to stabilize for 8 hours before injecting the first sample. The LS laser is turned on at least 1 hour to 1.5 hours before running the samples. The concentration, c, at each point in the chromatogram is calculated from the baseline-subtracted DRI signal, I_{DRI}, using the following equation:

$$\\ c = {K}_{DRI} {I}_{DRI} / ( dn / dc )$$

where K_{DRI} is a constant determined by calibrating the DRI, and (dn/dc) is the refractive index increment for the system. The refractive index, n=1.500 for TCB at 145° C. and λ=690 nm. Units on parameters throughout this description of the GPC-3D method are such that concentration is expressed in g/cm³, molecular weight is expressed in g/mol, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\\ \frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and Kₒ is the optical constant for the system:

$$\\ {K}_{o} = \frac{4 {π}^{{}_{} 2} {{n}^{{}_{} 2} ( dn / dc )}^{2}}{{λ}^{4} {N}_{A}}$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

$$\\ {η}_{s} = c [ η ] + 0.3 {( c [ η ] )}^{2}$$

where c is concentration and was determined from the DRI output.

The branching index (g′ᵥᵢₛ) is calculated using the output of the GPC-DRI-LS-VIS method as follows. The average intrinsic viscosity, [η]_{avg}, of the sample is calculated by:

$$\\ {[ η ]}_{avg} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$$\\ {g}_{vis}^{{}_{} ′} = \frac{{[ η ]}_{avg}}{{kM}_{v}^{{}_{} α}}$$

where Mv is the viscosity-average molecular weight based on molecular weights determined by LS analysis, while α and K are as calculated in the published in literature (T. Sun, P. Brant, R. R. Chance, and W. W. Graessley, Macromolecules, Volume 34, Number 19, pp. 6812-6820, (2001)).

All molecular weights are weight average unless otherwise noted. All molecular weights are reported in g/mol unless otherwise noted.

Differential Scanning Calorimetry (DSC): Peak melting point, Tm, (also referred to as melting point), peak crystallization temperature, Tc, (also referred to as crystallization temperature), glass transition temperature (Tg), heat of fusion (ΔH_{f} or H_{f}), and percent crystallinity were determined using the following DSC procedure according to ASTM D3418-03. Differential scanning calorimetric (DSC) data were obtained using a TA Instruments model Q200 machine. Samples weighing approximately 5-10 mg were sealed in an aluminum hermetic sample pan. The DSC data were recorded by first gradually heating the sample to 200° C. at a rate of 10° C./minute. The sample was kept at 200° C. for 2 minutes, then cooled to −90° C. at a rate of 10° C./minute, followed by an isothermal for 2 minutes and heating to 200° C. at 10° C./minute. Both the first and second cycle thermal events were recorded. Areas under the endothermic peaks were measured and used to determine the heat of fusion and the percent of crystallinity. The percent crystallinity is calculated using the formula, [area under the melting peak (Joules/gram)/B (Joules/gram)]*100, where B is the heat of fusion for the 100% crystalline homopolymer of the major monomer component. These values for B are to be obtained from the Polymer Handbook, Fourth Edition, published by John Wiley and Sons, New York 1999, provided; however, that a value of 207 J/g (B) is used as the heat of fusion for 100% crystalline polypropylene, a value of 290 J/g is used for the heat of fusion for 100% crystalline polyethylene. The melting and crystallization temperatures reported here were obtained during the second heating/cooling cycle unless otherwise noted.

For polymers displaying multiple endothermic and exothermic peaks, all the peak crystallization temperatures and peak melting temperatures were reported. The heat of fusion for each endothermic peak was calculated individually. The percent crystallinity is calculated using the sum of heat of fusions from all endothermic peaks. Some of the polymer blends produced show a secondary melting/cooling peak overlapping with the principal peak, which peaks are considered together as a single melting/cooling peak. The highest of these peaks is considered the peak melting temperature/crystallization point. For the amorphous polymers, having comparatively low levels of crystallinity, the melting temperature is typically measured and reported during the first heating cycle. Prior to the DSC measurement, the sample was aged (typically by holding it at ambient temperature for a period of 2 days) or annealed to maximize the level of crystallinity.

The ¹³C solution NMR was performed on a 10 mm broadband probe using a field of at least 400 MHz in tetrachloroethane-d2 solvent at 120° C. with a flip angle of 90° and full NOE with decoupling. Sample preparation (polymer dissolution) was performed at 140° C. where 0.20 grams of polymer was dissolved in an appropriate amount of solvent to give a final polymer solution volume of 3 ml. Chemical shifts were referenced by setting the ethylene backbone (—CH2-)n (where n>6) signal to 29.98 ppm. Carbon NMR spectroscopy was used to measure the composition of the reactor products as submitted.

Chemical shift assignments for the ethylene-propylene copolymer are described by Randall in “A Review Of High Resolution Liquid Carbon Nuclear Magnetic Resonance Characterization of Ethylene-Based Polymers”, Polymer Reviews, 29:2, 201-5 317 (1989). The copolymer content (mole and weight %) is also calculated based on the method established by Randall in this paper. Calculations for r₁r₂ were based on the equation r₁r₂=4*[EE]*[PP]/[EP]²; where [EE], [EP], [PP] are the diad molar concentrations; E is ethylene, P is propylene. The values for the methylene sequence distribution and number average sequence lengths were determined based on the method established by James C. Randall, “Methylene sequence distributions and average sequence lengths in ethylene-propylene copolymers,” Macromolecules, 1978, 11, 33-36. The “average methylene sequence lengths for sequences of six and greater”, <n(6⁺)> is calculated by the following equation, <n(6⁺)>=(3*γδ+δ⁺δ⁺)/(0.5*γδ) with the assignments for γδ and δ⁺δ⁺ as reported in the paper above. The “percentage of methylene sequences of length 6 or greater”, % C6⁺=(aka m6), is calculated by the following equation, % C6⁺=(0.5*γδ*100)/(0.5*αβ+ββ+0.5*βγ+γγ+0.5*γδ) with the assignments for γδ, αβ, ββ, βγ, and γγ as reported in the paper above.

Ethylene wt. % is determined using FTIR according to ASTM D3900.

Chain ends for quantization can be identified using the signals shown in the table below. N-butyl and n-propyl were not reported due to their low abundance (less than 5%) relative to the chain ends shown in the table below.

| Chain end | ¹³C NMR Chemical shift |
|---|---|
| P~i-Bu | 23.5 to 25.5 and 25.8 to 26.3 ppm |
| E~i-Bu | 39.5 to 40.2 |
| P~Vinyl | 41.5 to 43 |
| E~Vinyl | 33.9to 34.4 |

The number of vinyl chain ends, vinylidene chain ends and vinylene chain ends is determined using ¹H NMR using 1,1,2,2-tetrachloroethane-d2 as the solvent on an at least 400 MHz NMR spectrometer, and in selected cases, confirmed by ¹³C NMR. Proton NMR data was collected at 120° C. in a 5 mm probe using a Varian spectrometer with a ¹H frequency of at least 400 MHz. Data was recorded using a maximum pulse width of 45°, 5 seconds between pulses and signal averaging 120 transients. Spectral signals were integrated and the number of unsaturation types per 1000 carbons was calculated by multiplying the different groups by 1000 and dividing the result by the total number of carbons. The number averaged molecular weight (Mn) was calculated by dividing the total number of unsaturated species into 14,000, assuming one unsaturation per polyolefin chain.

The chain end unsaturations are measured as follows. The vinyl resonances of interest are between from 5.0 to 5.1 ppm (VRA), the vinylidene resonances between from 4.65 to 4.85 ppm (VDRA), the vinylene resonances from 5.31 to 5.55 ppm (VYRA), the trisubstituted unsaturated species from 5.11 to 5.30 ppm (TSRA) and the aliphatic region of interest between from 0 to 2.1 ppm (IA).

The number of vinyl groups/1000 Carbons is determined from the formula: (VRA*500)/((IA+VRA+VYRA+VDRA)/2)+TSRA). Likewise, the number of vinylidene groups/1000 Carbons is determined from the formula: (VDRA*500)/((IA+VRA+VYRA+VDRA)/2)+TSRA), the number of vinylene groups/1000 Carbons from the formula (VYRA*500)/((IA+VRA+VYRA+VDRA)/2) 25+TSRA) and the number of trisubstituted groups from the formula (TSRA*1000)/((IA+VRA+VYRA+VDRA)/2)+TSRA). VRA, VDRA, VYRA, TSRA and IA are the integrated normalized signal intensities in the chemical shift regions defined above.

Small Amplitude Oscillatory Shear (SAOS): Dynamic shear melt rheological data was measured with an Advanced Rheometrics Expansion System (ARES) using parallel plates (diameter=25 mm) in a dynamic mode under nitrogen atmosphere. For all experiments, the rheometer was thermally stable at 190° C. for at least 30 minutes before inserting compression-molded sample of resin (polymer composition) onto the parallel plates. To determine the samples' viscoleastic behavior, frequency sweeps in the range from 0.01 to 385 rad/s were carried out at a temperature of 190° C. under constant strain of 10%. A nitrogen stream was circulated through the sample oven to minimize chain extension or cross-linking during the experiments. A sinusoidal shear strain is applied to the material. If the strain amplitude is sufficiently small the material behaves linearly. As those of ordinary skill in the art will be aware, the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoleastic materials, 0<δ<90. Complex viscosity, loss modulus (G″) and storage modulus (G′) as function of frequency are provided by the small amplitude oscillatory shear test. Dynamic viscosity is also referred to as complex viscosity or dynamic shear viscosity. The phase or the loss angle δ, is the inverse tangent of the ratio of G″ (shear loss modulus) to G′ (shear storage modulus).

Shear Thinning Ratio: Shear-thinning is a rheological response of polymer melts, where the resistance to flow (viscosity) decreases with increasing shear rate. The complex shear viscosity is generally constant at low shear rates (Newtonian region) and decreases with increasing shear rate. In the low shear-rate region, the viscosity is termed the zero shear viscosity, which is often difficult to measure for polydisperse and/or LCB polymer melts. At the higher shear rate, the polymer chains are oriented in the shear direction, which reduces the number of chain entanglements relative to their un-deformed state. This reduction in chain entanglement results in lower viscosity. Shear thinning is characterized by the decrease of complex dynamic viscosity with increasing frequency of the sinusoidally applied shear. Shear thinning ratio is defined as a ratio of the complex shear viscosity at frequency of 0.1 rad/sec to that at frequency of 100 rad/sec. The onset of shear thinning is defined as a frequency at which the complex viscosity start to deviate from Newtonian region (complex viscosity is independent of shear rate). For some long chain branching ethylene copolymer, no Newtonian flow region is observed in the testing frequency range. In this case, the onset of shear thinning is below 0.01 rad/sec (the lower limit of frequency tested).

Mooney Large Viscosity (ML) and Mooney Relaxation Area (MLRA): ML and MLRA are measured using a Mooney viscometer according to ASTM D-1646, modified as detailed in the following description. A square sample is placed on either side of the rotor. The cavity is filled by pneumatically lowering the upper platen. The upper and lower platens are electrically heated and controlled at 125° C. The torque to turn the rotor at 2 rpm is measured by a torque transducer. Mooney viscometer is operated at an average shear rate of 2 s⁻¹. The sample is pre-heated for 1 minute after the platens are closed. The motor is then started and the torque is recorded for a period of 4 minutes. The results are reported as ML (1+4) 125° C., where M is the Mooney viscosity number, L denotes large rotor, 1 is the pre-heat time in minutes, 4 is the sample run time in minutes after the motor starts, and 125° C. is the test temperature.

The torque limit of the Mooney viscometer is about 100 Mooney units. Mooney viscosity values greater than about 100 Mooney unit cannot generally be measured under these conditions. In this event, a non-standard rotor design is employed with a change in Mooney scale that allows the same instrumentation on the Mooney viscometer to be used for more viscous polymers. This rotor that is both smaller in diameter and thinner than the standard Mooney Large (ML) rotor is termed MST-Mooney Small Thin. Typically, when the MST rotor is employed, the test is also run at different time and temperature. The pre-heat time is changed from the standard 1 minute to 5 minutes and the test is run at 200° C. instead of the standard 125° C. Thus, the value will be reported as MST (5+4) at 200° C. Note that the run time of 4 minutes at the end of which the Mooney reading is taken remains the same as the standard conditions. According to EP 1 519 967, one MST point is approximately 5 ML points when MST is measured at (5+4@200° C.) and ML is measured at (1+4@125° C.). The MST rotor should be prepared as follows:
a. The rotor should have a diameter of 30.48+/−0.03 mm and a thickness of 2.8+/−0.03 mm (tops of serrations) and a shaft of 11 mm or less in diameter.
b. The rotor should have a serrated face and edge, with square grooves of 0.8 mm width and depth of 0.25-0.38 mm cut on 1.6 mm centers. The serrations will consist of two sets of grooves at right angles to each other (form a square crosshatch).
c. The rotor shall be positioned in the center of the die cavity such that the centerline of the rotor disk coincides with the centerline of the die cavity to within a tolerance of +/−0.25 mm. A spacer or a shim may be used to raise the shaft to the midpoint.
d. The wear point (cone shaped protuberance located at the center of the top face of the rotor) shall be machined off flat with the face of the rotor.

The MLRA data is obtained from the Mooney viscosity measurement when the rubber relaxes after the rotor is stopped. The MLRA is the integrated area under the Mooney torque-relaxation time curve from 1 to 100 seconds. The MLRA is a measure of chain relaxation in molten polymer and can be regarded as a stored energy term that suggests that, after the removal of an applied strain, the longer or branched polymer chains can store more energy and require longer time to relax. Therefore, the MLRA value of a bimodal rubber (the presence of a discrete polymeric fraction with very high molecular weight and distinct composition) or a long chain branched rubber are larger than a broad or a narrow molecular weight rubber when compared at the same Mooney viscosity values.

Mooney Relaxation Area is dependent on the Mooney viscosity of the polymer, and increases with increasing Mooney viscosity. In order to remove the dependence on polymer Mooney Viscosity, a corrected MLRA (cMLRA) parameter is used, where the MLRA of the polymer is normalized to a reference of 80 Mooney viscosity. The formula for cMLRA is provided below

$$\\ c M L R A = M L R {A ( \frac{80}{ML} )}^{1.44}$$

where MLRA and ML are the Mooney Relaxation Area and Mooney viscosity of the polymer sample measured at 125° C.

Melt Flow Rates. All melt flow rates (MFR) were determined using ASTM D1238 at 2.16 kg and 230° C. High load melt flow rates (HLMFR) were determined using ASTM D1238 at 21.6 kg and 230° C.

HPLC-SEC. Compositional uniformity of polymers is verified by using High Performance Liquid Chromatography—Size Exclusion Chromatography (HPLC-SEC) equipped with IR5 detector (Polymer Char, S. A., Valencia, Spain). The HPLC-SEC instrument undergoes two separation mechanisms for compositional separation and polymer size separation. The first separation mechanism depends on the adsorption-desorption of polymers with porous graphite materials under a varying gradient of two solvents. The second separation mechanism relies on how different sizes of polymers permeate through various pore sizes of packing materials in a SEC column.

In the experiment, one high temperature Hypercarb column for HPLC (100.0×4.6 mm, 5 μm particle size) and one high temperature Agilent PL Rapid H column for SEC (150.0×7.5 mm, 10 μm particle size) are used. The various transfer lines, columns, and detector are contained in an oven maintained at 160° C. The nominal flow rate of HPLC is 0.025 mL/min running with programmed gradient of 1-decanol and 1,2,4,-trichlorobenzene (TCB) mixtures and the nominal flow rate of SEC is 3 mL/min in TCB.

The TCB purchased from Fisher reagent grade was filtered through membrane (Millipore, polytetrafluoroethylene, 0.1 μm) before use. The 1-decanol was used as received from Alpha Aesar. The 1-decanol polymer solutions are prepared by placing dry polymer in glass vials, then the Polymer Char autosampler transfers desired amount of 1-decanol, and heating the mixture at 160° C. with continuous shaking for about 1.5 hours. All quantities are measured gravimetrically. All samples were prepared at concentration approximately 1.5 mg/mL.

The autosampler transferred 100 μL of the prepared sample solution into instrument. The HPLC has a varying gradient composition of mobile phase of 1-decanol and TCB, beginning with 100 vol. % of 1-decanol under nominal flow rate of 0.025 mL/min. After injection of sample solution, the mobile phase of HPLC was programmatically adjusted with varying linear gradient changes from 0 vol % TCB/min to 100 vol % TCB/min over certain period of times. Specifically, the HPLC gradient profiles used for this analysis over 200 min analysis time is 0% of TCB (0 min), 0% of TCB (20 min), 100% of TCB (120 min), 100% of TCB (200 min). A sampling loop collects HPLC eluents and transfers into SEC every 2 minutes. The SEC has TCB as mobile phase with the nominal flow rate of 3 mL/min. The IR5 (Polymer Char) infrared detector was used to obtain mass concentration and chemical composition of polymer in the eluting flow.

The analysis of HPLC-SEC was performed with using in-house developed MATLAB (Version R2015b) based algorithm (HPC×SEC version 2.6).

### Polymerization

The following describes the general polymerization procedure used for the examples. Polymerizations were carried out in a continuous stirred tank reactor system. A 1-liter Autoclave reactor was equipped with a stirrer, a pressure controller, and a water cooling/steam heating element with a temperature controller. The reactor was operated in liquid fill condition at a reactor pressure in excess of the bubbling point pressure of the reactant mixture, keeping the reactants in liquid phase. Isohexane and propylene were pumped into the reactors by Pulsa feed pumps. All flow rates of liquid were controlled using Coriolis mass flow controller (Quantim series from Brooks). Ethylene flowed as a gas under its own pressure through a Brooks flow controller. Monomer (e.g., ethylene and propylene) feeds were combined into one stream and then mixed with a pre-chilled isohexane stream that had been cooled to at least 0° C. The mixture was then fed to the reactor through a single line. Scavenger solution (when used) was also added to the combined solvent and monomer stream just before it entered the reactor to further reduce any catalyst poisons. Similarly, preactivated catalyst solution was fed to the reactor using an ISCO syringe pump through a separated line.

Isohexane (used as solvent), and monomers (e.g., ethylene and propylene) were purified over beds of alumina and molecular sieves. Toluene for preparing catalyst solutions was purified by the same technique.

An isohexane solution of tri-n-octyl aluminum (TNOA) (25 wt % in hexane, Sigma Aldrich) was used as scavenger solution. Catalyst #1 is rac-cyclotetramethylenesilylene-bis(4,8-dimethyl-1,5,6,7-tetrahydro-s-indacen-1-yl)hafnium dimethyl. Catalyst #2 is rac-cyclotetramethylenesilylene-bis(2,4,7-trimethylinden-1-yl)hafnium dimethyl. Catalyst #3 is rac-cyclotetramethylenesilylene-bis(4,7-dimethylinden-1-yl)hafnium dimethyl. All the catalysts were activated with N,N-dimethylanilinium tetrakis(heptafluoro-2-naphthyl)borate (available from W.R. Grace & Co.) at a molar ratio of about 1:1 in toluene. Catalysts #2 and #3 can be prepared as described in U.S. Pat. No. 9,458,254. Catalyst #1 can be prepared as described in U.S. Pat. No. 9,938,364.

The polymer produced in the reactor exited through a back pressure control valve that reduced the pressure to atmospheric. This caused the unconverted monomers in the solution to flash into a vapor phase that was vented from the top of a vapor liquid separator. The liquid phase, comprising mainly polymer and solvent, was collected for polymer recovery. The collected samples were first air-dried in a hood to evaporate most of the solvent, and then dried in a vacuum oven at a temperature of about 90° C. for about 12 hours. The vacuum oven dried samples were weighed to obtain yields and used in the calculation of the overall monomer conversion listed in Tables 1-3.

The detailed polymerization process conditions and some characteristic properties of the polymers produced are listed of samples 1-49 are shown in Table 1. The scavenger feed rate (when used) was adjusted to optimize the catalyst efficiency and the feed rate varied from 0 (no scavenger) to 15 μmol/min. The catalyst feed rates may also be adjusted according to the level of impurities in the system to reach the targeted conversions listed. All the reactions were carried out at a pressure of about 2.4 MPa (˜350 psi) unless otherwise mentioned.

Polymerizations of ethylene and propylene were also carried out using a solution process in a 28 liter continuous stirred-tank reactor (autoclave reactor). Polymer samples 50-74 in Table 1 are made by this process. The autoclave reactor was equipped with an agitator, a pressure controller, and insulation to prevent heat loss. The reactor temperature was controlled by controlling the catalyst feed rates and heat removal was provided by feed chilling. All solvents and monomers were purified over beds of alumina and molecular sieves. The reactor was operated liquid full and at a pressure of 1600 psi. Isohexane was used as a solvent. It was fed into the reactor using a turbine pump and its flow rate was controlled by a mass flow controller downstream. The compressed, liquefied propylene feed was controlled by a mass flow controller. Ethylene feed was also controlled by a mass flow controller. The ethylene and propylene were mixed into the isohexane at separate addition points via a manifold. A 3 wt. % mixture of tri-n-octylaluminum in isohexane was also added to the manifold through a separate line (used as a scavenger) and the combined mixture of monomers, scavenger, and solvent was fed into the reactor through a single tube.

An activated Catalyst 1 (rac-cyclotetramethylenesilylene-bis(4,8-dimethyl-1,5,6,7-tetrahydro-s-indacen-1-yl)hafnium dimethyl) solution was prepared in a 4 L Erlenmeyer flask in a nitrogen-filled glove box. The flask was charged with 4 L of air-free anhydrous toluene, 2.0 g (˜0.003 mole) of Catalyst 1, and 3.38 g N,N-dimethylanilinium tetrakis (perfluoronaphthyl)borate) in a ˜1:1 molar ratio to make the solution. After the solids dissolved, with stirring, the solution was charged into an ISCO pump and metered into the reactor.

The catalyst feed rate was controlled along with the monomer feed rates and reaction temperature, as shown in Table 1, to produce the polymers also described in Table 1. The reactor product stream was treated with trace amounts of methanol to halt the polymerization. The mixture was then freed from solvent via a low-pressure flash separation, treated with Irganox™ 1076 then subjected to a devolatilizing extruder process. The dried polymer was then pelletized.

TABLE 1

| VI additive # | 1 | 2 | 3 | 4 | 5 | 6 |
|---|---|---|---|---|---|---|
| Polymerization | 100 | 100 | 100 | 100 | 100 | 100 |
| temperature (° C.) | | | | | | |
| Ethylene | 6.79 | 4.52 | 5.66 | 6.79 | 6.79 | 6.79 |
| feed rate | | | | | | |
| (g/min) | | | | | | |
| Propylene | 6 | 6 | 6 | 6 | 4 | 6 |
| feed rate | | | | | | |
| (g/min) | | | | | | |
| Isohexane | 82.7 | 56.7 | 56.7 | 56.7 | 56.7 | 56.7 |
| feed rate | | | | | | |
| (g/min) | | | | | | |
| Catalyst #1 | 1.07E−07 | 1.35E−07 | 1.35E−07 | 1.35E−07 | 1.35E−07 | 1.35E−07 |
| feed rate | | | | | | |
| (mol/min) | | | | | | |
| Yield (g/min) | 10.1 | 9.4 | 10.7 | 12.0 | 10.7 | 11.9 |
| Conversion (%) | 78.9% | 89.3% | 91.5% | 94.1% | 99.4% | 93.3% |
| Catalyst | 144,043 | 105,804 | 120,067 | 135,427 | 120,658 | 134,217 |
| productivity | | | | | | |
| (kg Poly/kg cat) | | | | | | |
| Complex viscosity at | 1,789 | 199 | 510 | 857 | 1,547 | 842 |
| 100 rad/s (Pa s) | | | | | | |
| Complex viscosity at | 140,590 | 634 | 6,942 | 38,429 | 160,844 | 30,890 |
| 0.1 rad/s (Pa s) | | | | | | |
| Shear thinning | 78.57 | 3.19 | 13.62 | 44.84 | 103.96 | 36.67 |
| ratio (—) | | | | | | |
| MFR (g/10 min) | | 48.4 | 8.2 | 1.2 | | 1.5 |
| HLMFR (g/10 min) | | | | | 18.7 | |
| ML (mu) | 37.2 | | | | | 25.2 |
| MLRA (mu-sec) | 402.0 | | | | | 198.0 |
| cMLRA (mu.-sec) | 1210.9 | | | | | 1047.2 |
| MST (mu) | 11.3 | | | | | |
| MST RA (mst-sec) | 163 | | | | | |
| Mn_DRI (g/mol) | 46,882 | 22,214 | 33,292 | 36,932 | 57,602 | 40,598 |
| Mw_DRI (g/mol) | 145,800 | 79,111 | 106,583 | 135,561 | 194,527 | 131,156 |
| Mz_DRI (g/mol) | 319,266 | 319,266 | 211,280 | 276,366 | 702,670 | 270,137 |
| MWD (—) | 3.11 | 3.56 | 3.20 | 3.67 | 3.38 | 3.23 |
| Mn_LS (g/mol) | 54,058 | 28,969 | 37,020 | 47,870 | 76,499 | 50,217 |
| Mw_LS (g/mol) | 159,175 | 99,302 | 136,322 | 177,774 | 238,362 | 163,774 |
| Mz_LS (g/mol) | 324,605 | 227,965 | 298,287 | 383,987 | 517,386 | 347,864 |
| g′ᵥᵢₛ (—) | 0.814 | 0.725 | 0.694 | 0.677 | 0.681 | 0.66 |
| Ethylene content | 62.1% | 47.0% | 51.1% | 54.8% | 62.6% | 55.6% |
| by FTIR (wt %) | | | | | | |
| Tm (° C.) | | — | 4.6 | −24.9 | −1.0 | −22.9 |
| Tg (° C.) | −54 | −55 | −59 | −51 | −51 | −53 |
| Heat of | | — | 4.5 | 10.1 | 15.9 | 7.1 |
| fusion (J/g) | | | | | | |
| Mole % Ethylene^{a} | 67.0% | 55.7% | 59.7% | 62.6% | 69.7% | 63.5% |
| Mole % Propylene^{a} | 33.0% | 44.3% | 40.3% | 37.4% | 30.3% | 36.5% |
| Mole % Regio | 0.48 | 1.08 | 0.87 | 1.09 | 0.78 | 0.85 |
| r₁r₂ | 1.11 | 1.07 | 1.07 | 1.12 | 1.14 | 1.10 |
| [EEE] | 0.320 | 0.180 | 0.220 | 0.257 | 0.348 | 0.269 |
| [EEP] | 0.288 | 0.270 | 0.284 | 0.284 | 0.286 | 0.288 |
| [PEP] | 0.061 | 0.105 | 0.091 | 0.084 | 0.064 | 0.078 |
| [EPE] | 0.138 | 0.131 | 0.136 | 0.141 | 0.138 | 0.140 |
| [EPP] | 0.168 | 0.229 | 0.209 | 0.176 | 0.132 | 0.180 |
| [PPP] | 0.025 | 0.085 | 0.061 | 0.058 | 0.032 | 0.046 |
| Average —CH₂— | 11.22 | 9.63 | 10.01 | 10.63 | 11.92 | 10.66 |
| Sequence Length for | | | | | | |
| Sequences 6+ | | | | | | |
| % methylene | 48 | 30 | 35 | 38 | 46 | 40 |
| sequences 6+ | | | | | | |
| E RUN # | 20.5 | 24.0 | 23.3 | 22.6 | 20.6 | 22.2 |
| P RUN # | 22.2 | 24.6 | 24.0 | 23.0 | 20.4 | 23.0 |
| VI additive # | 7 | 8 | 9 | 10 | 11 | 12 |
| Polymerization | 100 | 100 | 100 | 100 | 100 | 100 |
| temperature (° C.) | | | | | | |
| Ethylene | 6.79 | 6.79 | 6.79 | 6.79 | 6.79 | 6.79 |
| feed rate | | | | | | |
| (g/min) | | | | | | |
| Propylene | 6 | 6 | 4 | 4 | 4 | 6 |
| feed rate | | | | | | |
| (g/min) | | | | | | |
| Isohexane | 56.7 | 56.7 | 56.7 | 56.7 | 56.7 | 56.7 |
| feed rate | | | | | | |
| (g/min) | | | | | | |
| Catalyst #1 | 2.03E−07 | 2.71E−07 | 1.35E−07 | 2.03E−07 | 2.71E−07 | 1.08E−07 |
| feed rate | | | | | | |
| (mol/min) | | | | | | |
| Yield (g/min) | 12.4 | 12.4 | 10.4 | 10.9 | 10.8 | 10.8 |
| Conversion (%) | 96.7% | 97.3% | 96.8% | | 99.9% | 84.3% |
| Catalyst | 92,696 | 69,995 | 117,507 | 81,580 | 60,616 | 151,575 |
| productivity | | | | | | |
| (kg Poly/kg cat) | | | | | | |
| Complex viscosity at | 618 | 508 | 1793 | 1,097 | 1,274 | 1,640 |
| 100 rad/s (Pa s) | | | | | | |
| Complex viscosity at | 21,803 | 9,102 | 196,982 | 97,287 | 87,205 | 132,626 |
| 0.1 rad/s (Pa s) | | | | | | |
| Shear Thinning | 35.31 | 17.91 | 109.87 | 88.70 | 68.43 | 80.89 |
| Ratio | | | | | | |
| MFR (g/10 min) | 2.6 | 6.1 | | | 0.4 | 0.2 |
| HLMFR (g/10 min) | | | 12.1 | 20.4 | 33.7 | |
| ML (mu) | 22.9 | 15.3 | 48.4 | 44.1 | 37.3 | |
| MLRA (mu-sec) | 170.4 | 69.9 | 715.2 | 636.6 | 476.5 | |
| cMLRA (mu.-sec) | 1035.4 | 757.7 | 1476.5 | 1501.7 | 1429.8 | |
| Mn_DRI (g/mol) | 37,143 | 33,915 | 44,451 | 35,251 | 42,697 | 50,132 |
| Mw_DRI (g/mol) | 135,649 | 125,000 | 174,044 | 163,903 | 163,342 | 158,600 |
| Mz_DRI (g/mol) | 285,274 | 255,132 | 366,309 | 357,852 | 367,197 | 334,381 |
| MWD (—) | 3.65 | 3.69 | 3.92 | 4.65 | 3.83 | 3.16 |
| Mn_LS (g/mol) | 52,306 | 47,335 | 51,059 | 45,680 | 52,494 | 55,052 |
| Mw_LS (g/mol) | 175,646 | 170,112 | 226,708 | 224,407 | 215,220 | 178,617 |
| Mz_LS (g/mol) | 391,866 | 385,096 | 507,348 | 547,616 | 484,011 | 389,552 |
| g′ᵥᵢₛ (—) | 0.626 | 0.597 | 0.628 | 0.608 | 0.582 | 0.722 |
| Ethylene content | 55.0% | 54.1% | 64.1% | 63.6% | 63.1% | 51.7% |
| by FTIR (wt %) | | | | | | |
| Tm (° C.) | −23.0 | −23.1 | 1.1 | 0.7 | 0.6 | −16.8 |
| Tg (° C.) | −60 | −59 | −58 | −52 | −56 | −56 |
| Heat of | 5.0 | 4.0 | 18.6 | 14.4 | 13.0 | 9.8 |
| fusion (J/g) | | | | | | |
| Mole % Ethylene^{a} | 63.8% | 62.7% | 70.9% | 69.4% | 70.0% | |
| Mole % Propylene^{a} | 36.2% | 37.3% | 29.1% | 30.6% | 30.0% | |
| Mole % Regio | 0.82 | 0.89 | 0.72 | 1.04 | 0.78 | |
| r₁r₂ | 1.08 | 1.07 | 1.12 | 1.16 | 1.12 | |
| [EEE] | 0.264 | 0.252 | 0.368 | 0.356 | 0.356 | |
| [EEP] | 0.291 | 0.288 | 0.283 | 0.280 | 0.285 | |
| [PEP] | 0.082 | 0.086 | 0.059 | 0.060 | 0.061 | |
| [EPE] | 0.140 | 0.141 | 0.140 | 0.139 | 0.139 | |
| [EPP] | 0.174 | 0.179 | 0.124 | 0.137 | 0.133 | |
| [PPP] | 0.049 | 0.054 | 0.026 | 0.028 | 0.027 | |
| Average —CH₂— | 10.65 | 10.52 | 12.23 | 11.91 | 11.96 | |
| Sequence Length for | | | | | | |
| Sequences 6+ | | | | | | |
| % methylene | 39 | 38 | 48 | 47 | 47 | |
| sequences 6+ | | | | | | |
| E RUN # | 22.8 | 23.0 | 20.0 | 20.0 | 20.3 | |
| P RUN # | 22.6 | 23.1 | 20.2 | 20.7 | 20.5 | |
| VI additive # | 13 | 14 | 15 | 16 | 17 | 18 |
| Polymerization | 100 | 100 | 100 | 100 | 100 | 93 |
| temperature (° C.) | | | | | | |
| Ethylene | 5.66 | 4.52 | 6.79 | 6.79 | 6.79 | 6.79 |
| feed rate | | | | | | |
| (g/min) | | | | | | |
| Propylene | 6 | 6 | 3.5 | 4 | 4.5 | 6 |
| feed rate | | | | | | |
| (g/min) | | | | | | |
| Isohexane | 56.7 | 56.7 | 56.7 | 56.7 | 56.7 | 56.7 |
| feed rate | | | | | | |
| (g/min) | | | | | | |
| Catalyst #1 | 1.08E−07 | 1.08E−07 | 1.08E−07 | 1.08E−07 | 1.08E−07 | 1.08E−07 |
| feed rate | | | | | | |
| (mol/min) | | | | | | |
| Yield (g/min) | 9.7 | 8.4 | 9.4 | 9.8 | 10.2 | 11.1 |
| Conversion (%) | 82.9% | 79.6% | 91.4% | 90.9% | 90.1% | 86.8% |
| Catalyst | 135,932 | 117,724 | 132,242 | 137,866 | 142,963 | 156,110 |
| productivity | | | | | | |
| (kg Poly/kg cat) | | | | | | |
| Complex viscosity at | 849 | 405 | 2844 | 2379 | 2206 | 2412 |
| 100 rad/s (Pa s) | | | | | | |
| Complex viscosity at | 20,504 | 2,749 | 499,033 | 346,545 | 283,284 | 430,046 |
| 0.1 rad/s (Pa s) | | | | | | |
| Shear thinning | 24.15 | 6.79 | 175.45 | 145.66 | 128.41 | 178.32 |
| ratio (—) | | | | | | |
| MFR (g/10 min) | 2.3 | 15.5 | 2.7 | 3.3 | 5.0 | <0.1 |
| HLMFR (g/10 min) | | | | | | 3.8 |
| Mn_DRI (g/mol) | 34,555 | 30,937 | 50,554 | 51,298 | 47,832 | 79,132 |
| Mw_DRI (g/mol) | 114,859 | 92,650 | 184,999 | 178,114 | 174,873 | 270,636 |
| Mz_DRI (g/mol) | 232,586 | 189,967 | 391,221 | 372,255 | 360,263 | 613,446 |
| MWD (—) | 3.32 | 2.99 | 3.66 | 3.47 | 3.66 | 3.42 |
| Mn_LS (g/mol) | 39,095 | 36,777 | 62,523 | 65,272 | 67,245 | 65,183 |
| Mw_LS (g/mol) | 127,475 | 101,979 | 228,791 | 221,852 | 220,577 | 214,804 |
| Mz_LS (g/mol) | 265,170 | 207,840 | 512,482 | 493,921 | 511,440 | 460,681 |
| g′ᵥᵢₛ (—) | 0.685 | 0.706 | 0.665 | 0.659 | 0.666 | 0.727 |
| Ethylene content | 53.0% | 48.7% | 66.8% | 64.3% | 62.2% | 56.4% |
| by FTIR (wt %) | | | | | | |
| Tm (° C.) | −23.7 | −25.1 | 16.1 | 3.9 | 1.2 | — |
| Tg (° C.) | −57 | −56 | −46 | −49 | −52 | −55 |
| Heat of | 4.1 | 0.2 | 28.6 | 22.6 | 19.0 | — |
| fusion (J/g) | | | | | | |
| VI additive # | 19 | 20 | 21 | 22 | 23 | 24 |
| Polymerization | 100 | 110 | 100 | 100 | 100 | 110 |
| temperature (° C.) | | | | | | |
| Ethylene | 6.79 | 6.79 | 3.96 | 4.52 | 5.09 | 6.79 |
| feed rate | | | | | | |
| (g/min) | | | | | | |
| Propylene | 6 | 6 | 6 | 6 | 6 | 3.5 |
| feed rate | | | | | | |
| (g/min) | | | | | | |
| Isohexane | 56.7 | 56.7 | 56.7 | 56.7 | 56.7 | 56.7 |
| feed rate | | | | | | |
| (g/min) | | | | | | |
| Catalyst #1 | 1.08E−07 | 1.08E−07 | 8.11E−08 | 8.11E−08 | 8.11E−08 | 8.11E−08 |
| feed rate | | | | | | |
| (mol/min) | | | | | | |
| Yield (g/min) | 11.2 | 11.1 | 9.3 | 9.8 | 10.0 | 9.2 |
| Conversion (%) | 87.5% | 86.4% | 90.6% | 90.6% | 88.4% | 89.5% |
| Catalyst | 157,270 | 155,407 | 174,703 | 183,188 | 186,984 | 172,547 |
| productivity | | | | | | |
| (kg Poly/kg cat) | | | | | | |
| Complex viscosity at | 1,538 | 567 | 2,483 | 2,280 | 2,006 | 1,558 |
| 100 rad/s (Pa s) | | | | | | |
| Complex viscosity at | 118,020 | 6,679 | 394,992 | 368,974 | 245,524 | 89,273 |
| 0.1 rad/s (Pa s) | | | | | | |
| Shear Thinning | 76.74 | 11.77 | 159.10 | 161.80 | 122.37 | 57.29 |
| Ratio | | | | | | |
| MFR (g/10 min) | 0.2 | 7.2 | | | | 0.3 |
| HLMFR (g/10 min) | 23.4 | 350.1 | 2.5 | 6.0 | 6.6 | 28.3 |
| Mn_DRI (g/mol) | 60,589 | 36,110 | 69,563 | 69,795 | 61,051 | 40,633 |
| Mw_DRI (g/mol) | 192,331 | 113,138 | 228,694 | 236,137 | 212,591 | 127,097 |
| Mz_DRI (g/mol) | 453,327 | 262,878 | 501,897 | 538,522 | 470,740 | 258,047 |
| MWD (—) | 3.17 | 3.13 | 3.29 | 3.38 | 3.48 | 3.13 |
| Mn_LS (g/mol) | 48,965 | 22,729 | 54,565 | 56,572 | 47,612 | 54,449 |
| Mw_LS (g/mol) | 152,624 | 92,816 | 174,693 | 180,664 | 168,986 | 157,094 |
| Mz_LS (g/mol) | 320,364 | 188,678 | 345,005 | 373,312 | 356,230 | 347,850 |
| g′ᵥᵢₛ (—) | 0.697 | 0.681 | 0.671 | 0.695 | 0.680 | 0.658 |
| Ethylene content | 56.1% | 56.7% | 67.2% | 65.1% | 62.5% | 68.1% |
| by FTIR (wt %) | | | | | | |
| Tm (° C.) | −19.7 | −20.3 | 22.5 | 13.7 | 1.7 | 14.5 |
| Tg (° C.) | −56 | −58 | −48 | −50 | −52 | −50 |
| Heat of | 8.0 | 8.6 | 23.4 | 18.5 | 18.4 | 28.3 |
| fusion (J/g) | | | | | | |
| Mole % Ethylene^{a} | | | | | | 73.9% |
| Mole % Propylene^{a} | | | | | | 26.1% |
| Mole % Regio | | | | | | 0.56 |
| r₁r₂ | | | | | | 1.06 |
| [EEE] | | | | | | 0.419 |
| [EEP] | | | | | | 0.275 |
| [PEP] | | | | | | 0.045 |
| [EPE] | | | | | | 0.136 |
| [EPP] | | | | | | 0.114 |
| [PPP] | | | | | | 0.010 |
| Average —CH₂— | | | | | | 12.80 |
| Sequence Length for | | | | | | |
| Sequences 6+ | | | | | | |
| % methylene | | | | | | 55.15 |
| sequences 6+ | | | | | | |
| E RUN # | | | | | | 18.3 |
| P RUN # | | | | | | 19.3 |
| VI additive # | 25 | 26 | 27 | 28 | 29 | 30 |
| Polymerization | 120 | 130 | 90 | 100 | 110 | 110 |
| temperature (° C.) | | | | | | |
| Ethylene | 6.79 | 6.79 | 6.22 | 6.22 | 6.22 | 6.79 |
| feed rate | | | | | | |
| (g/min) | | | | | | |
| Propylene | 3.5 | 3.5 | 6.0 | 6.0 | 6.0 | 3.5 |
| feed rate | | | | | | |
| (g/min) | | | | | | |
| Isohexane | 56.7 | 56.7 | 56.7 | 56.7 | 56.7 | 56.7 |
| feed rate | | | | | | |
| (g/min) | | | | | | |
| Catalyst #1 | 8.11E−08 | 8.11E−08 | 1.08E−07 | 1.08E−07 | 1.08E−07 | 8.11E−08 |
| feed rate | | | | | | |
| (mol/min) | | | | | | |
| Yield (g/min) | 9.3 | 9.2 | 10.7 | 10.5 | 10.5 | 9.5 |
| Conversion (%) | 90.5% | 89.3% | 87.5% | 86.1% | 86.3% | 92.6% |
| Catalyst | 174,609 | 172,266 | 150,415 | 147,919 | 148,236 | 178,570 |
| productivity | | | | | | |
| (kg Poly/kg cat) | | | | | | |
| Complex viscosity at | 710 | 266 | 2078 | 998 | 388 | 1441 |
| 100 rad/s (Pa s) | | | | | | |
| Complex viscosity at | 10,927 | 873 | 233,335 | 31,256 | 2,440 | 86,929 |
| 0.1 rad/s (Pa s) | | | | | | |
| Shear Thinning | 15.39 | 3.29 | 112.3 | 31.32 | 6.28 | 60.32 |
| Ratio | | | | | | |
| MFR (g/10 min) | 4.2 | 38.2 | 0.1 | 1.7 | 17.7 | 0.3 |
| HLMFR (g/10 min) | 217.8 | | 12.9 | 94.0 | | 24.5 |
| Mn_DRI (g/mol) | 29,828 | 20,561 | 52,410 | 44,275 | 21,669 | 36,365 |
| Mw_DRI (g/mol) | 90,934 | 65,903 | 176,062 | 124,178 | 88,393 | 131,126 |
| Mz_DRI (g/mol) | 181,809 | 139,342 | 358,020 | 249,128 | 195,768 | 300,001 |
| MWD (—) | 3.05 | 3.21 | 3.36 | 2.8 | 4.08 | 3.61 |
| Mn_LS (g/mol) | 33,332 | 27,666 | 63,779 | 49,673 | 27,902 | 42,255 |
| Mw_LS (g/mol) | 106,177 | 73,252 | 205,877 | 148,203 | 97,517 | 153,226 |
| Mz_LS (g/mol) | 232,305 | 150,474 | 454,083 | 325,299 | 206,849 | 318,775 |
| g′ᵥᵢₛ (—) | 0.663 | 0.66 | 0.694 | 0.695 | 0.673 | 0.673 |
| Ethylene content | 68.9% | 70.1% | 54.2% | 54.5% | 54.9% | 68.3% |
| by FTIR (wt %) | | | | | | |
| Tm (° C.) | 13.9 | 14.1 | −21.8 | −23.3 | −23.0 | 17.0 |
| Tg (° C.) | −52 | −52 | −56 | −58 | −60 | −55 |
| Heat of | 34.6 | 30.9 | 7.0 | 7.9 | 6.6 | 28.0 |
| fusion (J/g) | | | | | | |
| Mole % Ethylene^{a} | 75.1% | 74.6% | 61.2% | 62.2% | 63.7% | |
| Mole % Propylene^{a} | 24.9% | 25.4% | 38.8% | 37.8% | 36.3% | |
| Mole % Regio | 0.48 | 0.64 | 1.39 | 0.82 | 0.61 | |
| r₁r₂ | 0.94 | 0.89 | 1.27 | 1.10 | 0.97 | |
| [EEE] | 0.424 | 0.429 | 0.261 | 0.253 | 0.257 | |
| [EEP] | 0.280 | 0.275 | 0.273 | 0.286 | 0.295 | |
| [PEP] | 0.048 | 0.043 | 0.074 | 0.081 | 0.084 | |
| [EPE] | 0.142 | 0.146 | 0.125 | 0.136 | 0.146 | |
| [EPP] | 0.093 | 0.102 | 0.219 | 0.195 | 0.177 | |
| [PPP] | 0.013 | 0.005 | 0.048 | 0.048 | 0.041 | |
| Average —CH₂— | 13.04 | 12.84 | 10.58 | 10.40 | 10.43 | |
| Sequence Length for | | | | | | |
| Sequences 6+ | | | | | | |
| % methylene | 53.76 | 55.77 | 38.22 | 38.85 | 38.88 | |
| sequences 6+ | | | | | | |
| E RUN # | 18.8 | 18.0 | 21.1 | 22.4 | 23.1 | |
| P RUN # | 18.9 | 19.7 | 23.4 | 23.3 | 23.5 | |

| VI additive # | 31 | 32 | 33 |
|---|---|---|---|
| Polymerization | 120 | 90 | 100 |
| temperature (° C.) | | | |
| Ethylene | 6.79 | 6.22 | 6.22 |
| feed rate | | | |
| (g/min) | | | |
| Propylene | 3.5 | 6 | 6 |
| feed rate | | | |
| (g/min) | | | |
| Isohexane | 56.7 | 56.7 | 56.7 |
| feed rate | | | |
| (g/min) | | | |
| Catalyst #1 | 8.11E−08 | 1.08E−07 | 1.08E−07 |
| feed rate | | | |
| (mol/min) | | | |
| Yield (g/min) | 9.4 | 10.9 | 10.9 |
| Conversion (%) | 91.0% | 89.4% | 89.1% |
| Catalyst | 175,523 | 153,567 | 153,051 |
| productivity | | | |
| (kg Poly/Kg cat) | | | |
| Complex viscosity at | 773 | 2226 | 898 |
| 100 rad/s (Pa s) | | | |
| Complex viscosity at | 13,485 | 312,229 | 36,678 |
| 0.1 rad/s (Pa s) | | | |
| Shear thinning | 17.44 | 140.29 | 40.84 |
| ratio (—) | | | |
| MFR (g/10 min) | 3.2 | | 1.1 |
| HLMFR (g/10 min) | 176.4 | 7.9 | 72.4 |
| Mn_DRI (g/mol) | 25,728 | 58,614 | 42,009 |
| Mw_DRI (g/mol) | 91,786 | 202,692 | 133,285 |
| Mz_DRI (g/mol) | 189,313 | 429,836 | 280,464 |
| MWD (—) | 3.57 | 3.46 | 3.17 |
| Mn_LS (g/mol) | 34,687 | 68,969 | 49,358 |
| Mw_LS (g/mol) | 106,588 | 251,774 | 156,827 |
| Mz_LS (g/mol) | 221,937 | 548,583 | 325,705 |
| g′ᵥᵢₛ (—) | 0.685 | 0.704 | 0.683 |
| Ethylene content | 69.7% | 54.1% | 54.8% |
| by FTIR (wt %) | | | |
| Tm (° C.) | 16.7 | −21.3 | −22.0 |
| Tg (° C.) | −54 | −58 | −60 |
| Heat of | 29.4 | 4.9 | 5.7 |
| fusion (J/g) | | | |

| VI additive # | 34* | 35* | 36* | 37* | 38* |
|---|---|---|---|---|---|
| Polymerization | 80 | 80 | 80 | 80 | 80 |
| temperature (° C.) | | | | | |
| Reactor | 320 | 320 | 320 | 320 | 320 |
| Pressure (psi) | | | | | |
| Ethylene | 3.13 | 2.76 | 2.4 | 2.03 | 1.67 |
| feed rate | | | | | |
| (g/min) | | | | | |
| Propylene | 4.8 | 4.2 | 3.6 | 3 | 2.4 |
| feed rate | | | | | |
| (g/min) | | | | | |
| Isohexane | 59.4 | 59.4 | 59.4 | 59.4 | 59.4 |
| feed rate | | | | | |
| (g/min) | | | | | |
| Catalyst #2 | 7.34E−08 | 7.34E−08 | 7.34E−08 | 7.34E−08 | 7.34E−08 |
| feed rate | | | | | |
| (mol/min) | | | | | |
| Yield (g/min) | 5.1 | 4.3 | 3.6 | 3.0 | 2.4 |
| Conversion (%) | 64.3% | 61.8% | 60% | 59.6% | 59.0% |
| Catalyst | 114,863 | 96,187 | 80,550 | 66,488 | 53,775 |
| productivity | | | | | |
| (kg Poly/Kg cat) | | | | | |
| Complex viscosity at | 2,869 | 3,197 | 2,833 | 2,448 | |
| 100 rad/s (Pa s) | | | | | |
| Complex viscosity at | 339,852 | 367,336 | 256,233 | 171,742 | |
| 0.1 rad/s (Pa s) | | | | | |
| Shear thinning | 118.46 | 114.91 | 90.44 | 70.15 | |
| ratio (—) | | | | | |
| Mn_DRI (g/mol) | 83,767 | 83,025 | 74,492 | 65,086 | 52,198 |
| Mw_DRI (g/mol) | 204,312 | 194,276 | 175,923 | 156,557 | 131,438 |
| Mz_DRI (g/mol) | 392,410 | 379,375 | 333,931 | 302,966 | 254,267 |
| MWD (—) | 2.44 | 2.34 | 2.36 | 2.41 | 2.52 |
| Mn_LS (g/mol) | 104,568 | 99,476 | 95,004 | 73,393 | 64,884 |
| Mw_LS (g/mol) | 240,433 | 223,741 | 201,130 | 171,717 | 143,791 |
| Mz_LS (g/mol) | 451,655 | 409,392 | 365,776 | 308,691 | 254,802 |
| g′ᵥᵢₛ (—) | 0.865 | 0.884 | 0.878 | 0.878 | 0.875 |
| Ethylene content | 50.9% | 51.9% | 52.3% | 52.8% | 52.8% |
| by FTIR (wt %) | | | | | |
| Tm (° C.) | −1.7 | −7.6 | −7.9 | −6.2 | |
| Tg (° C.) | | | | | |
| Heat of | 11 | 18 | 17 | 17 | |
| fusion (J/g) | | | | | |

| VI additive # | 39 | 40 | 41 | 42 |
|---|---|---|---|---|
| Polymerization | 95 | 99 | 90 | 120 |
| temperature (° C.) | | | | |
| Ethylene | 9.05 | 9.05 | 5.66 | 6.79 |
| feed rate | | | | |
| (g/min) | | | | |
| Propylene | 8.00 | 6.00 | 8.00 | 8.00 |
| feed rate | | | | |
| (g/min) | | | | |
| Isohexane | 55.2 | 55.2 | 55.2 | 82.7 |
| feed rate | | | | |
| (g/min) | | | | |
| Catalyst #2 | 2.75E−08 | 2.75E−08 | 6.61E−08 | 4.41E−08 |
| feed rate | | | | |
| (mol/min) | | | | |
| Yield (g/min) | 10.3 | 8.6 | 9.4 | 9.0 |
| Conversion (%) | 60.10% | 57.40% | 68.50% | 60.50% |
| Catalyst | 615,180 | 518,383 | 233,951 | 335,645 |
| productivity | | | | |
| (kg Poly/Kg cat) | | | | |
| Complex viscosity at | 3,344 | 3,035 | 1,407 | |
| 100 rad/s (Pa s) | | | | |
| Complex viscosity at | 613,200 | 684,109 | 81,806 | |
| 0.1 rad/s (Pa s) | | | | |
| Shear thinning | 183.39 | 225.43 | 58.13 | |
| ratio | | | | |
| MFR (g/10 min) | 0.01 | 0.01 | 1.15 | |
| Mn_DRI (g/mol) | 56,612 | 60,824 | 49,475 | 5,620 |
| Mw_DRI (g/mol) | 237,994 | 230,951 | 153,032 | 31,329 |
| Mz_DRI (g/mol) | 509,909 | 494,546 | 306,324 | 66,960 |
| MWD (—) | 4.20 | 3.80 | 3.09 | 5.57 |
| Mn_LS (g/mol) | 77,415 | 76,820 | 58,223 | 8,194 |
| Mw_LS (g/mol) | 260,320 | 247,404 | 161,667 | 31,356 |
| Mz_LS (g/mol) | 564,006 | 508,289 | 321,827 | 81,465 |
| g′ᵥᵢₛ (—) | 0.837 | 0.84 | 0.798 | 0.881 |
| Ethylene content | 67.0% | 71.2% | 46.8% | 46.3% |
| by FTIR (wt %) | | | | |
| Tc (° C.) | 17.4 | 34.4 | −24.8 | |
| Tm (C) | 35.6 | 50.6 | −16.1 | |
| Tg (° C.) | −50.9 | −46.8 | −52.1 | −61.1 |
| Heat of | 39.4 | 42.0 | 8.4 | |
| fusion (J/g) | | | | |
| Mole % Ethylene^{a} | 68.6% | 74.8% | 56.3% | 62.7% |
| Mole % Propylene^{a} | 31.4% | 25.2% | 43.7% | 37.3% |
| Mole % Regio | 0.60 | 0.51 | 0.71 | 0.72 |
| r₁r₂ | 2.25 | 2.27 | 2.56 | 1.27 |
| [EEE] | 0.399 | 0.482 | 0.250 | 0.278 |
| [EEP] | 0.239 | 0.230 | 0.242 | 0.263 |
| [PEP] | 0.049 | 0.037 | 0.069 | 0.085 |
| [EPE] | 0.099 | 0.099 | 0.082 | 0.136 |
| [EPP] | 0.164 | 0.121 | 0.217 | 0.174 |
| [PPP] | 0.050 | 0.031 | 0.141 | 0.063 |
| Average —CH₂— | 13.50 | 15.38 | 11.20 | 11.49 |
| Sequence Length | | | | |
| for Sequences 6+ | | | | |
| % methylene | 53 | 58 | 40 | 37 |
| sequences 6+ | | | | |
| E RUN # | 16.8 | 15.2 | 19.0 | 21.7 |
| P RUN # | 18.1 | 15.9 | 19.0 | 22.3 |

| VI additive # | 43 | 44 | 45 | 46 | 47 | 48 | 49 |
|---|---|---|---|---|---|---|---|
| Polymerization | 120 | 110 | 100 | 90 | 120 | 110 | 90 |
| temperature (° C.) | | | | | | | |
| Ethylene | 6.79 | 6.79 | 6.79 | 6.79 | 6.79 | 6.79 | 6.79 |
| feed rate | | | | | | | |
| (g/min) | | | | | | | |
| Propylene | 6.00 | 6.00 | 6.00 | 6.00 | 6.00 | 6.00 | 6.00 |
| feed rate | | | | | | | |
| (g/min) | | | | | | | |
| Isohexane | 56.7 | 56.7 | 56.7 | 56.7 | 82.7 | 82.7 | 82.7 |
| feed rate | | | | | | | |
| (g/min) | | | | | | | |
| Catalyst #3 | 3.47E−08 | 3.47E−08 | 3.47E−08 | 3.47E−08 | 1.85E−07 | 1.85E−07 | 1.85E−07 |
| feed rate | | | | | | | |
| (mol/min) | | | | | | | |
| Yield (g/min) | 3.6 | 5.1 | 5.5 | 5.8 | 8.1 | 8.4 | 9.5 |
| Conversion (%) | 28.1% | 39.9% | 42.7% | 45.3% | 63.4% | 65.3% | 74.4% |
| Catalyst | 179,604 | 254,971 | 272,719 | 289,717 | 75,998 | 78,295 | 89,242 |
| productivity | | | | | | | |
| (kg Poly/Kg cat) | | | | | | | |
| Complex viscosity | | | 2,777 | 3,675 | 65 | 218 | 920 |
| at 100 rad/s (Pa s) | | | | | | | |
| Complex viscosity | | | 205,674 | 379,193 | 105 | 635 | 23,306 |
| at 0.1 rad/s (Pa s) | | | | | | | |
| Shear thinning | | | 74.07 | 103.19 | 1.63 | 2.91 | 25.34 |
| ratio (—) | | | | | | | |
| ML (mu) | | | | | 0.5 | 2.5 | 20.1 |
| MLRA (mu-sec) | | | | | | 28.6 | 121.9 |
| cMLRA (mu.-sec) | | | | | | 4,205 | 891 |
| Mn_DRI (g/mol) | 36,471 | 44,623 | 71,067 | 99,960 | 14,777 | 20,206 | 38,225 |
| Mw_DRI (g/mol) | 118,530 | 127,814 | 163,644 | 174,640 | 41,519 | 54,641 | 110,666 |
| Mz_DRI (g/mol) | 263,894 | 255,990 | 306,189 | 6,656,332 | 91,150 | 83,482 | 222,762 |
| MWD (—) | 3.25 | 2.86 | 2.30 | 1.75 | 2.81 | 2.70 | 2.90 |
| Mn_LS (g/mol) | 42,945 | 52,969 | 78,885 | 90,335 | 16,150 | 24,705 | 46,418 |
| Mw_LS (g/mol) | 128,775 | 133,657 | 167,089 | 205,547 | 44,044 | 56,907 | 128,356 |
| Mz_LS (g/mol) | 303,816 | 284,106 | 303,546 | 350,814 | 114,928 | 123,363 | 308,272 |
| g′ᵥᵢₛ (—) | 0.795 | 0.853 | 0.893 | 0.892 | 0.816 | 0.809 | 0.765 |
| Tc (° C.) | 11.7 | 19.0 | 18.1 | 12.4 | 16.2 | 18.1 | 16.2 |
| Tm (° C.) | 23.2 | 39.4 | 35.2 | 23.6 | 34.6 | 39.4 | 34.6 |
| Tg (° C.) | −49.3 | −46.9 | −49.0 | −49.2 | −48.0 | −47.5 | −48.0 |
| Heat of | 30.2 | 40.4 | 39.6 | 30.1 | 39.3 | 35.2 | 39.3 |
| fusion (J/g) | | | | | | | |
| Ethylene content | 72.1% | 71.0% | 69.6% | 66.1% | 62.5% | 61.2% | 64.9% |
| by FTIR (wt %) | | | | | | | |
| Mole % Ethylene^{a} | 76.8% | 75.5% | 74.5% | 72.1% | 70.3% | 68.4% | 64.9% |
| Mole % Propylene^{a} | 23.2% | 24.5% | 25.5% | 27.9% | 29.7% | 31.6% | 35.1% |
| Mole % Regio | 0.51 | 0.59 | 0.47 | 0.64 | 0.94 | 1.18 | 0.61 |
| r₁r₂ | 1.80 | 1.88 | 2.04 | 2.04 | 1.63 | 1.74 | 2.02 |
| [EEE] | 0.499 | 0.487 | 0.473 | 0.434 | 0.392 | 0.373 | 0.334 |
| [EEP] | 0.238 | 0.239 | 0.241 | 0.248 | 0.264 | 0.261 | 0.263 |
| [PEP] | 0.034 | 0.031 | 0.032 | 0.039 | 0.048 | 0.052 | 0.051 |
| [EPE] | 0.108 | 0.104 | 0.101 | 0.106 | 0.118 | 0.116 | 0.104 |
| [EPP] | 0.100 | 0.122 | 0.131 | 0.137 | 0.144 | 0.153 | 0.184 |
| [PPP] | 0.021 | 0.017 | 0.022 | 0.036 | 0.034 | 0.045 | 0.064 |
| Average —CH2— | 15.11 | 14.53 | 14.33 | 13.94 | 12.66 | 12.51 | 11.92 |
| Sequence Length | | | | | | | |
| for Sequences 6+ | | | | | | | |
| % methylene | 59 | 63 | 62 | 57 | 52 | 49 | 50 |
| sequences 6+ | | | | | | | |
| E RUN # | 15.3 | 15.1 | 15.2 | 16.3 | 18.0 | 18.2 | 18.3 |
| P RUN # | 15.8 | 16.5 | 16.7 | 17.4 | 18.9 | 19.3 | 19.6 |

| VI additive # | 50 | 51 | 52 | 53 | 54 | 55 |
|---|---|---|---|---|---|---|
| Polymerization | 89 | 89 | 87 | 85 | 82 | 77 |
| temperature (° C.) | | | | | | |
| Ethylene | 63.33 | 63.33 | 63.33 | 63.33 | 63.33 | 58.50 |
| feed rate | | | | | | |
| (g/min) | | | | | | |
| Propylene | 109.67 | 109.67 | 109.67 | 109.67 | 109.67 | 101.50 |
| feed rate | | | | | | |
| (g/min) | | | | | | |
| Isohexane | 1328.7 | 1333.7 | 1378.5 | 1425.7 | 1501.0 | 1514.5 |
| feed rate | | | | | | |
| (g/min) | | | | | | |
| Catalyst #1 | 2.89E−06 | 2.85E−06 | 2.74E−06 | 2.95E−06 | 3.09E−06 | 3.49E−06 |
| feed rate | | | | | | |
| (mol/min) | | | | | | |
| Conversion (%) | 66.3% | 66.4% | 66.6% | 66.6% | 66.7% | 67.2% |
| Catalyst | 196143 | 198956 | 208145 | 193247 | 184736 | 152850 |
| productivity | | | | | | |
| (kg Poly/kg cat) | | | | | | |
| Complex viscosity at | 883 | 881 | 1,093 | 1,213 | 1,454 | 1,780 |
| 100 rad/s (Pa s) | | | | | | |
| Complex viscosity at | 18,584 | 18,173 | 32,534 | 43,831 | 67,091 | 110,015 |
| 0.1 rad/s (Pa s) | | | | | | |
| Shear thinning | 21.04 | 20.63 | 29.78 | 36.13 | 46.13 | 61.79 |
| ratio (—) | | | | | | |
| ML (mu) | 18.2 | 18.3 | 21.9 | 23.8 | 26.8 | 31.6 |
| MLRA (mu-sec) | 85.6 | 85.9 | 119.6 | 135.8 | 160 | 217.5 |
| CMLRA (mu.-sec) | 722 | 719 | 773 | 778 | 773 | 829 |
| Mn_DRI (g/mol) | 44,835 | 44,853 | 50,608 | 49,610 | 62,077 | 58,963 |
| Mw_DRI (g/mol) | 121,951 | 117,255 | 134,596 | 132,181 | 152,258 | 156,852 |
| Mz_DRI (g/mol) | 241,309 | 227,326 | 260,563 | 257,833 | 294,682 | 302,906 |
| MWD (—) | 2.72 | 2.61 | 2.66 | 2.66 | 2.45 | 2.66 |
| Mn_LS (g/mol) | 50,546 | 52,003 | 50,608 | 54,325 | 74,263 | 63,777 |
| Mw_LS (g/mol) | 135,399 | 127,926 | 147,299 | 141,673 | 167,102 | 169,416 |
| Mz_LS (g/mol) | 262,503 | 246,476 | 279,423 | 262,086 | 298,101 | 317,613 |
| g′ᵥᵢₛ (—) | 0.787 | 0.788 | 0.799 | 0.8 | 0.817 | 0.818 |
| Ethylene content | 47.5% | 47.2% | 47.4% | 47.8% | 47.3% | 47.0% |
| by FTIR (wt %) | | | | | | |
| Tg (° C.) | −57.3 | −57.2 | −57.1 | −56.7 | −56.8 | −56.4 |
| Vinylenes/1000 C | 0.19 | 0.16 | 0.25 | 0.14 | 0.15 | 0.12 |
| trisubs/1000 C | 0.43 | 0.22 | 0.45 | 0.18 | 0.21 | 0.17 |
| Vinyls/1000 C | 0.84 | 0.77 | 0.86 | 0.58 | 0.46 | 0.32 |
| Vinylidenes/1000 C | 0.14 | 0.06 | 0.09 | 0.08 | 0.06 | 0.05 |
| % vinyl | 52.5 | 63.6 | 52.1 | 59.2 | 52.3 | 48.5 |
| VI additive # | 56 | 57 | 58 | 59 | 60 | 61 |
| Polymerization | 68 | 90 | 100 | 100 | 100 | 100 |
| temperature (° C.) | | | | | | |
| Ethylene | 58.50 | 58.33 | 63.33 | 59.83 | 59.33 | 58.17 |
| feed rate | | | | | | |
| (g/min) | | | | | | |
| Propylene | 101.50 | 101.17 | 113.33 | 106.83 | 105.83 | 103.67 |
| feed rate | | | | | | |
| (g/min) | | | | | | |
| Isohexane | 1678.3 | 1677.3 | 1138.8 | 1125.3 | 1126.5 | 1128.7 |
| feed rate | | | | | | |
| (g/min) | | | | | | |
| Catalyst #1 | 3.44E−06 | 4E−06 | 2.12E−06 | 2.75E−06 | 2.85E−06 | 3.28E−06 |
| feed rate | | | | | | |
| (mol/min) | | | | | | |
| Conversion (%) | 64.0% | 63.4% | 65.0% | 68.1% | 68.2% | 70.0% |
| Catalyst | 146,986 | 124,817 | 268,602 | 203,832 | 196,123 | 170,567 |
| productivity | | | | | | |
| (kg Poly/kg cat) | | | | | | |
| Complex viscosity at | 2,667 | 2,223 | 400 | 248 | 260 | 171 |
| 100 rad/s (Pa s) | | | | | | |
| Complex viscosity at | 322,559 | 190,857 | 1,889 | 712 | 782 | 433 |
| 0.1 rad/s (Pa s) | | | | | | |
| Shear thinning | 120.94 | 85.84 | 4.72 | 2.88 | 3.01 | 2.53 |
| ratio (—) | | | | | | |
| MFR (g/10 min) | | | 18.01 | 40.86 | 36.76 | 59.71 |
| HLMFR (g/10 min) | | | 818.7 | 1683.0 | 1535.5 | 2385.4 |
| ML (mu) | 41.4 | 38.1 | | | | |
| MLRA (mu-sec) | 308.1 | 274.9 | | | | |
| CMLRA (mu.-sec) | 796 | 800 | | | | |
| Mn_DRI (g/mol) | 71,297 | 76,249 | 31,467 | 29,584 | 28,661 | 26,218 |
| Mw_DRI (g/mol) | 189,989 | 196,535 | 82,508 | 76,208 | 76,731 | 72,674 |
| Mz_DRI (g/mol) | 374,914 | 382,789 | 161,679 | 145,131 | 147,748 | 143,456 |
| MWD (—) | 2.66 | 2.58 | 2.62 | 2.58 | 2.68 | 2.77 |
| Mn_LS (g/mol) | 79,662 | 88,552 | 36,968 | 33,874 | 33,347 | 26,396 |
| Mw_LS (g/mol) | 202,787 | 217,290 | 89,310 | 85,142 | 84,517 | 79,391 |
| Mz_LS (g/mol) | 377,353 | 399,968 | 165,323 | 164,948 | 163,946 | 153,420 |
| g′ᵥᵢₛ (—) | 0.827 | 0.814 | 0.764 | 0.763 | 0.755 | 0.744 |
| Ethylene content | 47.0% | 47.0% | 48.1% | 46.8% | 46.7% | 46.3% |
| by FTIR (wt %) | | | | | | |
| Tg (° C.) | −56.0 | −56.1 | −58.2 | −57.9 | −57.8 | −57.6 |
| Vinylenes/1000 C | 0.17 | 0.07 | 0.14 | 0.14 | 0.11 | 0.07 |
| trisubs/1000 C | 0.35 | 0.17 | 0.12 | 0.2 | 0.09 | 0.15 |
| Vinyls/1000 C | 0.22 | 0.21 | 1 | 1.01 | 0.83 | 0.57 |
| Vinylidenes/1000 C | 0.04 | 0 | 0.09 | 0.05 | 0.06 | 0.04 |
| % vinyl | 28.2 | 46.7 | 74.1 | 72.1 | 76.1 | 68.7 |
| VI additive # | 62 | 63 | 64 | 65 | 66 | 67 |
| Polymerization | 100 | 92 | 81 | 91 | 95 | 100 |
| temperature (° C.) | | | | | | |
| Ethylene | 57.33 | 58.67 | 60.00 | 56.50 | 79.17 | 87.83 |
| feed rate | | | | | | |
| (g/min) | | | | | | |
| Propylene | 101.67 | 99.33 | 96.50 | 101.00 | 138.50 | 153.33 |
| feed rate | | | | | | |
| (g/min) | | | | | | |
| Isohexane | 1128.7 | 1270.2 | 1565.2 | 1208.7 | 1558.8 | 1617.7 |
| feed rate | | | | | | |
| (g/min) | | | | | | |
| Catalyst #1 | 3.67E−06 | 4.03E−06 | 5.02E−06 | 1.6E−06 | 2.12E−06 | 2.29E−06 |
| feed rate | | | | | | |
| (mol/min) | | | | | | |
| Conversion (%) | 71.5% | 72.8% | 74.0% | 67.9% | 69.6% | 65.7% |
| Catalyst | 153,120 | 141,197 | 114,359 | 164,913 | 176,091 | 171,171 |
| productivity | | | | | | |
| (kg Poly/kg cat) | | | | | | |
| Complex viscosity at | 117 | 360 | 1,230 | 630 | 448 | 324 |
| 100 rad/s (Pa s) | | | | | | |
| Complex viscosity at | 270 | 1,713 | 55,259 | 6,919 | 2,803 | 1,436 |
| 0.1 rad/s (Pa s) | | | | | | |
| Shear thinning | 2.31 | 4.76 | 44.91 | 10.99 | 6.26 | 4.43 |
| ratio (—) | | | | | | |
| MFR (g/10 min) | 97.42 | 20.08 | 0.53 | 5.92 | 12.94 | 24.05 |
| HLMFR (g/10 min) | | 901.2 | 50.3 | 342.4 | 593.0 | 1058.4 |
| Mn_DRI (g/mol) | 24,866 | 33,981 | 51,957 | 40,954 | 34,306 | 27,895 |
| Mw_DRI (g/mol) | 70,423 | 91,094 | 145,864 | 108,675 | 89,941 | 79,281 |
| Mz_DRI (g/mol) | 150,705 | 180,670 | 301,712 | 270,220 | 178,854 | 166,390 |
| MWD (—) | 2.83 | 2.68 | 2.81 | 2.65 | 2.62 | 2.84 |
| Mn_LS (g/mol) | 27,619 | 36,688 | 59,261 | 47,980 | 40,985 | 32,973 |
| Mw_LS (g/mol) | 74,333 | 100,418 | 156,401 | 116,666 | 102,250 | 88,545 |
| Mz_LS (g/mol) | 137,125 | 194,441 | 285,457 | 226,188 | 203,399 | 196,331 |
| g′ᵥᵢₛ (—) | 0.723 | 0.76 | 0.756 | 0.779 | 0.759 | 0.769 |
| Ethylene content | 45.4% | 45.8% | 46.7% | 46.5% | 47.2% | 48.0% |
| by FTIR (wt %) | | | | | | |
| Tg (° C.) | −57.3 | −57.0 | −56.5 | −57.1 | −57.3 | −58.0 |
| Vinylenes/1000 C | 0.19 | | 0.17 | 0.12 | 0.03 | 0.18 |
| trisubs/1000 C | 0.15 | | 0.29 | 0.12 | 0.12 | 0.33 |
| Vinyls/1000 C | 0.97 | | 0.76 | 0.79 | 0.34 | 1.16 |
| Vinylidenes/1000 C | 0.06 | | 0.03 | 0.09 | 0 | 0.13 |
| % vinyl | 70.8 | | 60.8 | 70.5 | 69.4 | 64.4 |

| VI additive # | 68 | 69 | 70 | 71 | 72 | 73 | 74 |
|---|---|---|---|---|---|---|---|
| Polymerization | 105 | 110 | 115 | 117 | 123 | 132 | 145 |
| temperature (° C.) | | | | | | | |
| Ethylene | 87.83 | 92.33 | 92.33 | 121.83 | 121.17 | 121.17 | 133.83 |
| feed rate | | | | | | | |
| (g/min) | | | | | | | |
| Propylene | 153.33 | 161.50 | 161.50 | 84.33 | 83.83 | 83.83 | 92.67 |
| feed rate | | | | | | | |
| (g/min) | | | | | | | |
| Isohexane | 1510.3 | 1486.8 | 1395.3 | 1382.8 | 1340.5 | 1212.3 | 1174.8 |
| feed rate | | | | | | | |
| (g/min) | | | | | | | |
| Catalyst #1 | 2.16E−06 | 1.92E−06 | 1.83E−06 | 7.56E−07 | 1.07E−06 | 1.03E−06 | 1.24E−06 |
| feed rate | | | | | | | |
| (mol/min) | | | | | | | |
| Conversion (%) | 69.4% | 67.7% | 67.4% | 72.7% | 77.1% | 76.2% | 74.5% |
| Catalyst | 191,389 | 220,993 | 230,615 | 488,718 | 365,091 | 379,964 | 336,715 |
| productivity | | | | | | | |
| (kg Poly/kg cat) | | | | | | | |
| Complex viscosity | 155 | 95 | 35 | 1,539 | 494 | 208 | 37 |
| at 100 rad/s (Pa s) | | | | | | | |
| Complex viscosity | 317 | 132 | 42 | 71,893 | 3,114 | 463 | 40 |
| at 0.1 rad/s (Pa s) | | | | | | | |
| Shear thinning | 2.04 | 1.39 | 1.22 | 46.70 | 6.31 | 2.23 | 1.10 |
| ratio (—) | | | | | | | |
| MFR (g/10 min) | 88.4 | 175.74 | 437.97 | 0.33 | 10.67 | 53.36 | 455.72 |
| HLMFR (g/10 min) | | | | 31.1 | 495.3 | 2021.3 | |
| ML (mu) | | | | 28.7 | | | |
| MLRA (mu-sec) | | | | 200.8 | | | |
| cMLRA (mu.-sec) | | | | 878 | | | |
| Mn_DRI (g/mol) | 23,648 | 20,408 | 17,242 | 38,672 | 24,989 | 21,515 | 13,798 |
| Mw_DRI (g/mol) | 63,017 | 58,699 | 44,990 | 105,256 | 70,233 | 56,471 | 36,982 |
| Mz_DRI (g/mol) | 123,901 | 146,772 | 85,256 | 215,862 | 142,410 | 109,785 | 70,322 |
| MWD (—) | 2.66 | 2.88 | 2.61 | 2.72 | 2.81 | 2.62 | 2.68 |
| Mn_LS (g/mol) | 27,348 | 23,844 | 21,106 | 46,082 | 30,351 | 23,329 | 15,683 |
| Mw_LS (g/mol) | 72,565 | 60,889 | 50,971 | 118,854 | 80,354 | 60,133 | 38,135 |
| Mz_LS (g/mol) | 159,751 | 119,193 | 109,570 | 243,216 | 167,605 | 119,971 | 77,177 |
| g′ᵥᵢₛ (—) | 0.76 | 0.748 | 0.748 | 0.792 | 0.737 | 0.825 | 0.821 |
| Ethylene content | 47.8% | 48.4% | 48.3% | 71.2% | 69.7% | 69.8% | 70.4% |
| by FTIR (wt %) | | | | | | | |
| Tm (° C.) | — | — | — | 38.5 | 19.4 | 19.4 | 20.0 |
| Tg (° C.) | −56.8 | −59.1 | −59.3 | −46.3 | −47.1 | −48.6 | −47.1 |
| Heat of | | | | 30.7 | 29.5 | 30.3 | 32.9 |
| fusion (J/g) | | | | | | | |
| Vinylenes/1000 C | 0.14 | 0.48 | | 0.14 | 0.18 | 0.42 | 0.26 |
| trisubs/1000 C | 0.2 | 1.01 | | 0.2 | 0.34 | 0.65 | 0.33 |
| Vinyls/1000 C | 1.23 | 0.56 | | 0.59 | 1.39 | 0.5 | 1.86 |
| Vinylidenes/1000 C | 0.12 | 0.05 | | 0.04 | 0.19 | 0.02 | 0.35 |
| % vinyl | 72.8 | 26.7 | | 60.8 | 66.2 | 31.4 | 66.4 |

| VI additive # | C1 | C2 |
|---|---|---|
| Complex viscosity at | 1449.08 | 682.73 |
| 100 rad/s (Pa s) | | |
| Complex viscosity at | 9529.65 | 2637.63 |
| 0.1 rad/s (Pa s) | | |
| Shear thinning | 6.58 | 3.86 |
| ratio (—) | | |
| Mn_DRI (g/mol) | 51,677 | 41,413 |
| Mw_DRI (g/mol) | 126,986 | 92,699 |
| Mz_DRI (g/mol) | 218,910 | 154,003 |
| MWD (—) | 2.46 | 2.24 |
| Mn_LS (g/mol) | 52,465 | 44,274 |
| Mw_LS (g/mol) | 119,715 | 85,020 |
| Mz_LS (g/mol) | 194,921 | 130,515 |
| g′ᵥᵢₛ (—) | 0.999 | 1.010 |
| Ethylene content | 42.8 | 45.6 |
| by FTIR (wt %) | | |

^{a}From ¹³C NMR
*These examples are from U.S. Pat. No. 9,657,122

Table 1 also contains samples C1 and C2, which are comparative, linear OCPs. C1 is and C2 are commercial linear EP copolymers respectively.

The polymer molecular weight and molecular weight distribution (MWD) from different detectors are listed in Table 1. Table 1 lists characterization results of the long chain branched ethylene copolymers. Evidence of long-chain branching in examples 1-74, is found in the both the branching index (g′ᵥᵢₛ) and shear thinning ratio. The branching in index of the comparative, linear OCP samples C1 and C2 is near unity whereas the branching index of the examples 1-74 employed in the compositions of the present disclosure are significantly lower. The shear thinning ratios of the examples are also significantly higher than that of the comparative, linear examples.

The examples in Table 1 were formulated and tested as viscosity modifiers in lubricant oils. The polymer samples were blended at in a Group I diluent oil to a concentration that yielded a viscosity of approximately 15 cSt. The results of the testing are shown in Table 2.

TABLE 2
VM performance testing data

| Formulation | VI additive | | | |
|---|---|---|---|---|
| Example # | sample # or ID | TE | SSI (%) | HTHS (cP) |
| CF-1 | C1 | 2.31 | 39.4 | 3.69 |
| CF-2 | C2 | 1.74 | 24.4 | 3.87 |
| F-1 | 1 | 2.24 | 33.0 | 3.60 |
| F-2 | 2 | 1.24 | 15.9 | 4.07 |
| F-3 | 3 | 1.54 | 21.4 | 3.87 |
| F-4 | 4 | 1.88 | 28.9 | 3.44 |
| F-5 | 5 | 2.28 | 35.4 | 3.59 |
| F-6 | 6 | 1.81 | 27.8 | 3.62 |
| F-7 | 7 | 1.79 | 28.7 | 3.61 |
| F-8 | 8 | 1.59 | 25.0 | 3.70 |
| F-9 | 9 | 2.32 | 35.1 | 3.39 |
| F-10 | 10 | 2.18 | 34.0 | 3.42 |
| F-11 | 11 | 2.06 | 32.2 | 3.28 |
| F-18 | 18 | 2.89 | 52.0 | 3.25 |
| F-19 | 19 | 2.18 | 36.3 | 3.49 |
| F-20 | 20 | 1.51 | 20.4 | 3.82 |
| F-21 | 21 | 2.61 | 37.3 | 3.39 |
| F-22 | 22 | 2.63 | 40.0 | 3.36 |
| F-23 | 23 | 2.37 | 36.4 | 3.46 |
| F-30 | 30 | 1.93 | 25.5 | 3.55 |
| F-31 | 31 | 1.53 | 17.6 | 3.83 |
| F-32 | 32 | 2.55 | 42.6 | 3.30 |
| F-33 | 33 | 1.83 | 28.6 | 3.58 |
| F-50 | 50 | 1.79 | 24.1 | 3.77 |
| F-51 | 51 | 1.78 | 25.9 | 3.79 |
| F-52 | 52 | 1.92 | 28.7 | 3.77 |
| F-53 | 53 | 2.13 | 29.9 | 3.68 |
| F-54 | 54 | 2.15 | 34.7 | 3.65 |
| F-55 | 55 | 2.25 | 36.6 | 3.62 |
| F-56 | 56 | 2.89 | 48.9 | 3.39 |
| F-57 | 57 | 2.67 | 44.1 | 3.43 |
| F-58 | 58 | 1.39 | 15.4 | 4.02 |
| F-59 | 59 | 1.25 | 11.4 | 4.00 |
| F-60 | 60 | 1.25 | 11.8 | 4.13 |
| F-61 | 61 | 1.17 | 10.1 | 4.06 |
| F-62 | 62 | 1.08 | 9.2 | 4.13 |
| F-63 | 63 | 1.32 | 14.2 | 4.03 |
| F-64 | 64 | 1.95 | 30.8 | 3.61 |
| F-65 | 65 | 1.62 | 24.6 | 3.82 |
| F-66 | 66 | 1.44 | 16.7 | 3.93 |
| F-67 | 67 | 1.34 | 15.6 | 3.91 |
| F-68 | 68 | 1.12 | 9.5 | 4.14 |
| F-69 | 69 | 1.01 | 7.4 | 4.24 |
| F-70 | 70 | 0.87 | 4.3 | 4.39 |
| F-71 | 71 | 2.00 | 22.8 | 3.74 |
| F-72 | 72 | 1.38 | 9.3 | 4.08 |
| F-73 | 73 | 1.14 | 5.3 | 4.27 |
| F-74 | 74 | 0.84 | 2.0 | 4.46 |

At similar TE and SSI (see Table 2), the examples employed in the compositions of the present disclosure exhibited lower HTHS compared to Formulation Examples CF-1 and/or CF-2.

Shear stability index (SSI) is determined according to ASTM D6278 at 30 cycles using using a Kurt Orbahn diesel injection apparatus.

High temperature and high shear (HTHS) is measured at 150° C. and 10⁶ 1/s according to ASTM D4683 in a Tapered Bearing Simulator.

Kinematic viscosity (KV) is determined according to ASTM D445. KV40 is the kinematic viscosity determined at a temperature of 40° C., and KV100 is the kinematic viscosity determined at a temperature of 100° C.

Thickening efficiency (TE) is defined as:

$$\\ T E = \frac{2}{c ln 2} ln ( \frac{{KV}_{polymer + oil}}{{KV}_{oil}} ) ,$$

wherein c is polymer concentration (grams of polymer/100 grams solution), KV_{oil+polymer} is kinematic viscosity of the mixture of polymer in the reference oil at 100° C., and KVₒᵢₗ is kinematic viscosity of the reference oil at 100° C.

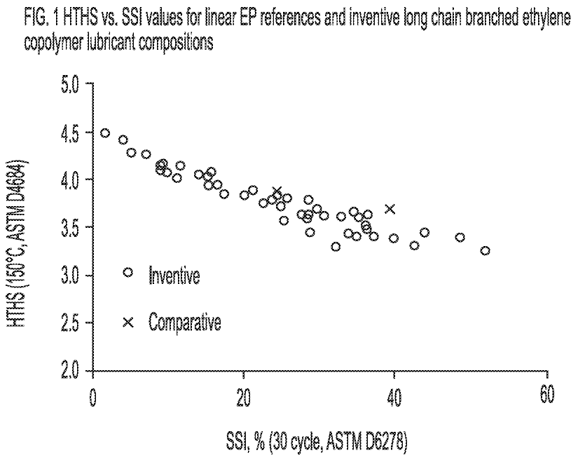

FIG. 1 is a graph illustrating the HTHS viscosity across a range of SSI for the long chain branched ethylene copolymers made using Catalyst #1 and linear OCPs as reference HTHS is a measure of shear-thinning behavior of the polymer in oil. For lubricating oils exhibiting the same low shear viscosity (KV100), a lower measured HTHS viscosity indicates that the oil may yield reduced frictional losses in an operating engine and lead to increased fuel economy (see for example, W. van Dam, T. Miller, G. Parsons: Optimizing Low Viscosity Lubricants for Improved Fuel Economy in Heavy Duty Diesel Engines. SAE Paper 2011-01-1206). The lubricating oils prepared with the inventive long chain branched EP samples show lower HTHS as compared to those prepared with linear OCPs.

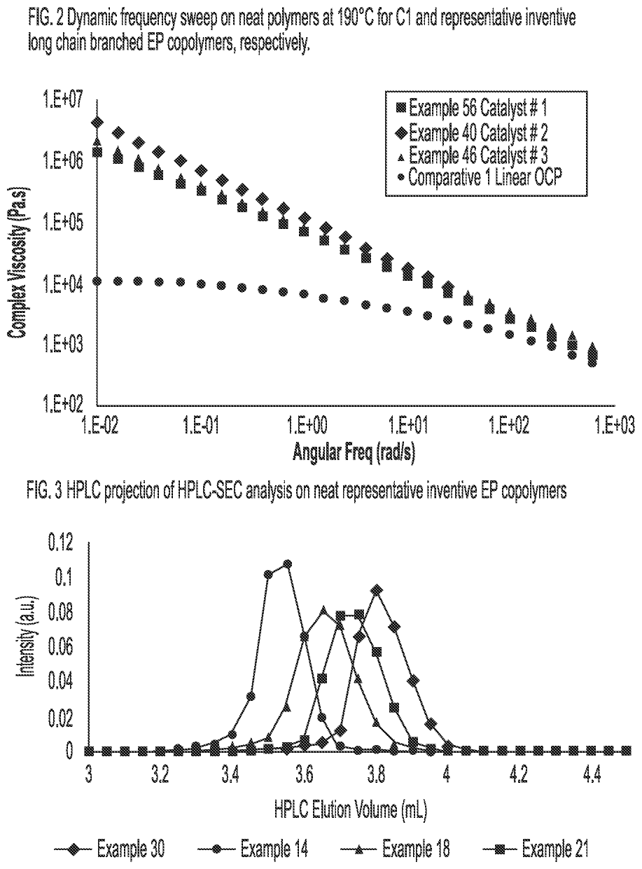

FIG. 2 is a graph illustrating the frequency sweep of the complex viscosity at 190° C. on the representative long chain branched ethylene copolymers. For comparison, the data for commercial OCP C1 is also included in the FIG. 2. The long chain branched ethylene copolymer produced in Examples 56, 40 and 46 show much stronger shear thinning with viscosity decreasing across several orders of magnitude than the commercial OCP C1 counterparts. No plateau region for the long chain branched ethylene copolymers produced in Example 56, 40 and 46 were observed in the frequency range tested, which imply that the plateau region is less than 0.01 rad/s, indicating a much earlier shear thinning onset than the commercial linear OCP grades. The shear thinning behavior indicates long chain branching.

FIG. 3 describes the HPLC projection of HPLC-SEC analysis describes the compositional uniformity of the representative polymers from their singular Gaussian peaks without shoulder peaks or secondary peaks.

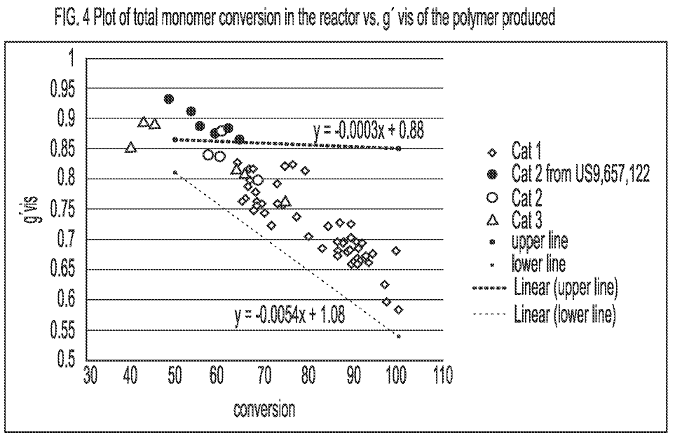

FIG. 4 is a plot of total monomer conversion in the reactor vs. g′ᵥᵢₛ of the polymer produced. This figure shows that as the total monomer conversion in the reactor is increased, the g′ᵥᵢₛ decreases which correlates with increased long chain branching in the ethylene propylene copolymer. Increased long chain branching is considered desireable in ethylene propylene copolymers used as viscosity modifiers for lubricant compositions.

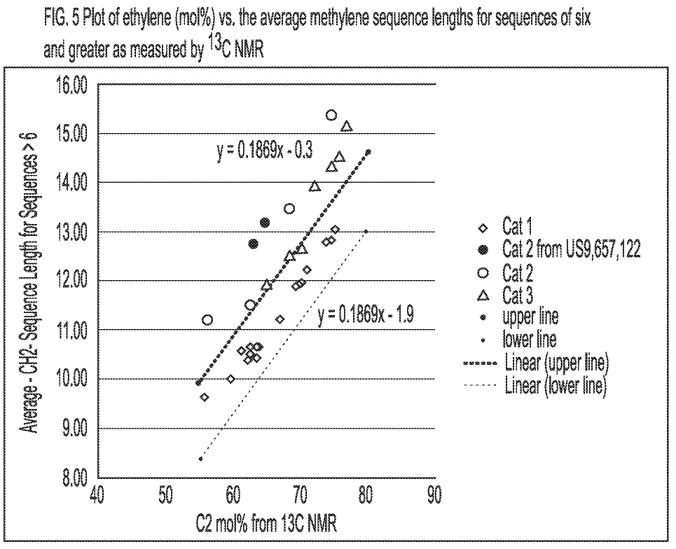

FIG. 5 is a plot of ethylene (mol %) vs. the average methylene sequence lengths for sequences of six and greater as measured by ¹³C NMR. As would be expected, methylene sequences increase in number as the amount of ethylene is increased in an ethylene propylene copolymer. For a given ethylene content, catalyst 1 has a lower average methylene sequence lengths for sequences of six and greater, vs. catalyst 2 or catalyst 3 indicating a more random distribution of ethylene and propylene within the copolymer.

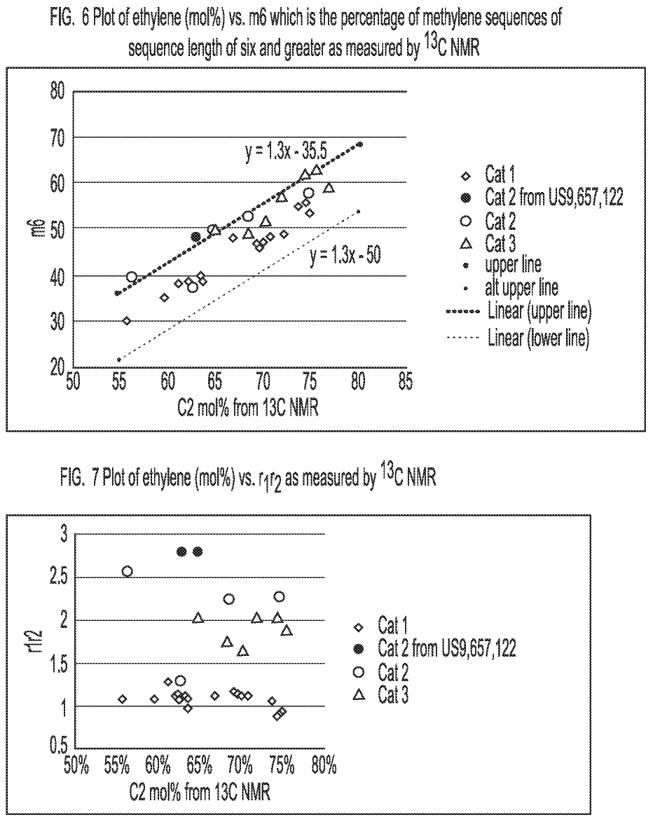

FIG. 6 is a plot of ethylene (mol %) vs. m6 which is the percentage of methylene sequences of sequence length of six and greater as measured by ¹³C NMR. As would be expected, the percentage of methylene sequences of sequence length of six or greater increases as the amount of ethylene is increased in an ethylene propylene copolymer. For a give ethylene content, catalyst 1 has a lower percentage of methylene sequences of sequence length of six and greater, vs. catalyst 2 or catalyst 3 indicating a more random distribution of ethylene and propylene with the copolymer.

FIG. 7 is a plot of ethylene (mol %) vs. r₁r₂ as measured by ¹³C NMR. FIG. 7 shows that the copolymers typically produced by catalyst 2 and catalyst 3 is a more blocky structure (r₁r₂>1.5) vs. the copolymer produced by cataylst 1 which is a random copolymer.

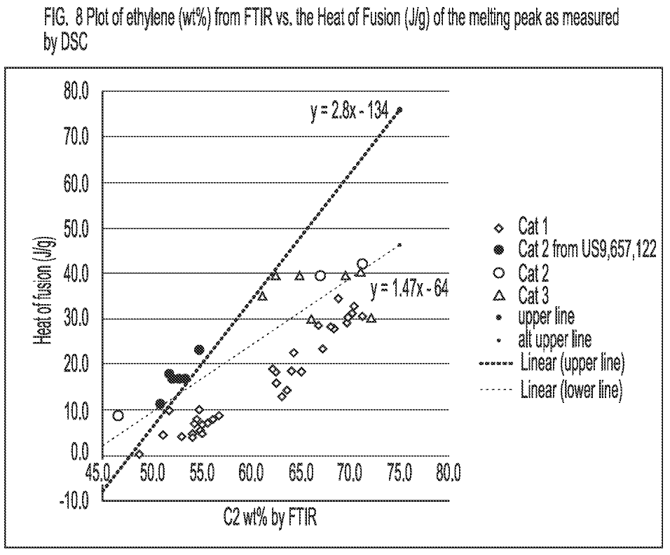

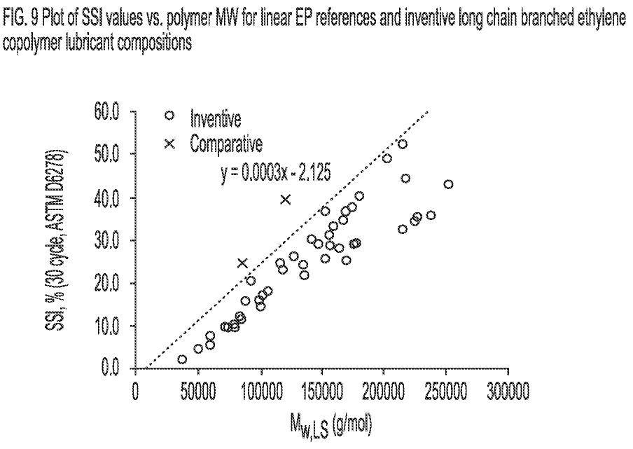

FIG. 8 is a plot of ethylene (wt %) by FTIR vs. heat of fusion as measured by DSC.

FIG. 9 is a plot of SSI (%) by ASTM D6278 vs. Mw(LS) from light scattering by GPC-3D.

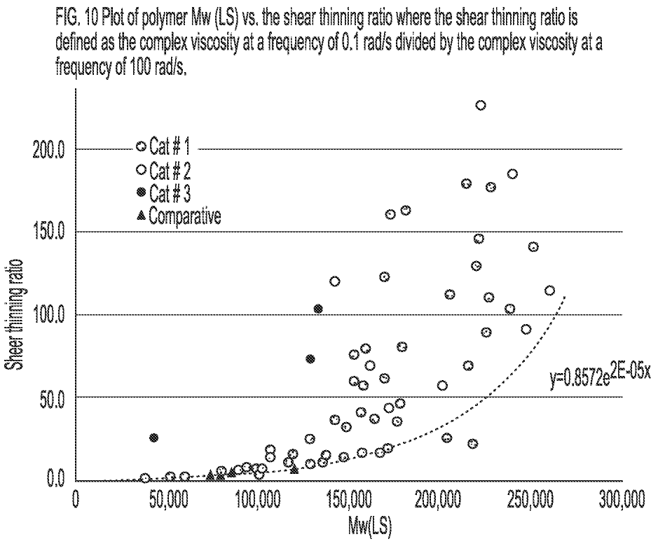

FIG. 10 is a plot of MW(LS) from light scattering from GPC-3D vs. shear thinning ratio where the shear thinning ratio is defined as the complex viscosity at a frequency of 0.1 rad/s divided by the complex viscosity at a frequency of 100 rad/s.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Likewise, the term “comprising” is considered synonymous with the term “including” for purposes of United States law. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The terms “a” and “the” as used herein are understood to encompass the plural as well as the singular.

Room temperature is about 23° C. unless otherwise noted.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

1. A lubricant composition comprising an oil and at least one long chain branched ethylene copolymer having;
a. a Mw/Mn from about 2.0 to about 6.5;
b. a Mw(LS) from about 30,000 to about 300,000 g/mol;
c. a branching index (g′ᵥᵢₛ) of from about 0.5 to about 0.97; and
d. an ethylene content of about 40 wt % to about 75 wt %.

2. The composition of claim 1, wherein the long chain branched ethylene copolymer has one or more of:
(a) a Mw(LS)/Mn(DRI) from about 2.0 to about 6.5;
(b) a Mw(LS) from about 30,000 to about 300,000 g/mol;
(c) a g′ᵥᵢₛ of from about 0.5 to about 0.97;
(d) an ethylene content of about 40 wt % to about 75 wt %; and
(e) a shear stability index (30 cycles) of from about 1% to about 60%.

3. The composition of claim 1, where the ethylene copolymer comprises a blend of a first copolymer and a second copolymer, wherein at least one of the first copolymer and second copolymer is a long chain branched ethylene copolymer and the second copolymer has an ethylene content less than the ethylene content of the first copolymer.

4. The composition of claim 1, where the long chain branched ethylene copolymer is an ethylene/propylene copolymer.

5. The composition of claim 1, wherein the lubricant composition has an aluminum content of 1 ppm or less.

6. The composition of claim 1, wherein the copolymer has an ethylene content of about 43 wt % to about 73 wt %.

7. The composition of claim 1 wherein the long chain branched ethylene copolymer has a shear thinning ratio greater than 0.8572*EXP(2E-05*w) where w is the Mw(LS) from light scattering GPC-3D.

8. The composition of claim 1, which has a kinematic viscosity at 100° C. of from about 3 cSt to about 30 cSt.

9. The composition of claim 1, which has a kinematic viscosity at 100° C. of from about 10 cSt to about 15 cSt.

10. The composition of claim 1 has a shear stability index (30 cycles) of from about 10% to about 50%.

11. The composition of claim 1, which has a shear stability index (30 cycles) of from about 15% to about 40%.

12. The composition of claim 1, which has a thickening efficiency of from about 1 to about 4.

13. The composition of claim 1 has a thickening efficiency of from about 1.5 to about 3.5.

14. The composition of claim 1, wherein the long chain branched ethylene copolymer has a g′ᵥᵢₛ of from about 0.55 to about 0.85.

15. The composition of claim 1, which comprises about 0.01 wt % to about 12 wt % of the long chain branched ethylene copolymer.

16. The composition of claim 1, which comprises about 0.01 wt % to about 3 wt % of the copolymer.

17. The composition of claim 1, wherein the oil comprises a hydrocarbon, polyalphaolefin, alkyl esters of dicarboxylic acids, polyglycols, alcohols, polybutenes, alkylbenzenes, organic esters of phosphoric acids, polysilicone oils, or combinations thereof.

18. The lubricant composition according to claim 1 further comprising at least one of a dispersant, a detergent, an antioxidant, an oiliness improver, a pour point depressant, a friction modifier, a wear modifier, an extreme pressure additive, a defoamer, a deemulsifier, or a corrosion inhibitor.

19. The composition of claim 1, which has a high temperature, high shear (HTHS) viscosity of about 4.0 cP or less.

20. The composition of claim 1, which has a shear stability index of about 60 or less.

21. The composition of claim 1, where the ethylene copolymer is made in a polymerization process using at least one metallocene catalyst.

22. The composition of claim 1 wherein the copolymer has a SSI (%) 30 cycle per ASTM D6278 less than 0.0003x-2.125 where x is Mw(LS) from GPC-3D.

23. A method of making a lubricant composition comprising blending an oil with long chain branched ethylene copolymer, wherein the copolymer has one or more of:
(a) a Mw(LS)/Mn(DRI) from about 2.0 to about 6.5;
(b) a Mw(LS) from about 30,000 to about 300,000 g/mol;
(c) a g′ᵥᵢₛ of from about 0.5 to about 0.97;
(d) an ethylene content of about 40 wt % to about 75 wt %;
(e) a shear stability index (30 cycles) of from about 1% to about 60%.

24. A method of lubricating an engine comprising supplying to the engine a lubricating oil composition comprising an oil and a long chain branched ethylene copolymer; wherein the long chain branched ethylene copolymer has one or more of the following: a) a Mw/Mn from about 2.0 to about 6.5; b) a Mw(LS) from about 30,000 to about 300,000 g/mol; c) a branching index (g′ᵥᵢₛ) of from about 0.5 to about 0.97; d) an ethylene content of about 40 wt % to about 75 wt %, and (e) a shear stability index (30 cycles) of from about 1% to about 60%.

25. A polymerization process for producing a long chain branched ethylene propylene copolymer, wherein the process comprises: (i) contacting at a temperature greater than 50° C., ethylene and propylene with a catalyst system capable of producing long chain branched ethylene propylene copolymers having vinyl chain ends, and wherein the catalyst system comprises a metallocene catalyst compound and an activator; (ii) converting at least 50% of the ethylene and propylene to a polyolefin; and (iii) obtaining a long chain branched ethylene propylene copolymer having from about 40% to less than 80% ethylene content by weight as determined by FTIR (ASTM D3900), wherein the copolymer has (a) a g′ᵥᵢₛ of from about 0.5 to about 0.97, (b) a Mw(LS)/Mn(DRI) from about 2.0 to about 6.5 (c) a Mw(LS) from about 30,000 to about 300,000 g/mol.

26. The process of claim 25 wherein the copolymer produced has a branching index (g′ᵥᵢₛ) less than −0.0003x+0.88, and greater than −0.0054x+1.08 where x is the percent total monomer conversion.

27. The process of claim 25 wherein the copolymer produced has an “average sequence length for methylene sequences six and longer” is less than 0.1869z-0.30, and greater than 0.1869z-1.9 where z is the mol % of ethylene as measured by ¹³C NMR.

28. The process of claim 25 wherein the copolymer produced has a “percentage of methylene sequence length of 6 or greater” less than 1.3z-35.5 and greater than 1.3z-50 where z is the mol % of ethylene as measured by ¹³C NMR.

29. The process of claim 25 wherein the copolymer produced has an r₁r₂ less than 2.0 and greater than 0.45.

30. The process of claim 25 wherein the copolymer produced exhibits no polymer crystallinity.

31. The process of claim 25 wherein the copolymer produced exhibits a Tm of less than 50° C. as measured by DSC.

32. The process of claim 25 wherein the copolymer produced has a polymer crystallinity wherein the heat of fusion (J/g) as measured by DSC is less than 2.8y-134 where y is the wt % of ethylene as measured by FTIR.

33. The process of claim 25 wherein the copolymer produced has a polymer crystallinity wherein the heat of fusion (J/g) as measured by DSC is less than 1.47y-64 where y is the wt % of ethylene as measured by FTIR.

34. The process of claim 25 wherein copolymer has an ethylene content of about 45 wt % to about 70 wt %.

35. The process of claim 25 wherein copolymer has an ethylene content of about 45 wt % to less than 50 wt %.

36. The process of claim 25 wherein the Mw(LS)/Mn(DRI) is from about 2.5 to about 6.0.

37. The process of claim 25 wherein the process is a solution process.

38. The process of claim 25 wherein the process is a continuous process.

39. The process of claim 25 wherein the monomer feed excludes dienes.

40. The process of claim 25 wherein the monomer feed excludes polyenes.

41. The process of claim 25 wherein the feed excludes aluminum vinyl transfer agents.

42. The process of claim 25 wherein the metallocene catalyst compound is represented by the formula: 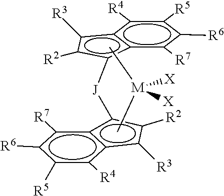
where: (1) J is a divalent bridging group comprising C, Si, or both; (2) M is a group 4 transition metal; (3) each X is independently a univalent anionic ligand, or two Xs are joined and bound to the metal atom to form a metallocycle ring, or two Xs are joined to form a chelating ligand, a diene ligand, or an alkylidene ligand; and (4) each R², R³, R⁴, R⁵, R⁶, and R⁷ is independently hydrogen, C₁-C₅₀ substituted or unsubstituted hydrocarbyl, provided that any one or more of the pairs R⁴ and R⁵, R⁵ and R⁶, and R⁶ and R⁷ may optionally be bonded together to form a saturated or partially saturated cyclic or fused ring structure.

43. The process of claim 42 wherein each R⁴ and R⁷ are selected from the group of C₁-C₃ alkyl, each R² is hydrogen or C₁-C₃ alkyl, each R³ are hydrogen, and each R⁵ and R⁶ are hydrogen or C₁-C₃ alkyl, and optionally each R⁵ and R⁶ are joined together to form a 5-membered partially unsaturated ring.

44. The process of claim 43 wherein each R⁴ and R⁷ is selected from the group of C₁-C₃ alkyl, each R² and R³ is hydrogen, and each R⁵ and R⁶ are joined together to form a 5-membered partially unsaturated ring.

45. The process of claim 44 where each R⁴ and R⁷ is methyl.

46. The process of claim 42 wherein J is selected from cyclopentamethylenesilylene, cyclotetramethylenesilylene, cyclotrimethylenesilylene, cyclopropandiyl, cyclobutandiyl, cyclopentandiyl, cyclohexandiyl, dimethylsilylene, diethylsilylene, isopropylene, and ethylene.

47. The process of claim 25 wherein the metallocene comprises cyclotetramethylenesilylene-bis(4,8-dimethyl-1,5,6,7-tetrahydro-s-indacen-1-yl)hafnium dimethyl.

48. A long chain branched ethylene propylene copolymer having from about 40% to less than 80% ethylene content by weight as determined by FTIR (ASTM D3900), wherein the polymer has a g′ᵥᵢₛ of from about 0.5 to about 0.97; a Mw(LS)/Mn(DRI) from about 2.5 to about 6.5; a Mw(LS) from about 30,000 to about 300,000 g/mol; and two or more additional properties selected from:
(a) a branching index (g′ᵥᵢₛ) less than −0.0003x+0.88, and greater than −0.0054x+1.08, where x is the percent total monomer conversion;
(b) a r₁r₂ less than 2.0 and greater than 0.45;
(c) an “average sequence length for methylene sequences six and longer” less than 0.1869z-0.30, and greater than 0.1869z-1.9, where z is the mol % of ethylene as measured by ¹³C NMR;
(d) a percentage of methylene sequence length of 6 or greater less than 1.3z-35.5, and greater than 1.3z-50, where z is the mol % of ethylene as measured by ¹³C NMR;
(e) exhibiting no polymer crystallinity, or a polymer crystallinity wherein the heat of fusion (J/g) as measured by DSC is less than 2.8y-134, where y is the wt % of ethylene as measured by FTIR;
(f) exhibiting no polymer crystallinity, or a polymer crystallinity wherein the heat of fusion (J/g) as measured by DSC is less than 1.47y-64, where y is the wt % of ethylene as measured by FTIR;
(g) exhibiting a Tm of less than 50° C. as measured by DSC; and
(h) a shear thinning ratio of greater than 0.8572*EXP(2E-05*w) where w is the Mw(LS) from light scattering GPC-3D and the shear thinning ratio is defined as the complex viscosity at a frequency of 0.1 rad/s divided by the complex viscosity at a frequency of 100 rad/s.

49. The copolymer of claim 48, which has an ethylene content of about 45 wt % to about 70 wt %.

50. The copolymer of claim 48 wherein copolymer has an ethylene content of about 45 wt % to about 50 wt %.

51. The copolymer of claim 48 wherein the copolymer excludes dienes.

52. The copolymer of claim 48 wherein the copolymer excludes polyenes.

53. The copolymer of claim 48 wherein the copolymer excludes aluminum vinyl transfer agents or remnants from aluminum vinyl transfer agents.

54. The copolymer of claim 48 wherein the SSI (%) 30 cycle per ASTM D6278 is less than 0.0003x-2.125 where x is Mw(LS) from GPC-3D.
